(19) United States
(12) Patent Application Publication
(10) Pub. No.: US 2025/0335626 A1
(43) Pub. Date: Oct. 30, 2025

(54) ENTITY-LEVEL PRIVACY IN AGGREGATION CONSTRAINTS

(71) Applicant: Snowflake Inc., Bozeman, MT (US)

(72) Inventors: Rachel Frances Blum, South Orange, NJ (US); Valentin K. Kuznetsov, Bellevue, WA (US); Henry Liu, Cupertino, CA (US); David Schultz, Piedmont, CA (US)

(21) Appl. No.: 18/651,501

(22) Filed: Apr. 30, 2024

(51) Int. Cl. G06F 21/62

(52) U.S. Cl. CPC G06F 21/6245

(57) ABSTRACT

An entity-level privacy system receives a query directed towards a shared dataset, the shared dataset comprising one or more data entries associated with one or more distinct entities, each entity of the one or more distinct entities being identifiable by one or more unique entity identifiers. The entity-level privacy system implements an entity-level privacy constraint, the entity-level privacy constraint comprising a dynamic aggregation constraint based on the one or more unique entity identifiers. The entity-level privacy system determines that the one or more unique entity identifiers satisfy a threshold condition comprising a minimum number of entities. The entity-level privacy system enforces the entity-level privacy constraint on the query and generates an output to the query based on the entity-level privacy constraint and the dynamic aggregation constraint while maintaining entity-level privacy associated with the one or more distinct entities.

### TECHNICAL FIELD

The present disclosure generally relates to special-purpose machines that manage data platforms and databases and, more specifically, to database systems that provide entity-level privacy as a layered policy for additional protection to enhance aggregation policies in a query processing system.

### BACKGROUND

Cloud data platforms may be provided through a cloud data platform, which allows organizations, customers, and users to store, manage, and retrieve data from the cloud. With respect to type of data processing, a cloud data platform could implement online transactional processing, online analytical processing, a combination of the two, and/or other types of data processing. Moreover, a cloud data platform could be or include a relational database management system and/or one or more other types of database management systems.

Databases are used for data storage and access in computing applications. A goal of database storage is to provide enormous sums of information in an organized manner so that it can be accessed, managed, and updated. In a database, data may be organized into rows, columns, and tables. A database platform can have different databases managed by different users. The users may seek to share their database data with one another; however, it is difficult to share the database data in a secure and scalable manner.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced. Various ones of the appended drawings merely illustrate example embodiments of the present disclosure and should not be considered as limiting its scope.

FIG. 1 is a system diagram illustrating an example computing environment in which a cloud data platform can implement entity-level privacy with aggregation constraints, according to some example embodiments.

FIG. 2 is a block diagram illustrating components of a compute service manager, according to some example embodiments.

FIG. 3 is a block diagram illustrating components of an execution platform, according to some example embodiments.

FIG. 4 is a block diagram illustrating components of an entity-level privacy system, according to some example embodiments.

FIG. 5 is a transactional table illustrating private data to implement entity-level privacy with aggregation policies, according to some example embodiments.

FIG. 6 is a chart illustrating data in an entity-level privacy constrained and aggregation-constrained table, according to some example embodiments.

FIG. 7 is a schematic diagram illustrating an example aggregation policy and entity-level privacy plan, according to some example embodiments.

FIG. 8 is a flow diagram illustrating a method for implementing entity-level privacy policies layered on aggregation policies, according to some example embodiments.

FIG. 9 is a block diagram illustrating aggregation constraint minimum row size and entity-level privacy constraint minimum entity count, according to some example embodiments.

FIG. 10 is a conceptual diagram illustrating aggregation policies, according to some example embodiments.

FIG. 11 is a conceptual diagram illustrating a variety of data sharing scenarios between provider(s) and consumer(s) employing entity-level privacy, according to some example embodiments.

FIG. 12 is a block diagram illustrating an example of multiple data steward scenarios, according to some example embodiments.

FIG. 13 is a conceptual diagram illustrating example sets of source data from different database accounts of a distributed database, according to some example embodiments.

FIG. 14A is an architecture diagram illustrating an example database architecture for implementing query templates for multiple entities, according to some example embodiments.

FIG. 14B is an architecture diagram illustrating an example database architecture for implementing query templates for multiple entities sharing data in a data clean environment, according to some example embodiments.

FIG. 14C is an architecture diagram illustrating an example of data clean room architecture for sharing data between multiple parties, according to some example embodiments.

FIG. 15A is an architecture diagram illustrating an example database architecture for implementing a defined-access clean room including a provider database account, according to some example embodiments.

FIG. 15B is an architecture diagram illustrating an example database architecture for implementing a defined-access clean room including a consumer database account, according to some example embodiments.

FIG. 16 is a block diagram illustrating a diagrammatic representation of a machine in the form of a computer system within which a set of instructions may be executed for causing the machine to perform any one or more of the methodologies discussed herein, according to some example embodiments.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail. For the purposes of this description, the phrase “cloud data platform” may be referred to as and used interchangeably with the phrases “a network-based database system,” “a database system,” or merely “a platform.”

Databases are used by various entities (e.g., businesses, people, organizations, etc.) to store data. For example, a retailer may store data describing purchases (e.g., product, date, price, etc.) and the purchasers (e.g., name, address, email address, etc.). Similarly, an advertiser may store data describing performance of their advertising campaigns, such as the advertisements served to users, date that advertisement was served, information about the user, (e.g., name, address, email address), and the like. In some cases, entities may wish to share their data with each other. For example, a retailer and advertiser may wish to share their data to determine the effectiveness of an advertisement campaign, such as by determining a fraction of users who saw the advertisement and subsequently purchased the product (e.g., determining a conversion rate of users that were served advertisements for a product and ultimately purchased the product). In these types of situations, the entities may wish to maintain the confidentiality of some or all of the data they have collected and stored in their respective databases. For example, a retailer and/or advertiser may wish to maintain the confidentiality of personal identifying information (PII), such as usernames, addresses, email addresses, credit card numbers, and the like or any data that a data provider decides to identify as private data.

Traditional approaches address this problem through prior solutions including heuristic anonymization techniques or differential privacy. For example, heuristic anonymization techniques (e.g., k-anonymity, l-diversity, and t-closeness) transform a dataset to remove identifying attributes from data. The anonymized data may then be freely analyzed, with limited risk that the analyst can determine the individual that any given row in a database (e.g., table) corresponds to. Differential privacy (DP) is a rigorous definition of what it means for query results to protect individual privacy. A typical solution that satisfies DP requires an analyst to perform an aggregate query and then adds random noise drawn from a Laplace or Gaussian distribution to the query result. Additional existing solutions include tokenization, which can only support exact matches of quality joins and often fails to protect privacy due to identity inference by other attributes.

Existing technologies including privacy enhancement tools used in production deployments support entity level privacy in certain ways, but each traditional approach fails to strengthen the privacy protections provided by the system(s) described herein. Some existing technologies allow the specification of an entity definition to use for every query using a differential privacy clause, like a privacy unit column that defines an entity identifier or maximum group contributed identifier that defines the limit on the number of GROUP BY partitions to which an entity is allowed to contribute. Other technologies allow for clamping bounds for an entity's aggregate value within a partition using parameters of differentially private aggregate operators. Predecessor technologies implemented a dedicated column name (e.g., UID) for an entity identifier column. Other technologies allow users to set an entity identifier column by calling their stored procedure that would save it in custom metadata stores. Still other predecessor technologies allow collaboration members to set up an aggregation group suppression mechanism by specifying a threshold and a column to suppress a group if the number of distinct values from that column is below a threshold. Other technologies have dedicated user identifier columns for each table containing information to be used with aggregation requirements or specifying an entity identifier column that allows an analyst to introduce different types of truncation bounds to limit sensitivity.

Existing methods fail to overcome the technical challenges related to maintaining the confidentiality of private data (e.g., personal identifying information) while data sharing across organizations for multiple reasons. For example, heuristic anonymization techniques can allow for data values in individual rows of a database to be seen, which increases a privacy risk; such techniques also require the removal or suppression of identifying and quasi-identifying attributes. This makes heuristic techniques like k-anonymity inappropriate for data sharing and collaboration scenarios, where identifying attributes are often needed to join datasets across entities (e.g., advertising, researching, etc.). Existing differential privacy methods fail to overcome the technical challenges; for example, DP requires a user to specify privacy budget parameters (e.g., epsilon, delta, kappa), requires a user to specify non-sensitive columns that are permitted to be used as grouping keys, and requires the addition of Laplace noise to query results.

Further existing methods may not be accurate causing usability issues and fail to provide grouping mechanisms such as example embodiments of the present disclosure detailed throughout. Additional mechanisms using only aggregation policy constraints fail to protect private data because aggregation policies alone only show (e.g., provide, display, etc.) a group aggregated value if the group size is greater than a certain value defined by the user. While aggregation constraints alone ensure the privacy of individual rows in the shared dataset (e.g., record-level privacy), record-level privacy does not prevent a query from exposing attributes of an entity when those attributes are located (e.g., found, exist) in multiple rows (e.g., in a table containing transactional data).

Existing technologies and methods have primarily focused on implementing privacy measures at the row level, utilizing approaches like differential privacy or specific aggregation constraints to safeguard individual data points. However, these conventional techniques fall short in addressing the complex challenge of protecting entity-level data that spans across multiple rows or datasets. This gap in the privacy protection landscape underscores a growing need for solutions capable of ensuring the privacy of individual entities while maintaining the utility of aggregated data.

Example embodiments presented herein improve upon existing techniques and overcome current technical challenges by providing increased data privacy protection to protect more than just row-level privacy. The cloud data platform's entity-level privacy support in aggregation constraints allows the user to specify which identifiers, quasi-identifiers, and/or attributes can be used to identify an entity (e.g., an entity key) and the threshold in which unique entity counts must be greater than in order to be displayed in a query results. Examples allow the cloud data platform Privacy Enhancement Technology (PET) to identify all of the records that belong to a particular entity within a dataset and adjust the query results accordingly.

Example embodiments of the present disclosure are directed to systems, methods, and machine-storage mediums that include an entity-level privacy policy layered on an aggregation policy to allow customers, such as data providers (e.g., data steward, data owner, etc.), of a cloud data platform, to specify an entity key size to be associated with table columns in addition to row counts of every aggregation group in order to increase protection of private data in a transactional table. The entity-level privacy policy can include a layered policy (e.g., supplementary policy, incremental policy, hierarchical policy, stacked policy, etc.) with additional rules or constraints to overlay an aggregation policy to achieve a cumulative effect that provides increased security over data desired to be private (e.g., be hidden from the consumer), enabling users to simply and quickly restrict how their data can be used (e.g., shared) in order to protect sensitive data (e.g., PII, data desired to be maintained as private, etc.) from misuse.

The disclosed entity-level privacy system presents an advanced approach for guaranteeing entity-level privacy layered to enhance data aggregation policies. Unlike existing technologies that concentrate on safeguarding individual rows through methods like differential privacy or general aggregation constraints, examples of the entity-level privacy system introduce a refined methodology that protects the privacy of data associated with entities spanning multiple rows or datasets. This is achieved by incorporating data storage to retain datasets consisting of data records linked to entities, each identifiable by one or more entity keys. A privacy enhancement technology component applies entity-level constraints and aggregation constraints to these datasets, ensuring each aggregation group and/or one or more unique entity identifiers satisfy a threshold condition comprising a minimum number of entities. For example, by including a predetermined minimum number of unique entities, thereby offering a sophisticated level of privacy protection at the entity level. The aggregation group and/or unique entity identifiers can be equal to or greater than a predefined minimum number of entities.

Additionally, examples of the entity-level privacy system encompass an entity key specification component for users to define attributes as entity keys, a query processing component to adjust query results in accordance with the combined constraints, and a policy management component for the creation and administration of privacy policies (both at the entity level and the aggregation level). Enhanced privacy protection is further supported through an encryption component that secures entity keys. Examples of the entity-level privacy system are distinct in their ability to not only preserve the utility of aggregated entity data but also to extend privacy protection across multiple datasets, addressing the complex privacy challenges presented by modern data structures. Examples of the entity-level privacy system represent a substantial progression in the field of data privacy, providing a comprehensive solution for entity-level privacy protection that surpasses the limitations of prior methodologies focused on row-level privacy.

As used herein, a provider is an organization, company, or account that owns and hosts a database or a set of data within the cloud data platform, the provider can be responsible for making the data available to other accounts or consumers for sharing, analysis, and the like, such as sharing specific databases, schemas, relations, or the like with other accounts. To resolve existing technical problems, example embodiments of a cloud data platform can employ an entity-level privacy system with an aggregation system to enforce both entity-level privacy constraints and aggregation constraints on data values stored in specified tables of a shared dataset when requests (e.g., queries) are received in the cloud data platform.

Example embodiments of the present disclosure include an aggregation system, where an aggregation constraint on a table is a constraint that is used to specify or indicate sensitive data to be shared while allowing limitations on what data and/or how the data can be used. An aggregation constraint ensures that all queries over a constrained table or view (or other schema) can only report data from that table in aggregated form. The aggregation constraint or aggregation policy primarily relies on record-level privacy (e.g., aggregation constraints inject a synthetic entity identifier for each row of a private dataset. The entity-level privacy constraint relies on row-level sensitivity and row-level truncation to provide additional privacy controls.

As used herein, aggregation constraints, such as aggregation constraint policies, can comprise (or refer to) a policy, rule, guideline, or combination thereof or, rule for limiting, for example, the ways that data can be aggregated or restricting to only aggregate data in specific ways according to a data provider's determinations (e.g., policies). For example, aggregation constraints enable use of providing restrictions, limitations, or other forms of data provider control over the aggregated data for purposes of queries and return responses to queries. An aggregation constraint can include criteria or dimension on what data in a shared dataset can be grouped together based on defined or provided operations (e.g., functions) applied to the data in each group. Aggregation constraints enable customers and users to analyze, share, collaborate, and combine datasets containing sensitive information while mitigating risks of exposing the sensitive information, where aggregation can include the grouping and/or combining of data to obtain summary information (e.g., minimum, totals, counts, averages, etc.). An aggregation constraint can identify that the data in a table should be restricted from being aggregated using functions, for example and not limitation, such as AVG, COUNT, MIN, MAX, SUM, and the like to calculate aggregated values based on groups of data. For example, the inputs do not skew or amplify specific values in a way that might create privacy challenges), and they do not reveal specific values in the input.

As used herein, entity-level privacy constraints or policies can comprise (or refer to) a policy, rule, guideline, or combination thereof or, rule for protecting, for example, an individual entity that may spread across different datasets or multiple rows of a single dataset by ensuring that an aggregation group contains a certain number of entities, not just a certain number of rows. An entity is a set of attributes belonging to a logical object whose privacy needs to be protected. When a protected entity is stored in a relational database or database system and is represented by a single row of a single dataset in the database, it provides a mechanism for row-level privacy or record-level privacy. Example embodiments stack new functionalities (e.g., entity-level privacy) upon existing aggregation policies by introducing an additional layer of protection that enforces privacy at the entity level, addressing the limitations of minimum group size constraints in transactional tables.

Examples enable users to define an entity key, which is a set of one or more table columns that uniquely identify an entity. A count of unique key combinations must exceed a user-defined threshold for the group to be included in query results. Examples extend the aggregation policy by requiring the definition of an entity key in addition to the minimum group size, thereby enhancing the privacy of the data. Examples of the entity-level privacy system introduce a minimum entity count, in addition to the minimum group size. The minimum entity count must be satisfied with the group size before data can be shown, thus providing a dual-layered approach to privacy.

Examples provide for the concept of the privacy protected entity and corresponding mechanisms to be applied interchangeably to different cloud data platform privacy enhancement technologies (PET), including, for example, query constraints integration with technology for enterprises to securely unlock value from their most sensitive data assets. Entity-level privacy is a feature of privacy-enhancing technologies (PET) that protects the privacy of an entity that is stored in a shared dataset. It ensures that queries cannot expose sensitive attributes of an entity, even if those attributes are found in multiple records, for example. These sensitive attributes can be a single value (e.g., a username) or a combination of values (e.g., the total number of bank accounts belonging to an individual).

In some example embodiments, entity-level privacy and aggregation constraints can be implemented in data clean rooms (e.g., defined-access clean rooms) to enable data providers to specify, in some examples via the provider's own code, what queries consumers can run on the data. As used herein, a consumer is an organization, company, or account that accesses and consumes data shared by the provider, where consumers can access and query the shared data without the need for data replication or data movement. Consumers can further combine the shared data with their own data within the cloud data platform to perform various analytical operations on the data. Providers can offer flexibility via parameters and query templates, and the provider can control the vocabulary of the questions that can be asked. The entity-level privacy constraints and aggregation constraints can further be implemented as a type of query constraint that allow data providers to specify general restrictions on how the data can be used. The consumer can formulate the queries, and the platform (e.g., cloud data platform, database platform, on-premises platform, trusted data processing platform, and the like) ensures that these queries abide by the provider's aggregation constraint requirements.

According to some examples, the entity-level privacy system allows data providers in a data clean room (DCR) scenario to apply policies based on entity keys the data provider wants to protect, giving the data provider control over the privacy of their data. A key feature that modern DCR technologies offer is a protection of the privacy of an individual entity. An entity here is a set of attributes belonging to a logical object whose privacy needs to be protected, for instance a user profile or household information. As mentioned above, when a protected entity is stored in a relational database and is represented by a single row of a single dataset in that database, this is commonly referred to as a corresponding privacy protection mechanism (e.g., row-level privacy, record-level privacy, etc.). When attributes of a protected entity are spread across different datasets or multiple rows of a single dataset, this is commonly referred to as a protection mechanism for entity-level privacy. Examples provide for entity-level privacy for a majority of DCR workloads. For example, data in a DCR often contains information about users' activity (e.g., page views, transactions, patient visits, etc.) that is kept in separate rows due to normalization. All data enrichment and overlap scenarios commonly applicable to DCRs rely on the fact that an entity's data is spread across provider and consumer datasets. Since for most production databases at least a basic level of normalization is applied (e.g., star schema), data for complex entities often gets split though several datasets representing fact and dimension tables.

Additional example embodiments of the methods described herein can be applied to a variety of use cases. For example, methods of employing entity-level privacy constraints and aggregation constraints in a query processing system can include audience insights and customer overlap as a way of identifying joint customers without sharing full customer lists. In other examples, methods of employing entity-level privacy constraints and aggregation constraints in a query processing system can include advertisement activation by combining sales data with viewership and demographics data in order to determine target advertising audiences. In addition, machine learning algorithms and generative artificial intelligence can be used to identify similar customers based on attributes, such as customer loyalty, purchase data, or combinations of the like.

Examples of the combination of entity-level privacy constraints layered with aggregation constraints can be used alone or in combination with clean room systems, along with additional query constraints, such as projection constraints, to enable data sharing and collaboration while allowing data providers to set limits on how the provider's data can be used. Example embodiments provide for collaboration between multiple companies through the combination of entity-level privacy constraints and aggregation constraints to help protect companies' sensitive data when they share and collaborate.

As a general matter, it is to be understood that this disclosure is not limited to the configurations, process steps, and materials disclosed herein, as such configurations, process steps, and materials may vary somewhat. It is also to be understood that the terminology employed herein is used for describing example implementations only and is not intended to be limiting.

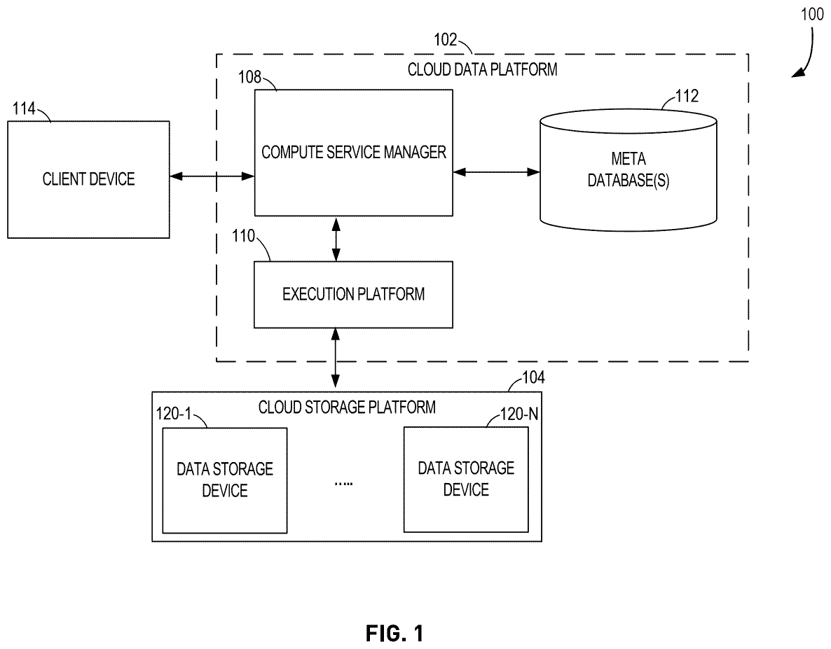

FIG. 1 illustrates an example computing environment 100 in which a cloud data platform 102 can implement aggregation constraints, according to some example embodiments. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of network-based database system or a cloud data platform.

As shown, the computing environment 100 comprises the cloud data platform 102 in communication with a cloud storage platform 104 (e.g., AWS®, Microsoft Azure Blob Storage®, or Google Cloud Storage). The cloud data platform 102 is a network-based system used for reporting and analysis of integrated data from one or more disparate sources including one or more storage locations within the cloud storage platform 104. The cloud storage platform 104 comprises a plurality of computing machines and provides on-demand computer system resources such as data storage and computing power to the cloud data platform 102.

The cloud data platform 102 comprises a compute service manager 108, an execution platform 110, and one or more metadata databases 112. The cloud data platform 102 hosts and provides data reporting and analysis services to multiple client accounts.

The compute service manager 108 coordinates and manages operations of the cloud data platform 102. The compute service manager 108 also performs query optimization and compilation as well as managing clusters of computing services that provide compute resources (also referred to as “virtual warehouses”). The compute service manager 108 can support any number of client accounts, such as end-users providing data storage and retrieval requests, system administrators managing the systems and methods described herein, and other components/devices that interact with compute service manager 108.

The compute service manager 108 is also in communication with a client device 114. The client device 114 corresponds to a user of one of the multiple client accounts supported by the cloud data platform 102. A user may utilize the client device 114 to submit data storage, retrieval, and analysis requests to the compute service manager 108.

The compute service manager 108 is also coupled to one or more metadata databases 112 that store metadata pertaining to various functions and aspects associated with the cloud data platform 102 and its users. For example, metadata database(s) 112 may include a summary of data stored in remote data storage systems as well as data available from a local cache. Additionally, metadata database(s) 112 may include information regarding how data is partitioned and organized in remote data storage systems (e.g., the cloud storage platform 104) and local caches. As discussed herein, a “micro-partition” is a batch storage unit, and each micro-partition has contiguous units of storage. By way of example, each micro-partition may contain between 50 MB and 500 MB of uncompressed data (note that the actual size in storage may be smaller because data may be stored compressed). Groups of rows in tables may be mapped into individual micro-partitions organized in a columnar fashion. This size and structure allow for extremely granular selection of the micro-partitions to be scanned, which can be comprised of millions, or even hundreds of millions, of micro-partitions. This granular selection process for micro-partitions to be scanned is referred to herein as “pruning.” Pruning involves using metadata to determine which portions of a table, including which micro-partitions or micro-partition groupings in the table, are not pertinent to a query, avoiding those non-pertinent micro-partitions when responding to the query, and scanning only the pertinent micro-partitions to respond to the query. Metadata may be automatically gathered on all rows stored in a micro-partition, including the range of values for each of the columns in the micro-partition; the number of distinct values; and/or additional properties used for both optimization and efficient query processing. In one embodiment, micro-partitioning may be automatically performed on all tables. For example, tables may be transparently partitioned using the ordering that occurs when the data is inserted/loaded. However, it should be appreciated that this disclosure of the micro-partition is exemplary only and should be considered non-limiting. It should be appreciated that the micro-partition may include other database storage devices without departing from the scope of the disclosure. Information stored by a metadata database 112 (e.g., key-value pair data store) allows systems and services to determine whether a piece of data (e.g., a given partition) needs to be accessed without loading or accessing the actual data from a storage device.

The compute service manager 108 is further coupled to the execution platform 110, which provides multiple computing resources that execute various data storage and data retrieval tasks. The execution platform 110 is coupled to cloud storage platform 104. The cloud storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid state drives (SSDs), storage clusters, Amazon S3™ storage systems, or any other data storage technology. Additionally, the cloud storage platform 104 may include distributed file systems (such as Hadoop Distributed File Systems (HDFS)), object storage systems, and the like.

The execution platform 110 comprises a plurality of compute nodes. A set of processes on a compute node executes a query plan compiled by the compute service manager 108. The set of processes can include: a first process to execute the query plan; a second process to monitor and delete cache files using a least recently used (LRU) policy and implement an out of memory (OOM) error mitigation process; a third process that extracts health information from process logs and status to send back to the compute service manager 108; a fourth process to establish communication with the compute service manager 108 after a system boot; and a fifth process to handle all communication with a compute cluster for a given job provided by the compute service manager 108 and to communicate information back to the compute service manager 108 and other compute nodes of the execution platform 110.

In some embodiments, communication links between elements of the computing environment 100 are implemented via one or more data communication networks. These data communication networks may utilize any communication protocol and any type of communication medium. In some embodiments, the data communication networks are a combination of two or more data communication networks (or sub-networks) coupled to one another. In alternate embodiments, these communication links are implemented using any type of communication medium and any communication protocol.

The compute service manager 108, metadata database(s) 112, execution platform 110, and cloud storage platform 104 are shown in FIG. 1 as individual discrete components. However, each of the compute service managers 108, metadata databases 112, execution platforms 110, and cloud storage platforms 104 may be implemented as a distributed system (e.g., distributed across multiple systems/platforms at multiple geographic locations). Additionally, each of the compute service managers 108, metadata databases 112, execution platforms 110, and cloud storage platforms 104 can be scaled up or down (independently of one another) depending on changes to the requests received and the changing needs of the cloud data platform 102. Thus, in the described embodiments, the cloud data platform 102 is dynamic and supports regular changes to meet the current data processing needs.

During typical operation, the cloud data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

As shown in FIG. 1, the computing environment 100 separates the execution platform 110 from the cloud storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from, and store data to, any of the data storage resources in the cloud storage platform 104.

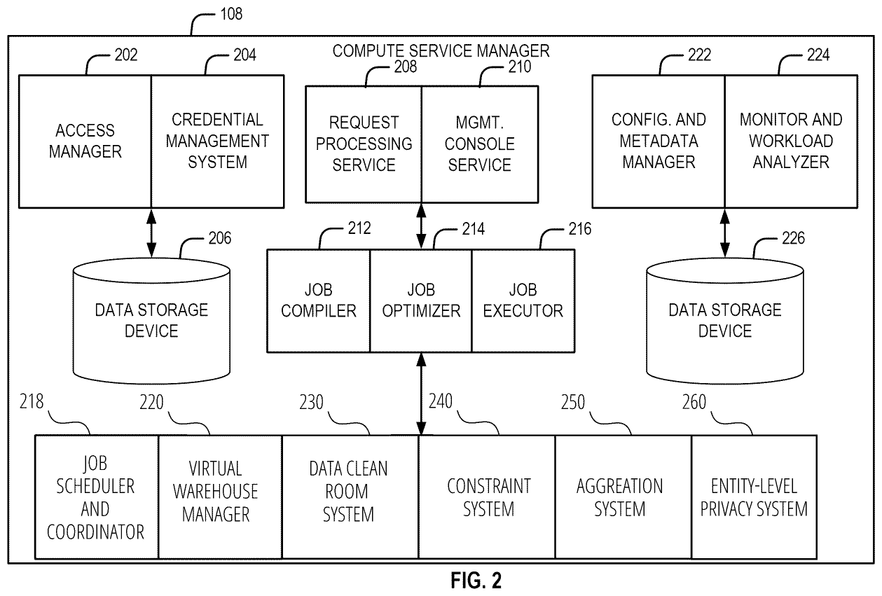

FIG. 2 is a block diagram illustrating components of the compute service manager 108, in accordance with some embodiments of the present disclosure. As shown in FIG. 2, the compute service manager 108 includes an access manager 202 and a credential management system 204 coupled to data storage device 206, which is an example of the metadata databases 112. Access manager 202 handles authentication and authorization tasks for the systems described herein.

The credential management system 204 facilitates use of remote stored credentials to access external resources such as data resources in a remote storage device. As used herein, the remote storage devices may also be referred to as “persistent storage devices” or “shared storage devices.” For example, the credential management system 204 may create and maintain remote credential store definitions and credential objects (e.g., in the data storage device 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the data storage device 206 (e.g., access metadata database, a credential object, and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in cloud storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110 of FIG. 1. For example, jobs may be prioritized and then processed in the prioritized order. In an embodiment, the job scheduler and coordinator 218 determines a priority for internal jobs that are scheduled by the compute service manager 108 of FIG. 1 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries, requests, or the like.

As illustrated, the compute service manager 108 includes a configuration and metadata manager 222, which manages the information related to the data stored in the remote data storage devices and in the local buffers (e.g., the buffers in execution platform 110). The configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the cloud data platform 102 and may further redistribute tasks based on a user (e.g., “external”) query workload that may also be processed by the execution platform 110. The configuration and metadata manager 222 and the monitor and workload analyzer 224 are coupled to a data storage device 226. Data storage device 226 represents any data storage device within the cloud data platform 102. For example, data storage device 226 may represent buffers in execution platform 110, storage devices in cloud storage platform 104, or any other storage device.

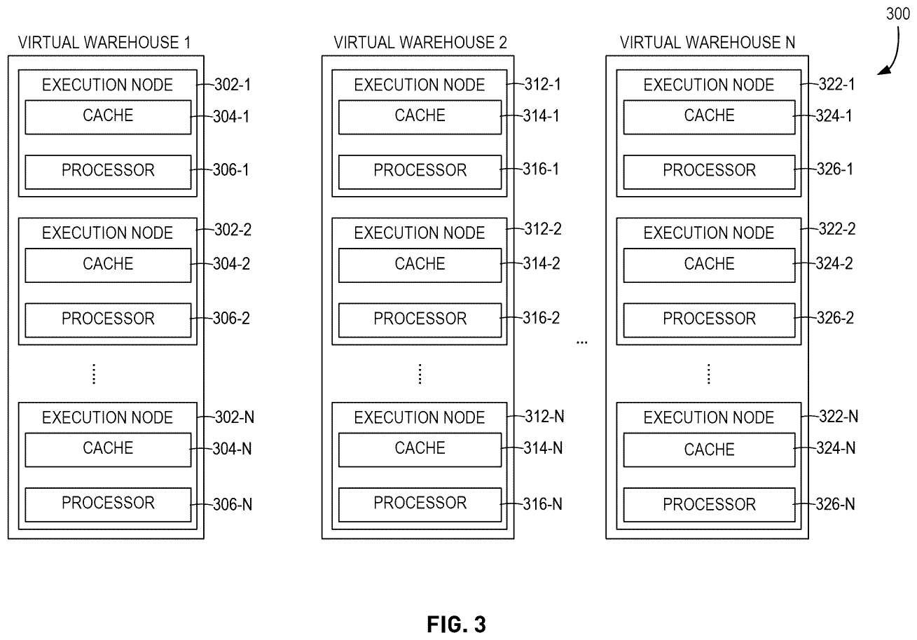

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 302-1 of FIG. 3) may need to communicate with another execution node (e.g., execution node 302-2 of FIG. 3), but should be disallowed from communicating with a third execution node (e.g., execution node 312-1), and any such illicit communication can be recorded (e.g., in a log or other location). Also, the information stored on a given execution node is restricted to data relevant to the current query, and any other data is unusable, rendered so by destruction or encryption where the key is unavailable.

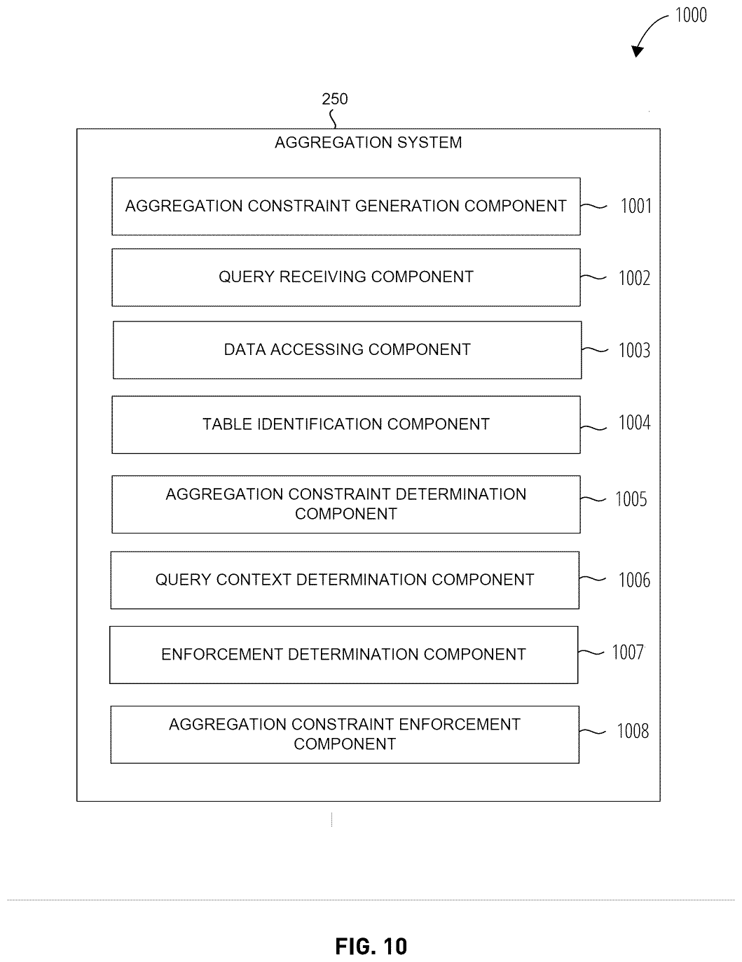

A data clean room system 230 allows for dynamically restricted data access to shared datasets, as depicted and described in further detail below with in connection with FIG. 10 to FIG. 16. The constraint system 240 provides for projection constraints on data values stored in specified columns of shared datasets, as discussed in further detail below. An aggregation system 250 can be implemented within the cloud data platform 102 when processing queries directed to tables in shared datasets. The aggregation system 250 (also referred to as the aggregation constraint system) is described in detail in connection with FIG. 10. For example, in some embodiments, the aggregation system 250 can be implemented within a clean room provided by the data clean room system 230 and/or in conjunction with the constraint system 240.

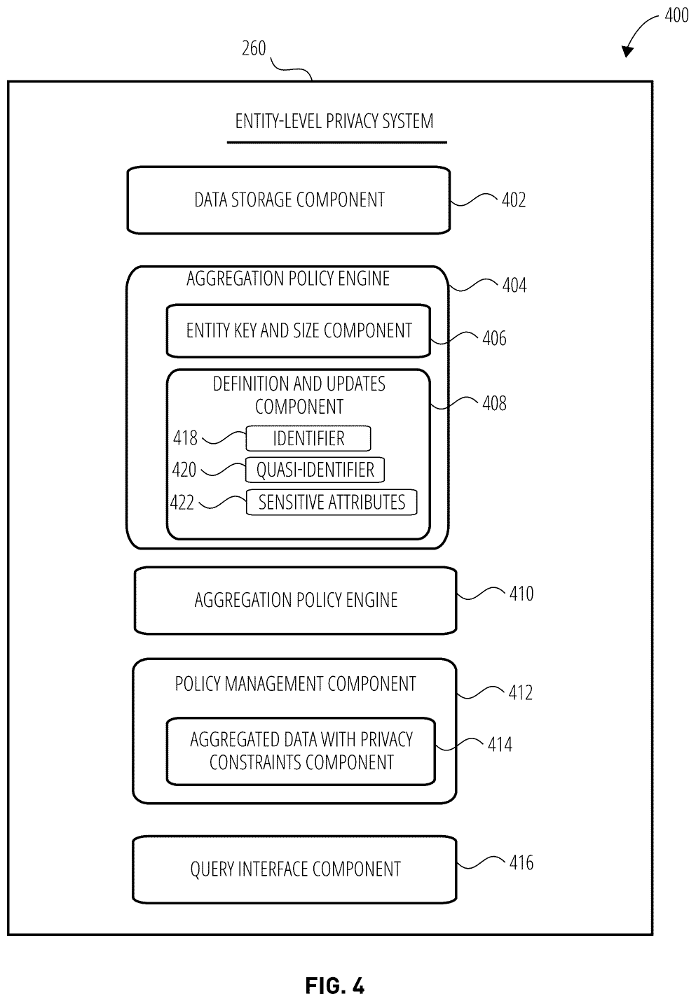

An entity-level privacy system 260 can be implemented in the cloud data platform 102 when processing queries directed to tables in shared datasets. The entity-level privacy system 260 is described in detail in connection with FIG. 4. For example, in some embodiments, the entity-level privacy system 260 can be implemented within a clean room provided by the data clean room system 230, in conjunction with the constraint system 240, and/or in conjunction with the aggregation system 250. According to some examples, the entity-level privacy system 260 and/or other policy systems can be combined into a policy engine (not shown) that is a combination engine (e.g., component) that provides for the handling, management, or the like of all policy related components, including for example, privacy policies, aggregation policies, constraint policies, and more.

The constraint system 240 enables entities to establish projection constraints (e.g., projection constraint policies) to shared datasets. A projection constraint identifies that the data in a column may be restricted from being projected (e.g., presented, read, outputted) in an output to a received query, while allowing specified operations to be performed on the data and a corresponding output to be provided. For example, the projection constraint may indicate a context for a query that triggers the constraint, such as based on the user that submitted the query.

For example, the constraint system 240 may provide a user interface or other means of communication that allows entities to define projection constraints in relation to their data that is maintained and managed by the cloud data platform 102. To define a projection constraint, the constraint system 240 enables users to provide data defining the shared datasets and columns to which a projection constraint should be associated (e.g., attached). For example, a user may submit data defining a specific column and/or a group of columns within a shared dataset that should be attached with the projection constraint.

Further, the constraint system 240 enables users to define conditions for triggering the projection constraint. This may include defining the specific context and/or contexts that triggers enforcement of the projection constraint. For example, the constraint system 240 may enable users to define roles of users, accounts and/or shares, which would trigger the projection constraint and/or are enabled to project the constrained column of data. After receiving data defining a projection constraint, the constraint system 240 generates a file that is attached to the identified columns. In some embodiments, the file may include a Boolean function based on the provided conditions for the projection constraint. For example, the Boolean function may provide an output of true if the projection constraint should be enforced in relation to a query and an output of false if the projection constraint should not be enforced in relation to a query. Attaching the file to the column establishes the projection constraint to the column of data for subsequent queries.

The constraint system 240 receives a query directed to a shared dataset. The query may include data defining data to be accessed and one or more operations to perform on the data. The operations may include any type of operations used in relation to data maintained by the cloud data platform 102, such as join operation, read operation, and the like. The constraint system 240 may provide data associated with the query to the other components of the constraint system 240, such as a data accessing component, a query context determination component, or other components of the constraint system 240. The constraint system 240 accesses a set of data based on a query received by the constraint system 240 or a component thereof. For example, the data accessing component may access data from columns and/or sub-columns of the shared dataset that are identified by the query and/or are needed to generate an output based on the received query. The constraint system 240 may provide the accessed data to other components of the constraint system 240, such as a projection constraint enforcement component. The constraint system 240 determines the columns associated with the data accessed by the constraint system 240 in response to a query. This can include columns and/or sub-columns from which the data was accessed. The constraint system 240 may provide data identifying the columns to the other components of the constraint system 240, such as a projection constraint determination component.

The constraint system 240 determines whether a projection constraint (e.g., projection constraint policy) is attached to any of the columns identified by the constraint system 240. For example, the constraint system 240 determines whether a file defining a projection constraint is attached to any of the columns and/or sub-columns identified by the constraint system 240. The constraint system 240 may provide data indicating whether a projection constraint is attached to any of the columns and/or the file defining the projection constraints to the other components of the constraint system 240, such as an enforcement determination component.

The constraint system 240 determines a context associated with a received query. For example, the constraint system 240 may use data associated with a received query to determine the context, such as by determining the role of the user that submitted the query, an account of the cloud data platform 102 associated with the submitted query, a data share associated with the query, and the like. The constraint system 240 may provide data defining the determined context of the query to the other components of the constraint system 240, such as an enforcement determination component.

The constraint system 240 determines whether a projection constraint should be enforced in relation to a received query. For example, the constraint system 240 uses the data received that indicates whether a projection constraint is attached to any of the columns and/or the file defining the projection constraints as well as the context of the query received from the constraint system 240 to determine whether a projection constraint should be enforced. If a query constraint is not attached to any of the columns, the constraint system 240 determines that a projection constraint should not be enforced in relation to the query. Alternatively, if a projection constraint is attached to one of the columns, the constraint system 240 uses the context of the query to determine whether the projection constraint should be enforced. For example, the constraint system 240 may use the context of the query to determine whether the conditions defined in the file attached to the column are satisfied to trigger the projection constraint. In some embodiments, the constraint system 240 may use the context of the query as an input into the Boolean function defined by the projection constraint to determine whether the projection constraint is triggered. For example, if the Boolean function returns a true value, the constraint system 240 determines that the projection constraint should be enforced. Alternatively, if the Boolean function returns a false value, the constraint system 240 determines that the projection constraint should not be enforced. The constraint system 240 may provide data indicating whether the projection constraint should be enforced to the other components of the constraint system 240, such as a projection constraint enforcement component.

The constraint system 240 enforces a projection constraint in relation to a query. For example, the constraint system 240 may prohibit an output to a query from including data values from any constrained columns of a shared dataset. This may include denying a query altogether based on the operations included in the query, such as if the query requests to simply output the values of a constrained column. However, the constraint system 240 may allow for many other operations to be performed while maintaining the confidentiality of the data values in the restricted columns, thereby allowing for additional functionality compared to current solutions (e.g., tokenization). For example, the constraint system 240 allows for operations that provide an output indicating a number of data values within a column that match a specified key value or values from another column, including fuzzy matches. As one example, two tables can be joined on a projection-constrained column using a case-insensitive or approximate match. Tokenization solutions are generally not suitable for these purposes.

The constraint system 240 may also allow users to filter and perform other operations on data values stored in projection-constrained columns. For example, if an email-address column is projection-constrained, an analyst end-user is prevented from enumerating all of the email addresses but can be allowed to count the number of rows for which the predicate “ENDSWITH (email, ‘database_123’)” is true. The constraint system 240 may provide an output to the query to a requesting user's client device.

However, the constraint system 240, cannot protect individual privacy with projection constraints by themselves; enumeration attacks are possible, aggregate queries on non-constrained attributes are possible, and covert channels are possible.

FIG. 3 is a block diagram 300 illustrating components of the execution platform 110 of FIG. 1, in accordance with some embodiments of the present disclosure. As shown in FIG. 3, the execution platform 110 includes multiple virtual warehouses, including virtual warehouse 1, virtual warehouse 2, and virtual warehouse N. Each virtual warehouse includes multiple execution nodes that each include a data cache and a processor. The virtual warehouses can execute multiple tasks in parallel by using the multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer useful.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each include one data cache and one processor, additional embodiments may include execution nodes containing any number of processors and any number of caches. Additionally, the caches may vary in size among the different execution nodes. The caches shown in FIG. 3 store, in the local execution node, data that was retrieved from one or more data storage devices in cloud storage platform 104 of FIG. 1. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet, another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor intensive. Similarly, an execution node may be assigned more cache resources if the tasks performed by the execution node require a larger cache capacity.

Although virtual warehouses 1, 2, and N are associated with the same execution platform 110, the virtual warehouses may be implemented using multiple computing systems at multiple geographic locations. For example, virtual warehouse 1 can be implemented by a computing system at a first geographic location, while virtual warehouses 2 and N are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault tolerant. For example, if one virtual warehouse fails, that virtual warehouse is quickly replaced with a different virtual warehouse at a different geographic location. A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer useful.

In some embodiments, the virtual warehouses may operate on the same data in cloud storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance.

FIG. 4 is a block diagram block diagram 400 illustrating components of the entity-level privacy system 260, in accordance with some embodiments of the present disclosure. As shown in FIG. 4, the entity-level privacy system 260 includes a data storage component 402, an aggregation policy engine 404, an entity key and size component 406, a definition and updates component 408, an aggregation policy engine 410, a policy management component 412, an aggregated data with privacy constraints component 414, and a query interface component 416.

In some examples, interrelated components of a database management system or database system, such as the cloud data platform 102 or components thereof, are provided to enforce entity-level privacy constraints. The entity-level privacy system 260 is composed of several modules that work alone and/or in concert to ensure that aggregated data queries respect the privacy of individual entities represented within the database.

The block diagram 400 represents example components of the system architecture for enforcing entity-level privacy constraints according to the entity-level privacy system 260. The data storage component 402 stores transactional data, while the aggregation policy engine 404, which can be a privacy protection component that applies algorithms to calculate the unique entity key sizes in each group, defines and updates entity keys and sizes. The aggregation policy engine 410 applies the privacy constraints, and the policy management component 412 allows administrators to manage privacy policies, including the aggregated data with privacy constraints component 414. The query interface component 416 provides access to the aggregated data that complies with the defined privacy constraints.

Examples of the data storage component 402 includes (e.g., comprises) the physical and/or virtual data repositories where transactional data is stored. Examples of the data storage component 402 are configured to manage and/or control a variety of data types and structures, including but not limited to, relational tables, key-value stores, document-based collections, or the like. The data storage component 402 is configured to control maintaining the integrity, availability, and/or confidentiality of the stored data.

Examples of the aggregation policy engine 404 defines and enforces the privacy constraints based on entity keys and/or key sizes. According to some examples, an entity key can refer to attributes or combinations of attributes used to enforce privacy constraints on the data. For example, an entity key can be a privacy identification marker, an anonymity assurance identifier, a privacy attribute token, a privacy protection key, an anonymization control element, or the like.

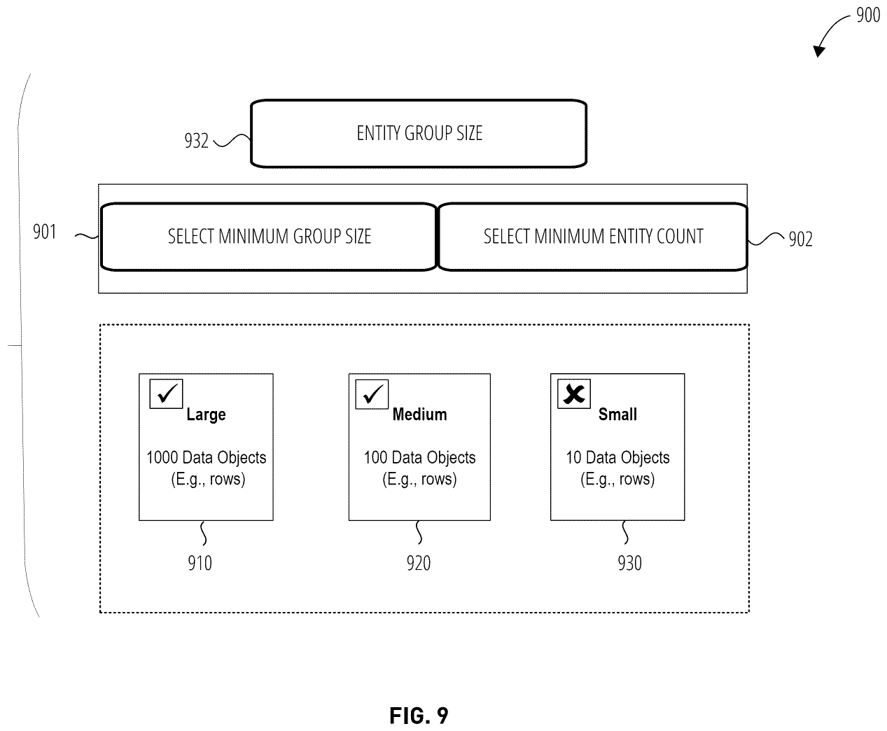

Examples of the aggregation policy engine 404 includes the sub-components of the entity key and size component 406 and the definition and updates component 408, which in some examples may be controlled by other components of the cloud data platform 102. The entity key and size component 406 enables the entity-level privacy system 260 administrator or data owner (e.g., data provider) to define one or more attributes that constitute the entity key. The entity key uniquely identifies an entity within the dataset and serves as the basis for applying privacy constraints. The entity key and size component 406 further enables the specification of a minimum number of unique entity key combinations (e.g., entity key size) used for an aggregation group to be included in query results. This threshold ensures that the aggregated data cannot be used to infer sensitive information about any individual entity (minimum group size is described and depicted in more detail in connection with FIG. 9). According to some examples of the entity key and size component 406, a remainder group size is calculated with the entity key and size in the group. An aggregation group can include a certain number of entities, in addition to or combined with a certain number of rows that are grouped together based on specified criteria for the purpose of performing operations, such as privacy policy operations, aggregate functions, and the like. For example, the criteria and be defined by one or more attributes (e.g., columns) in a dataset and the aggregate functions can be applied to these groups to compute a single result from multiple individual values. For examples in the context of privacy, aggregation groups can determine how data is aggregated in such a way that the privacy of individuals or entities represented in the data is protected. For example, ensuring that an aggregation group contains data from a sufficient number of distinct entities before including it in query results helps prevent the possibility of inferring sensitive information about any single entity. Where minimum entity count ensures that each aggregation group meets certain privacy standards before the aggregated data or values are exposed.

Examples of the entity key and size component 406 or other components of the entity-level privacy system 260 can define an entity key for a table when the user assigns the aggregation policy to the table or view. For example, when executing the ALTER TABLE . . . SET AGGREGATION POLICY command or the ALTER VIEW . . . SET AGGREGATION POLICY command to assign the aggregation policy, the user can use the ENTITY KEY clause to specify which columns in the table or view contain the identifying attributes of an entity (e.g., the entity key). Example syntax for such commands may be as follows:

::::::::CODE::::::::
ALTER { TABLE | VIEW } <name>
SET AGGREGATION POLICY <policy_name>
[ ENTITY KEY ( <column> [, <column2>, ... ] ) ]
[ FORCE ]
::::::::CODE::::::::

Where FORCE is an optional parameter that allows the command to assign the aggregation policy to a table or view that already has an aggregation policy assigned to it. According to some examples, the new aggregation policy automatically replaces an existing aggregation policy.

The ENTITY KEY clause specifies which columns of the table or view constitute the entity key. Where the aggregation policy identifies entities within the table or view by identifying a unique combination of values within those columns. For example, to create an entity key while assigning an aggregation policy my_agg_policy to a table viewership_log, the user would execute the following code:

::::::::CODE::::::::
ALTER TABLE viewership_log
SET AGGREGATION POLICY my_agg_policy
ENTITY KEY (first_name,last_name);
::::::::CODE::::::::

In such an example, because columns first_name and last_name are an entity key, the aggregation policy can determine that all rows where first_name=joe and last_name=smith belong to the same entity.

::::::::CODE::::::::
ALTER { TABLE | VIEW } <name>
SET AGGREGATION POLICY <policy_name>
[ ENTITY KEY ( <column> [, <column2>, ... ] ) ]
[ FORCE ]
::::::::CODE::::::::

According to some examples, entity keys within the cloud data platform 102 architecture can be implemented and enforced through a combination of metadata management, policy definition, query execution controls, or the like. In some examples, metadata management can include an entity key definition for data owners to define entity keys using a dedicated interface or SQL commands, where the cloud data platform stores these definitions in its metadata repository. Metadata management can further include entity key columns where the entity key is composed of one or more columns in a table that uniquely identifies an entity. These columns are tagged in the metadata as part of the entity key. Metadata management can further include entity key enforcement when an aggregation policy is applied to a table, the metadata system ensures that the entity key columns are used to enforce the minimum entity count within aggregation groups.

In example embodiments including policy definition and application, the entity-level privacy system 260 can include an aggregation policy extension being extended to include parameters for entity-level privacy (e.g., min_entity_count). When a policy is applied to a table, a policy engine records the association between the table, the entity key, and the policy in the metadata for purposes of policy application. The entity-level privacy system 260 can perform policy enforcement during query execution, the policy engine uses the entity key definitions to enforce the specified privacy constraints.

In example embodiments including query execution controls, the entity-level privacy system 260 can include aggregation group evaluation, suppression logic, differential privacy integration, or the like. For example, aggregation group evaluation can include the entity-level privacy system 260, during query execution, a cloud data platform 102 query engine evaluating each aggregation group against the entity key to ensure compliance with the minimum entity count. The entity-level privacy system 260 can employ suppression logic if an aggregation group does not meet the entity-level privacy criteria, it is suppressed from the query results. For differential privacy calculations, the entity key is used to group rows and calculate the sensitivity based on the aggregate values of the entity.

Examples of the aggregation policy engine 404 includes the definition and updates component 408, which provides for policy updates and definitions. For example, the definition and updates component 408 includes receiving or generating updates of the entity keys and sizes dynamically in response to changes in data patterns, privacy requirements, regulatory compliance needs, or the like.

Examples of the aggregation policy engine 410 includes a processing unit that applies the defined aggregation policies to incoming queries. The aggregation policy engine 410 ensures that any data aggregation performed respects the entity-level privacy constraints. For example, the engine can intercept query requests, analyze the queries against the defined policies, and/or modify the query execution plan to include the necessary privacy checks.

Examples of the policy management component 412 includes a user interface that allows system administrators or policy owners to manage and update the aggregation policies. Through this interface, users (e.g., providers) can define new entity keys, adjust entity key sizes, and review or modify existing policies to ensure ongoing compliance with privacy standards. The policy management component 412 can include a sub-component such as the aggregated data with privacy constraints component 414 or otherwise receive aggregated data with privacy constraint data from other internal or external components of the cloud data platform 102.

Examples of the query interface component 416 serves as an access point for users or applications to submit data queries to the database system, such as the cloud data platform 102. The query interface component 416 provides a mechanism for users to request aggregated data while ensuring that the responses comply with the entity-level privacy constraints enforced by the system. The query interface component 416 can receive some or all of the data from the aggregated data with privacy constraints component 414.

According to some examples, the query interface component 416 includes query requirements related to aggregation policies and/or entity-level privacy policies. For example, after an aggregation policy and/or an entity-level privacy policy has been applied to a table or view, queries against the table or view conform to certain requirements. In some examples, once part of the query properly aggregates data to satisfy the requirements of the aggregation policy, these query restrictions do not apply, and another part of the query can include things that are otherwise prohibited.

It will be understood by those having skill in the art that the architecture depicted in the block diagram 400 is designed to be modular, allowing for each component to be updated or replaced independently as technology evolves or as new privacy requirements emerge. The entity-level privacy system 260 is scalable, capable of handling large volumes of data and complex query patterns while maintaining high performance and robust privacy protections.

In examples, an entity is a set of attributes belonging to a logical object whose privacy needs or wants to be protected, for example, a user profile or household information. When attributes of a protected entity are spread across different datasets (e.g., shared datasets, multiple rows of a single dataset, etc.), this protection mechanism is referred to as entity-level privacy. According to some examples, attributes of an entity may be differentiated by identifier (ID) 418, quasi-identifier 420, sensitive attributes 422, or the like.

For example, the identifier 418 is a unique entity identifier that can be represented by one or multiple columns or it can be an organization internal entity identifier or global identifier, like an email or social security number (SSN). These identifiers 418 are primarily maintained as private and are often encrypted (or hashed) to use during entity overlap scenarios (e.g., involving private set intersection protocols). For example, in relational schemas, an entity identifier can be used as a primary key for entity's base tables and full entity information can be restored by traversing a tree of its foreign key relations or the like.

The quasi-identifier(s) 420 are a set of columns that do not uniquely identify an entity in general but can identify it in some cases or when combined with other quasi-identifiers. The quasi-identifier(s) 420 can also be used with intersection protocols that may involve separate identity resolution services. According to some examples, the primary difference between identifiers 418 and quasi-identifiers 420 as used by the cloud data platform 102 is that identifiers 418 can be used as an entity's record keys, while the quasi-identifier(s) 420 exist primarily to facilitate the privacy of entity set intersection protocols.

The sensitive attributes 422 include entity's columns that can never identify an entity by itself and are not used in DCR workflows (e.g., intersection) with intent to identify an entity. According to some examples, the mapping from identifiers 418 or quasi-identifiers 420 to sensitive attributes 422 is to be protected. For example, an entity identifier is a set of columns (or just one column) that are defined by a data owner (e.g., data provider) as identifying for this entity, regardless of actual column classification(s). For example, an entity ID can be represented by the same set of columns or a single column for an entity ID. An entity definition is a metadata describing an entity type, such as logical objects whose explicit attributes or aggregate values are to be protected. The entity definition can contain at least information about an entity identifier 418 (e.g., a list of ID columns) and, in some examples, optionally can include other information such as default policies applied to this entity or column classification. In some examples, aspects of the entity definition include an entity protection mechanism that protects not only values of explicit entity attributes, but also its combined value. For example, if a user has several bank accounts, the entity-level privacy system 260 or other component of the cloud data platform 102 protects not only a balance of each account, but also aggregates (e.g., total sum of balances across accounts, number of users accounts, etc.).

In some examples, the entity definition is not equivalent to a table primary key with attached privacy policies metadata regardless of a table's primary key or any other physical table layout information. For example, a table may contain several entities depending on what group of records a table owner needs to protect.

In some examples, a table containing viewers of a video service may have two entities defined: a) the viewer's account itself and b) the household entity that consists of several viewers in the same household. For example, an entity example may include a schema describing a bank customer who has several bank accounts. For each account, a component of the cloud data platform 102 has a transaction history (e.g., containing transaction volume, time, etc.). Depending on a use case, a schema owner may want to set up one or more entity definitions for this schema that can include, for example: (1) an account, (2) a user), and (3) a household.

According to some examples, an entity definition can be used in conjunction with relation producing objects. For example, as a policy on top of relation, an entity definition can be attached to any relation producing objects (e.g., views, table-valued functions, stored procedures, etc.). Relation producing objects in the context of databases, data management systems, or the like, can refer to constructs or components that generate or output a set of tuples (e.g., a relation), such as a table in the relational database model. Such objects receive (e.g., take) inputs or queries and generate (e.g., produce) relations as outputs that can be used for further querying, analysis, processing, or the like. Relation producing objects generally refer to any database object or construct that can output a dataset in the form of a relation, which can be subject to privacy constraints or other operations as defined by the entity-level privacy system's 260 privacy enhancement technologies (PETs).

Examples of relation producing objects can include tables, views, stored procedures, table-valued functions (TVFs), materialized views, common table expressions (CTEs), subqueries, or the like. Tables include fundamental storage objects in a relational database that store data in rows and columns, where each row represents a record, and each column represents a data field. Views include virtual tables created by a query that joins and selects data from one or more tables. A view itself does not store data but produces a relation based on the underlying tables' data. Stored procedures include precompiled collections of SQL statements and optional control-of-flow statements stored under a name and processed as a unit; it can return result sets that are relations. TVFs include functions that return a table data type. TVFs can accept parameters, perform complex processing, and/or return a relation that can be used like a table within SQL queries. Materialized views (MVs) store the query result as a physical table that can be refreshed. The MV can produce a relation that contains the data resulting from the query at the time of the materialization. CTEs can be named temporary result sets that are derived from a SELECT statement and defined within the execution scope of a single statement. The CTEs can produce a relation that can be referenced within a SELECT, INSERT, UPDATE, and/or DELETE statement. Subqueries can include nested queries used within another SQL query, which return intermediate results for the parent query to use. The result of a subquery is a relation that can be utilized in the outer query.

In some examples of relation producing objects, entity definition policies can propagate through some of such objects by using policy propagation rules. With reference to views and SQL table-valued functions, returned relation infer its entity-definition policies from relations referenced by returned relation. For example, customers can define more entity definitions for returned relations in addition to those that are referenced from its sources. With reference to stored procedures, customers can attach entity definitions to stored procedures definition. For example, no policy propagation is expected since the policy enforcement should be applied already to each query executed within the cloud data platform 102.

In further examples, the entity-level privacy system 260 can include an entity schema object and/or a policy with entity definition, according to different example embodiments. For example, the entity-level privacy system 260 or other components of the cloud data platform 102 can have a separate entity schema object in comparison with the approach when an entity is defined by a policy in its body. Having a separate entity definition applied to the table level allows to the entity-level privacy system 260 to protect entity privacy regardless of the level of indirection to which policy is applied (e.g., if an access to a table is provided through several levels of different views to which final policies are applied, a provider does not need to remember and list all entities that affects top-level policy, since all applicable entities will be propagated up the view stack and be automatically applied by the policy.

In some examples, in a case where a user works with several policy configurations, the user (e.g., provider) does not need to replicate entity definition and default parameters multiple times. Further examples that include differential privacy may need an entity definition that is shared between different tables (e.g., DP needs to know whether two tables are referencing the same private entity). For example, a database stored a separate table of users' accounts for each branch of a bank. In this example, a single user may have different accounts in different tables. However, the DP should still be able to protect the total balance of all accounts calculated with UNION queries. In some examples, separate entity definitions can serve as a high-level metadata that helps users to understand what business and privacy protection rules can be applied to a dataset.

According to some examples, a distributed privacy protection architecture (not shown) can be implemented where the privacy protection logic is not centralized but rather distributed across multiple nodes to help in scaling the system and reducing the performance overhead associated with the privacy checks. The distributed privacy protection architecture can include distributed data nodes, a privacy coordinator component, and an aggregation coordinator component. The distributed data nodes are implemented such that each node stores a portion of the transactional data, and each node is capable of performing local aggregations with privacy constraints. The privacy coordinator component coordinates the privacy policy definitions and disseminations across the distributed nodes. The aggregation coordinator component collects partial aggregation results from the distributed nodes and combines them to form the final query result, ensuring that entity-level privacy is maintained.

According to some examples, a hybrid on-demand privacy protection architecture (not shown) can be implemented. The hybrid on-demand privacy protection architecture uses a combination of on-demand and pre-computed privacy checks. For example, for frequently queried entity keys, the system pre-computes and caches the permissible aggregation results, while less common queries trigger on-demand privacy checks. The hybrid on-demand privacy protection architecture can include a privacy cache component to store pre-computed aggregation results that meet the privacy constraints for common queries, an on-demand privacy engine to process entity-level privacy queries and/or aggregation queries that are not in the cache, applying privacy constraints in real-time. The hybrid on-demand privacy protection architecture can include a cache management component to update the privacy cache as data changes or when new privacy policies are implemented. For example, the hybrid on-demand privacy protection architecture can support materialized view with aggregation policy source tables.

According to some examples, a privacy-aware data federation architecture (not shown) can be implemented. For example, in a federated architecture, data remains in its original location, and the system federates queries across these disparate data sources. The privacy protection is applied at the source, which can help in managing diverse privacy regulations across different jurisdictions. For example, the privacy-aware data federation architecture can include a data source adapter, a federation engine, and a global privacy policy repository. Where the data source adapter interfaces with various data sources, applying local privacy constraints before sending data for aggregation. The federation engine federates queries across multiple data sources, ensuring that each source's privacy constraints are respected. The global privacy policy repository stores privacy policies that are applicable across all data sources and ensures consistency in privacy enforcement.

According to some examples, a machine learning-assisted privacy protection architecture (not shown) can be implemented. For example, the ML-privacy protection architecture can leverage machine learning algorithms or large language models to predict and optimize privacy constraints based on data access patterns and privacy requirements, potentially reducing the complexity of key selection, and improving performance. For example, the ML-privacy protection architecture can include a predictive privacy component to use machine learning to predict optimal entity key sizes based on historical query patterns, privacy outcomes, or the like. The ML-privacy protection architecture can include an adaptive privacy controller to adjust privacy constraints in real-time based on predictions from the machine learning model, and a privacy training data repository to store data access patterns and privacy impact assessments to train the predictive privacy model.

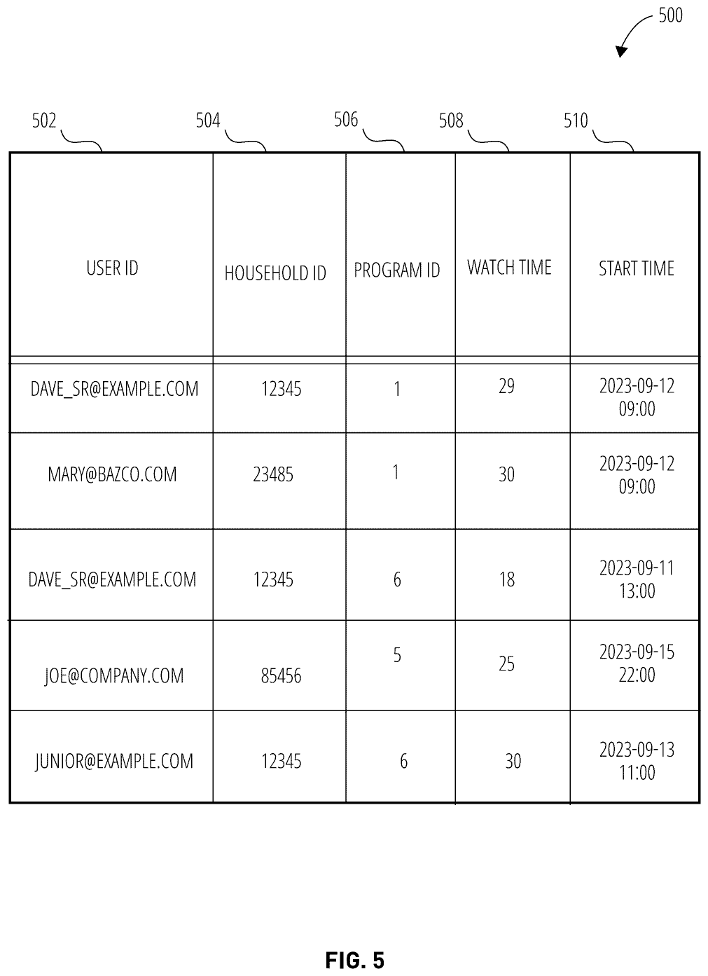

FIG. 5 illustrates a transactional table 500 of potentially private data to implement entity-level privacy with aggregation policies, in accordance with some example embodiments.

As noted above, the introduction of entity-level privacy strengthens the privacy protections provided by the cloud data platform 102 aggregation policies. The cloud data platform 102 can identify an entity within a dataset, which means it can ensure that an aggregation group contains a certain number of entities, not just a certain number of rows.

In some examples, an entity refers to a set of attributes that belong to a logical object, where a logical object can be a user identifier 502, a household identifier 504, a program identifier 506, a watch time 508, and/or a start time 510. These attributes can be used to identify an entity within a dataset. For example, all records where the email address is uniqueid@example.com (e.g., dave_sr@example.com and junior@example.com) might belong to the same entity. In some examples, in a dataset containing viewer records for a TV show, the entity key could be defined using ‘user_id’ 502 and ‘household_id’ 504 as a compound key. The entity-level privacy mechanism would then ensure that the aggregated data for viewership statistics is only displayed if the number of unique combinations of ‘user_id’ and ‘household_id’ exceeds the specified entity key size. A compound key refers to a key that consists of two or more entities (e.g., columns) in a database table that together form a unique identifier for a record. In the context of entity-level privacy, a compound key is used to uniquely identify an entity across multiple rows or datasets, ensuring that the privacy constraints are applied to the entity as a whole rather than to individual records. For example, a compound key is used to enforce entity-level privacy within aggregation policies. The compound key is created by combining multiple columns, such as user_id and household_id, to form a unique identifier that represents an entity, such as a household. This compound key is then used to determine the uniqueness of entities and to enforce privacy rules, such as ensuring that a minimum number of unique entities are present in an aggregation group before the group's data can be shown in query results.

For example, an audience ratings company using the cloud data platform 102 DCR framework described throughout, can provide a data clean room solution that allows their customers to get visibility into how much time different categories of viewers spent on viewing different categories of television (TV) programs. Such categories can be used as grouping keys for aggregation groups for which DCR consumers obtain view time statistics. In some examples, a main source of information used in aggregations is a view event table, where each record corresponds to some segment of time a particular user account spent on watching a particular program. The audience ratings company can associate user accounts with their households. To preserve customers' privacy, the audience ratings company can dictate that each aggregation group that a DCR consumer can get from the DCR is to contain at least some minimum number of distinct households. In such an example, the private entity that the audience ratings company can protect is a household, where the audience ratings company internal household identifier serves as the entity key.

The account can include Privacy Enhancement Technology (PET) that identifies all of the records that belong to a particular entity within a dataset, which will ensure that attributes (e.g., an account balance that is calculated as the volume sum of all transactions) are protected. The user (e.g., account holder) can include PET that ensures that attributes (e.g., total balance across all accounts) are protected. The household can include PET to ensure that attributes (e.g., total balance across all accounts of all members of a household) are protected.

According to some examples of common entity usage, the entity definition is used with the following PET mechanisms: an aggregation group suppression and/or an attribute sensitivity calculation in differential privacy.

An example of the aggregation group suppression can include, for some particular aggregation group, that there is an entity that dominates the result of aggregation (e.g., would be when there is only a single entity in the group), the aggregation group is removed from the output. This mechanism is used by aggregation constraints in the cloud data platform 102, and many SQL DP systems that use it, to bound query sensitivity (and, thus, the level of needed noise). For example, suppression can be implemented by applying some user defined thresholds, such as minimum group size as used by the cloud data platform 102 aggregation constraints, or max entity contribution to each aggregation group. An example of the attribute sensitivity calculation in differential privacy can include protecting the privacy for the whole entity, such that DP sensitivity for a particular column can be calculated not just as a maximum value stored in this column, but as a maximum value of an aggregate of that column grouped by an entity identifier.

In some examples, entity definition is a policy of an arbitrary relation (in contrast with similarly looking table's primary or foreign keys that are write-time constraints), entity definition is a read-time policy that affects query execution. In such examples, customers can define this policy not only on tables or views, but on any relation producing constructs including stored procedures, table-valued functions, and the like.

In some examples, entity definition is independent from a table. For example, there are several cases when PET policies need to detect that two or more tables contain data belonging to the same entity. For proper sensitivity calculation(s), examples detect whether during a JOIN it is possible that a record belonging to one entity is joined with a record belonging to another entity (e.g., cross-entity join). To be able to detect this during compile time, an entity definition exists outside of a particular table definition, which references this entity definition. For example, if two tables store the same entity, both tables point to a single entity definition.

In some examples, entity definition includes UNION operators configured to manage (e.g., understand) whether merged data belongs to the same entity. For example, if a customer has different tables for each branch of their bank or organization, the total balance for a particular user will be a sum calculated from the union of those tables. A lack of knowledge about entity correspondence between UNIONed tables can lead to sensitivity undercalculation with corresponding loss in privacy for DP policy cases. For example, while an attacker will not be able to tell whether the entity is present in a particular table, the attacker will be able to tell that the entity is present in their UNION. Similarly, for aggregation constraints, a lack of knowledge about entity correspondence between UNIONed tables can lead to the loss of utility due to more aggressive group suppression. As can be seen, the requirement of having a separate entity definition is not blocking for aggregation constraint where lack of a common definition leads to worse utility, while it is more important for differential privacy where it leads to privacy loss unless a customer adjusts their schema to ensure DP is correctly accounted for during a merge (e.g., the customer can create a view to merge the data and apply the DP policy to a view).

Many PETs ensure the privacy of individual rows in the shared dataset (E.g., record-level privacy). However, record-level privacy does not prevent a query from exposing attributes of an entity when those attributes are found in multiple rows (e.g., in a table containing transactional data). For example, suppose a streaming service wants to share data about programs being watched with potential advertisers but does not want the advertisers to be able to discover sensitive attributes about any of the individual viewers. In such an example, in its transactional table, the streaming service keeps track of the email address (e.g., user_id), and household (e.g., household_id) of each viewer as they watch shows. The advertisers must never be able to expose these attributes for an individual viewer or household.

The streaming service can use an aggregation policy to force the advertisers to aggregate data instead of returning individual records. For example, the streaming service can require a query to aggregate the data into groups that contain at least two records. Doing so prevents the advertisers from retrieving data from an individual record (e.g., record-level privacy). If each viewer and household only appeared once in the table, that would be enough to protect their privacy. However, an advertiser's query can still learn about both viewers and their households. For example, a query can create a group that consists entirely of records from household 12345 or, in a worse scenario, a group that consists entirely of records for viewer dave_sr. In both cases, the number of records in the group would meet the requirements set by the streaming service (e.g., minimum of two records per group).

To achieve entity-level privacy, the cloud data platform 102 allows the user to specify which attributes can be used to identify an entity (e.g., an entity key). This enables a cloud data platform 102 PET to identify all of the records that belong to a particular entity within a dataset, and adjust its results based on the entity key and the aggregation policy in order to determine which results (e.g., data values) are hidden from a consumer. For example, if the entity key is composed of two columns (e.g., first_name and last_name), then the cloud data platform 102 can determine that all records where first_name=joe and last_name=smith belong to the same entity.

In the preceding example, where the streaming service defines household_id as the entity key because it uniquely identifies each household. The streaming service modifies its implementation of aggregation policies to require a query to aggregate data into groups that contain at least two entities rather than specifying that it must contain at least two records.

The privacy of each household is now preserved. Before the change, a group could consist entirely of records where household_id=12345, but now it must contain at least two distinct values of household_id. In some examples, the entity key is not always the same as the primary key of a table. In this example, the table might use user_id as the primary key because it uniquely identifies a viewer. But in this case, the streaming service wants to protect the privacy of an entire household, which consists of multiple viewers, so they chose household_id as the entity key.

In examples, to enforce entity-level privacy with aggregation policies (as described and depicted in detail in connection with FIG. 10), example embodiments specify the number of entities that must be included in each aggregation group when executing a CREATE AGGREGATION POLICY command to create the aggregation policy and define the entity key when assigning the aggregation policy to a table or view.

In examples that specify the minimum number of entities (as described and depicted in detail in connection with FIG. 9), the syntax for creating an aggregation policy with CREATE AGGREGATION POLICY does not change with the introduction of entity-level privacy. For example, the user can use a MIN_GROUP_SIZE argument of the AGGREGATION_CONSTRAINT function to specify a minimum group size (as described and depicted in detail in connection with FIG. 9). Once the user defines an entity key, the minimum group size changes from a requirement on the number of records in a group to the number of entities in a group.

For example, the following code creates an aggregation policy that has a minimum group size of five, when the user defines an entity key when assigning the policy to a table, each aggregation group must contain at least five entities.

:::::::CODE::::::
CREATE AGGREGATION POLICY my_agg_policy
AS ( ) RETURNS AGGREGATION_CONSTRAINT −>
AGGREGATION_CONSTRAINT(MIN_GROUP_SIZE =>5);
:::::::CODE::::::

In some examples, a syntax to define a minimum group size that requires each aggregation group to contain a certain number of entities and a certain number of records. In such an example, the AGGREGATION_CONSTRAINT internal function accepts the following parameters: (1) min_entity_count=>integer_expression and (2) min_row_count=>integer_expression. Where min_entity_count=>integer_expression specifies how many separate entities must be included in each aggregation group and min_row_count=>integer_expression specifies how many records must be included in each aggregation group. For example, the following code creates an aggregation policy that requires aggregation groups to contain at least five entities and ten rows.

:::::::CODE::::::
CREATE AGGREGATION POLICY my_agg_policy
AS ( ) RETURNS AGGREGATION_CONSTRAINT −>
AGGREGATION_CONSTRAINT(MIN_ROW_COUNT=>10,
MIN_ENTITY_COUNT=>5);
:::::::CODE::::::

According to some examples, the user can specify an entity key for new tables and views. For example, the user can use the syntax for the CREATE TABLE . . . SET AGGREGATION POLICY command and the CREATE VIEW . . . SET AGGREGATION POLICY command to allow the user to specify an entity key when creating a new table or view. Example syntax for such commands may be as follows:

::::::::CODE::::::::
CREATE { TABLE | VIEW } <name>
WITH AGGREGATION POLICY <policy_name>
[ ENTITY KEY ( <column> [, <column2>, ... ] ) ]
::::::::CODE::::::::

According to some examples, to create a new table (t1) while assigning an aggregation policy and defining an entity, the user can execute the example syntax as follows:

Example syntax for such commands may be as follows:

::::::::CODE::::::::
CREATE TABLE t1
WITH AGGREGATION POLICY my_agg_policy
ENTITY KEY (first_name,last_name);
::::::::CODE::::::::

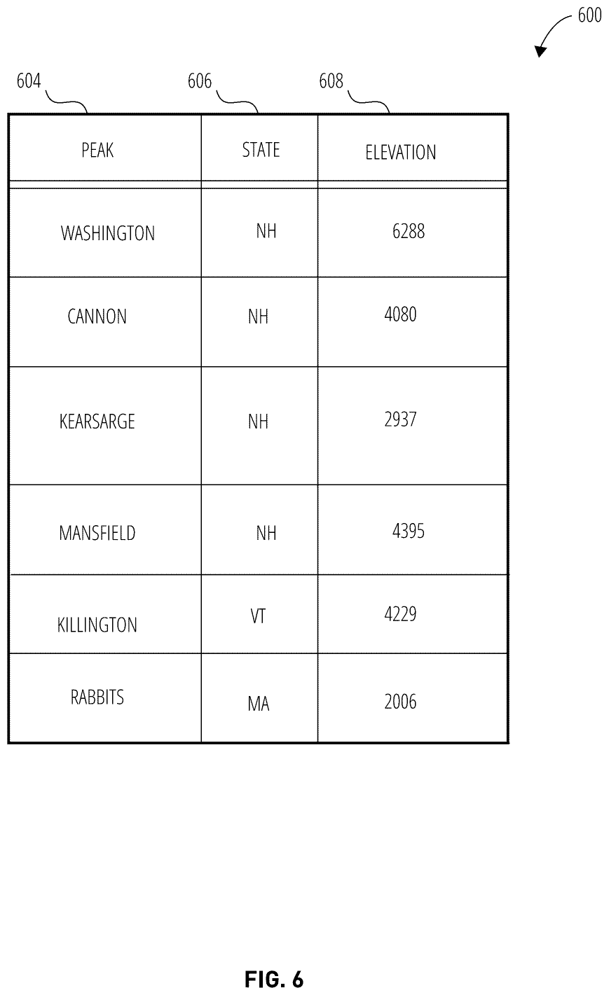

FIG. 6 illustrates an entity-level privacy constrained and aggregation-constrained table 600, in accordance with some example embodiments. In the example table 600, an entity refers to a set of attributes that belong to a logical object, where a logical object can be a peak 604, a state 606, and/or an elevation 608.

In some examples, creating an aggregation policy and assigning the aggregation policy to a table follows an example procedure similar to creating and assigning other policies in the cloud data platform (e.g., masking policies, projection policies, etc.). For example, creating the aggregation policy and assigning the aggregation policy to a table includes: (1) creating a custom role (e.g., agg_policy_admin) to manage the policy or use an existing role of the users, (2) grant this role the privileges to create and assign an aggregation policy, (3) create the aggregation policy, and (4) assign the aggregation policy to a table. Once the aggregation policy is assigned to the table, successful queries against the table aggregate its data according to the policy.

Once the provider shares the aggregation-constrained table, the data consumer (e.g., consumer) can execute queries against it. As seen in table 600, for example, the aggregation-constrained table contains three columns: peak 604, state 606, and elevation 608. The entity-level privacy constrained and aggregation-constrained table includes six rows. Assume the consumer executes the following query against table 600:

::::::CODE::::::
SELECT state,AVG(elevation) AS avg_elevation
FROM table 600
GROUP BY state;
::::::CODE::::::

The results would produce the following table, where the value of STATE in the second group is NULL because it is a remainder group that averages the elevation of peaks in VT and MA.

TABLE 1
Results of Average State and Average Elevation

| STATE | AVG_ELEVATION |
|---|---|
| NH | 4435 |
| NULL | 3543 |

In some examples, a user can assign an aggregation policy to both views and materialized views. For example, when an aggregation policy is applied to a view, the underlying table does not become aggregation-constrained, such that this base table can still be queried without restrictions. In order to avoid the possibility of exposing sensitive data, all aggregation-constrained views are treated as if they are secure views (even if they are not). In some examples, whether a user can create a view from an aggregation-constrained table depends on the type of view. For example, the user can create a regular view from one or more aggregation-constrained tables; however, queries against that view must aggregate data in a way that meets the restrictions of those base tables. In some examples, a user cannot create a materialized view based on an aggregation-constrained table or view, nor can the user assign an aggregation policy to a table or view upon which a materialized view is based. In some examples, aggregation policies can be used with cloned objects, using database replication, using replication groups, and/or other privileges and commands. The cloud data platform 102 supports different permissions to create and/or set an aggregation policy on an object.

According to some examples, aggregation policies can be implemented to interact with various features and/or services of the cloud data platform 102, such as masking policies, row access policies, projection policies, or the like.

According to some examples, cloning objects can be used in combination with aggregation policies and/or entity-level privacy policies to safeguard data from users with the SELECT privilege on a cloned table or view that is stored in a cloned database or schema. According to some examples, cloning a database can result in the cloning of all aggregation policies and/or entity-level privacy policies with the database, and cloning a schema can result in the cloning of all aggregation policies and/or entity-level privacy policies within the schema.

For example, a cloned table maps to the same aggregation policies and/or entity-level privacy policies as a source table. When a table is cloned in the context of its parent schema cloning, if the source table has a reference to an aggregation policy and/or entity-level privacy policy in the same parent table (e.g., a local reference), the cloned table will have a reference to the cloned policies. If the source table refers to an aggregation policy and/or entity-level privacy policy in a different schema (e.g., a foreign reference), then the cloned table retains the foreign reference.

According to some examples, aggregation policies and/or entity-level privacy policies and their respective assignments can be replicated using database replication and replication groups. For example, for database replication, the replication operation fails if either of the following conditions is true. (1) The primary database is in an enterprise (or higher) account and contains a policy but one or more of the accounts approved for replication are on lower editions. (2) A table or view contained in the primary database has a dangling reference to an aggregation policy in another database. The dangling reference behavior for database replication can be avoided when replicating multiple databases in a replication group.

An aggregation policy is a schema-level object that controls what type of query can access data from a schema (e.g., table, view, etc.). When an aggregation policy is applied to a table, queries against that table aggregate data into groups of a minimum size in order to return results, thereby preventing a query from returning information from an individual record. For example, a table or view with an aggregation policy assigned to it is said to be aggregation-constrained. In some examples, when creating an aggregation policy, the provider's policy administrator specifies a minimum group size (e.g., the number of rows or columns that must be aggregated together into a group). The larger the minimum size, the less likely it is that a consumer could use the query results to deduce the contents of a single record.

Aggregation policies protect data for an individual record, not an entity. If a dataset contains multiple records belonging to the same entity, an aggregation policy only protects the privacy of a specific record pertaining to that entity, not the entire entity. While aggregation policies limit access to individual records, they do not guarantee a malicious actor could not use deliberate queries to obtain potentially sensitive data from an aggregation-constrained table. With enough query attempts, a malicious actor could potentially work around the aggregation requirements to ascertain a value from an individual row. Aggregation policies are best suited for use, for example, with partners and customers of the cloud data platform with whom users have an existing level of trust. For example, providers of data, e.g., users of the cloud data platform, should be vigilant about potential misuses of their data (e.g., by reviewing the access history for the provider's listings).

In some examples, once the aggregation policy is applied to a table or view, a query against the table or view must conform to two rules: (1) the query must aggregate the data. If the query uses an aggregation function, it must be one of the allowed aggregation functions. (2) Each group created by the query must include the aggregate of at least X records, where X is the minimum group size of the aggregation policy. If the query returns a group that contains fewer records than the minimum group size of the policy, then the cloud data platform combines those groups into a remainder group. The cloud data platform can apply the aggregation function to the appropriate column to return a value for the remainder group. However, because that value is calculated from rows that belong to more than one group, the value of the GROUP BY key column is NULL. For example, if the query includes the clause GROUP BY state, then the value of STATE in the remainder is NULL. A query that does not return enough results to populate a remainder group continues to function but returns a NULL value in every field of the results.

The body of an aggregation policy uses internal functions (e.g., no aggregation constraint, aggregation constraint, etc.) to define the constraints of the policy. When the conditions of the body call one of these functions, the return value from the function determines how queries against the aggregation-constrained table or view must be formulated to return results. In a no aggregation-constraint situation, when the policy body returns a value from this function, queries can return data from aggregation-constrained tables or views without restriction. For example, the body of the policy can call this function when an administrator needs to obtain unaggregated results from the aggregation-constrained table or view. In an aggregation-constraint situation, when the policy body returns a value from this function, queries aggregate data in order to return results using the minimum group size argument to specify how many records must be included in each aggregation group. Once created, an aggregation policy can be applied to one or more tables or views or the like to make it aggregation-constrained.

Policy administrators can create conditional policies to allow one user to query a table without restriction while requiring others to aggregate the results. Policy administrators can further modify, assign, replace, detach, monitor, discover, identify aggregation policies, and the like. After an aggregation policy has been applied to a table or view, queries against that table or view conform to certain requirements. For example, one part of the query properly aggregates data to satisfy the requirements of the aggregation policy and another part of the query can include things that are otherwise prohibited. In some examples, aggregation functions, such as AVG, COUNT, HLL, SUM, are allowed in a query against an aggregation-constrained table. Where the query can contain more than one of the allowed aggregation functions.

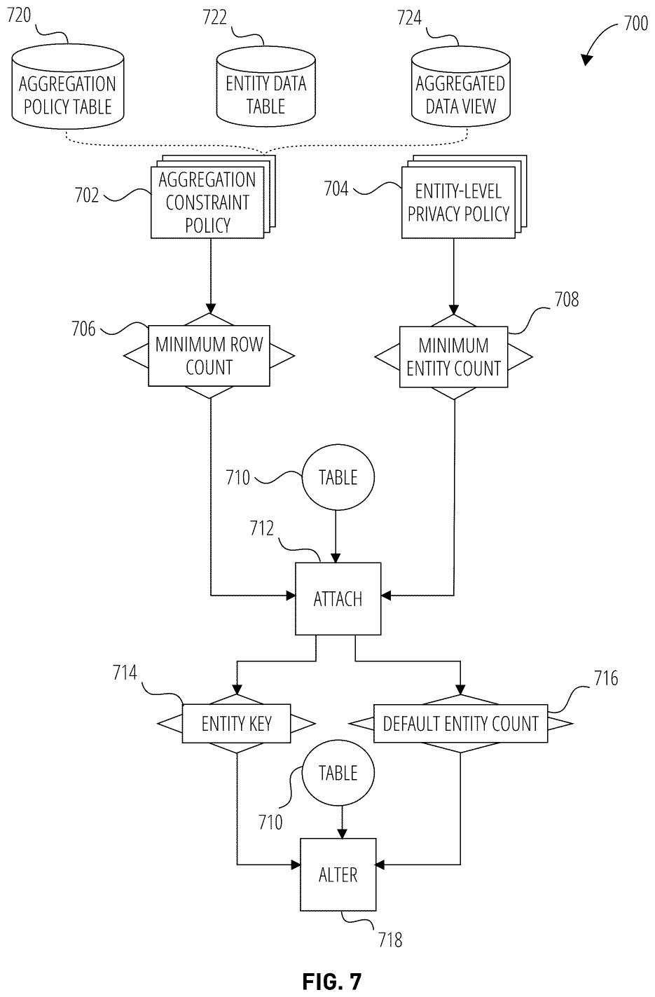

FIG. 7 illustrates a schematic diagram 700 depicting a workflow of an example aggregation policy plan and entity-level privacy policy plan, in accordance with some example embodiments. The schematic diagram 700 comprises an aggregation constraint policy 702, an entity-level privacy policy 704, a minimum row count 706, a minimum entity count 708, a table 710, an attach 712 operation, an entity key 714, a default entity count 716, and an alter 718 operation.

The workflow begins by creating the aggregation constraint policy 702 including the minimum row count 706, where the minimum row count 706, for this example, requires having at least six rows. The workflow, either simultaneously or in progression, creates the entity-level privacy policy 704 including the minimum entity count 708, where the minimum entity count 708, for this example, includes a minimum of four entities from a protected table in each returned aggregation result.

The workflow of the example policy plans includes an attach 712 operation that that attaches the aggregation constraint policy 702 and the entity-level privacy policy 704 as a combination policy as a single policy that defines, for example, min_row count and min_entity_count as a single policy to the table 710 using an entity key 714. For example, the entity key 714 can include {first_name, last_name}. The single, combination policy attached is used to ensure no conflicting constraints can be imposed on any schema. The attach 712 operation further includes using a default entity count 716. In this example, the default entity count 716 can equal three. In some examples, the default entity count 716 can be overwritten by the policies 702/704 that are combined as a single policy (e.g., one total policy in coded implementation) by the policy as happening in the policy body.

The workflow of the example policy plans includes an alter 718 operation that is altering the table 710 to be a protected table with a set aggregation policy including the entity key 714 (e.g., first name, last name) with a default minimum entity count of three. For example, a portion of the schematic diagram 700 may be expressed in SQL code to create and apply an aggregation constraint policy as follows:

```
::::::CODE::::::
-- Create an aggregation constraint policy that requires to
have at least 6 rows and
-- 4 entities from a protected table in each returned aggregation group.
  CREATE AGGREGATION POLICY test_policy AS ( )
  RETURNS AGGREGATION CONSTRAINT
  AGGREGATION_CONSTRAINT(min_row_count=>6,
min_entity_count=>4);
-- Attach an aggregation constraint policy to a table using entity
key {first_name, --
last_name} and default entity count equal to 3. Default entity count
can be --
overwritten by the policy as happening in the policy body above.
  ALTER TABLE protected_table
  SET AGGREGATION POLICY test_policy
  ENTITY KEY (first_name, last_name) WITH DEFAULT
min_entity_count=>3;
::::::CODE::::::
```

According to some examples, a default minimum entity count parameter, such as the default entity count 716 and/or the minimum entity count 708, in an aggregation constraint policy and/or an entity-level privacy constraint policy serves as a baseline requirement for the number of distinct entities that must be present in each aggregation group when querying a database table. This parameter ensures that the data aggregation does not inadvertently reveal sensitive information about any individual entity, thereby maintaining privacy and compliance with data protection regulations. For example, the default minimum entity count helps in privacy protection and data integrity. With regard to privacy protection, the default entity count prevents the possibility of identifying individual entities when the data is aggregated. For example, if the data is grouped by certain attributes, having too few entities in each group could make it possible to deduce information about an individual. With regard to data integrity, the default entity count ensures that aggregated data is representative of a sufficiently diverse sample, thus maintaining the integrity and statistical significance of the data.

According to some examples, overriding the default minimum default entity count parameter can be useful in several scenarios, such as varying privacy requirements, regulatory compliance, custom aggregation policies, custom entity-level privacy policies, and the like. For example, with varying privacy requirements, different tables or datasets might have varying levels of sensitivity. For instance, data containing medical information might require a higher minimum entity count compared to general demographic data to ensure enhanced privacy. In another example with reference to regulatory compliance, specific regulations or policies might dictate stricter aggregation rules for certain types of data. Overriding the default allows compliance with such legal requirements. In another example with reference to custom aggregation policies, depending on the analysis or reporting needs, a higher or lower entity count might be necessary to achieve the desired balance between data utility and privacy. Overriding the default minimum entity count parameter can also be used in optimization for performance. In some examples, adjusting the entity count might be necessary to optimize query performance while still maintaining adequate privacy safeguards. The ability to override the default minimum entity count provides flexibility to tailor data aggregation practices to specific needs, ensuring both compliance and practical utility of the aggregated data. This flexibility is particularly important in environments where data sensitivity can vary significantly across different datasets or where regulatory requirements are stringent and specific.

According to some examples, the cloud data platform 102 can support data definition language (DDL) policies to create and manage aggregation policies and/or entity-level privacy policies, such as CREATE, ALTER, DESCRIBE, DROP, SHOW, etc. According to some examples, a user can manage aggregation policies alone or in conjunction with entity-level privacy policies according to privileges and commands, such as an aggregation policy privilege, an aggregation policy DDL reference, or other commands, operations, and privileges.

An aggregation policy DDL reference is a set of instructions or commands used in database schemas to define the structure of an aggregation policy within a database. This includes specifying how data should be grouped, how privacy constraints are to be applied, and how entity-level privacy is to be maintained during data aggregation processes. This DDL reference includes the creation of an aggregation policy table 720 to store the privacy rules, an entity data table 722 to store the entity information and a relationship between them, and an aggregated data view 724 that applies the aggregation policy to the data. A HAVING clause in the view 724 ensures that only groups meeting the minimum entity count 708 and group size thresholds (e.g., minimum row count 706) are included in the aggregated results, thus enforcing the entity-level privacy constraints.

In some examples, the cloud data platform 102 can also use from the entity-level privacy system 260 information, such as the entity schema object and/or a policy with entity definition described in connection with FIG. 4 to enforce DCR creation rules (e.g., a dataset with a private entity attached should be allowed to be added to DCR without some protection policy attached). In some examples, policy and entity has a different functional scope, where an entity definition is a stable static part of a dataset metadata that belongs to a dataset description, while a policy is a definition of an access to that dataset.

In some examples, new schema objects for an entity can include one of the syntax options being introduced to an entity as a separate schema-level object. For example, metadata models can be included as a new schema object for an entity, where a component of the cloud data platform 102 maintains several new metadata entities to facility entity-level privacy, such as: a private entity type definition metadata, a private entity policy profile that contains a setting used by different PET policies, and/or an entity type definition attachment and potential policy profile overwrite.

The private entity type definition metadata can contain an entity type name global for the schema, a list of entity identifier columns, and/or a default private entity policy profile as described below. The private entity policy profile that contains a setting used by different PET policies can include a minimum group size to use for aggregation group suppression, columns row and entity level boundaries to use for entity suppression, columns row and entity level boundaries to use for value clamping, and/or other related settings. The entity type definition attachment and potential policy profile overwrite that can connect an entity with a relation producing construct (e.g., table, view, TFV, etc.) can contain an optional mapping from column names defined in an entity definition to dataset columns. This can help with the case when different datasets use different naming conventions for their columns and thus need to be consolidated.

According to some examples, entity profile priorities may be enabled by the entity-level privacy system 260 or other components of the cloud data platform 102 in order for all private entity profile settings to be applied on different levels (e.g., entity definition, table attachment, policy itself, etc.). For example, the entity definition and table attachment can enable customers to significantly simplify the process of configuring different privacy settings. Adjusting settings on the policy level, will allow some custom scenarios that need different entity definitions or policy their settings for different roles. The entity-level privacy system 260 can enable customers to set policy settings on all levels by incorporating the aggregation system 250 and the entity-level privacy system 260 into a single system that combines or integrates all non-conflicting constraints into a single policy or constraint on the table, including the lower-level policies by higher level policies.

According to some examples, the entity-level privacy system 260 or other components of the cloud data platform 102 can use DDL statements to operate with objects described throughout, such as an entity definition creation, a private entity reference, or the like. To be able to overwrite default policy configurations specified for an entity, the entity-level privacy system 260 can enable a private entity reference function that can be used from the policy body. Where the entity name argument denotes the name of the entity schema object, the policy configuration options have the same meaning as for the private entity function; however, since some of the policy options can be defined within an entity, they do not have to be provided in the private entity reference call. In some examples, an entity object name is the name of the object describing an entity, which can include a full schema path.

For instance, the expression: “PRIVATE_ENTITY_REFERENCE(‘der_db.der_sch.user_entity’, min_group_size=>10)” will return a configuration for an entity ‘user_entity’ previously created in ‘der_db.dcr_sch’ schema, but with min_group_size parameter being overwritten with new value.

A full workflow example of applying an entity definition to a table is given below:

::::::CODE::::::
//Create an entity definition.
CREATE PRIVATE ENTITY employee
ENTITY ID (ssn STRING) -- ssn is an entity key column (can be a list
of columns as
well).
POLICY PROFILE(min_entity_count=>25); -- min_group_size is a
default policy
parameter.
//Attach the entity to the table with optional parameter overwrite.
ALTER TABLE employees ADD PRIVATE ENTITY employee
REFERENCES ssn => employee_ssn -- Map table column
‘employee_ssn’ to ‘ssn’
key.
POLICY PROFILE (
COLUMN salary ENTITY_SUPRESSION_BOUND 10 TO 10,000,000
);
ALTER TABLE paychecks ADD PRIVATE ENTITY employee
REFERENCES ssn => reciever_ssn -- Map table column ‘reciever_ssn’
to ‘ssn’ key.
POLICY PROFILE (
COLUMN paid_sum ENTITY_CLAMP_BOUND 0 TO 1,000,000
);
//Creates an aggregation constraint policy that automatically uses
entities -- assigned
to underlying tables.
CREATE AGGREGATION POLICY paycheck_aggregation_policy
AS ( )
RETURNS AGGREGATION_CONSTRAINT −>
AGGREGATION_CONSTRAINT( );
//Assigns policy to a table - attached entities will be automatically
used by a policy
with -- their settings defined either within an entity or within an
attachment.
ALTER TABLE paychecks SET AGGREGATION POLICY
paycheck_aggregation_policy;
ALTER TABLE employees SET AGGREGATION POLICY
paycheck_aggregation_policy;
//In case a user needs to overwrite some of the entity configuration --
parameters, they
can create a policy that references required entities -- explicitly
from the policy body.
CREATE AGGREGATION POLICY custom_policy REFERENCES
ssn AS ( )
RETURNS AGGREGATION_CONSTRAINT −>
AGGREGATION_CONSTRAINT(
entity=>PRIVATE_ENTITY_REFERENCE(
name=> ‘db.sch.user_entity’,
min_group_size=>10, //Overwrite default min_group_size. ‘ssn’));
ALTER TABLE paychecks SET AGGREGATION POLICY
custom_policy
REFERENCES reciever_ssn;
::::::CODE::::::

According to some examples, these can be enforced through entity definition and/or entity definition label by itself does not affect access to a dataset in any way. However, as soon as an entity definition is applied to a dataset, it will be respected by privacy policies (e.g., aggregation constraints or DP policies).

In some examples including aggregation constraint enforcement, if at least one entity is defined for a dataset, an aggregation policy will start using this entity definition for group suppressions. For example, in order to calculate a group size, the entity-level privacy system 260 will count the number of distinct entity identifiers instead of the count of distinct synthetic row identifiers. In some examples, if there are more than one column in an entity identifier, the entity-level privacy system 260 will have to combine them together (e.g., in a way that preserves tuple equality) before applying a distinct count. To enforce a minimum group size, the entity-level privacy system 260 can take its threshold from an entity definition. For example, if several entity definitions are attached to a dataset (e.g., user and household), each of them is enforced separately. If min_group_size is present on a policy aggregation constraint expression, the entity-level privacy system 260 still enforces it on a row level. According to some examples, the entity-level privacy system 260 can perform backward compatibility and still allow customers to do row level enforcement when needed. For example, the entity-level privacy system 260 can allow users to set min_group_size to NULL, 0 or just omit it in aggregation constraint expressions at all, if users just need entity-level privacy.

Another more flexible way of dealing with entities is to allow a policy to specify an entity within its body, effectively allowing to enable and/or disable different entities depending on the context the policy body is executed. Using this example approach for private entity configuration type and functions, the entity-level privacy system 260 can add a new internal configuration type, similar to AGGREGATION_CONSTRAINT, called PRIVATE_ENTITY, with the following fields: min_group_size (e.g., minimum size of entities needed to be present in an aggregation group for this group to be allowed to be returned to a user) and key_columns (e.g., list of key columns that form entity id). This can include a policy configuration option that is a set of policy-specific named options that will grow while new privacy related policies are added.

For instance, the expression PRIVATE_ENTITY(min_group_size=>10, ‘user_name’, ‘user_surname’) creates a configuration for a private entity with the key column (user_name, user_surname) and minimum group size enforcement equal to 10.

To simplify the process of creation of policies (e.g., aggregation constraint) that depend on lists of private entities, the entity-level privacy system 260 can include a function that will create lists: ● PRIVATE_ENTITY_LIST(entity PRIVATE_ENTITY [, . . . ]). For instance, the expression:

PRIVATE_ENTITY_LIST(PRIVATE_ENTITY(min_group_size=>10, “user_id”), PRIVATE_ENTITY(min_group_size=>5, “house_hold_id”))
creates a list of private entities configurations corresponding to users and households.

In some examples, the entity-level privacy system 260 or other components of the cloud data platform 102 can adjust aggregation constraint policy syntax to support entities. For example, first, the entity-level privacy system 260 can allow a policy to reference columns from a table to be used with an entity. This will allow to have different names for columns corresponding to entity keys in different tables, as well as ensure that users are aware about dependency between aggregation policy configuration and table columns (e.g., entity id columns used by a policy should be deleted from a table unless a user changes a policy de-referencing those columns).

An example syntax for aggregation policy creation and attachment is as follows:

:::::::CODE::::::
CREATE AGGREGATION POLICY {policy_name} REFERENCES
{entity_id_key_names} [, ...] AS ( )
RETURNS AGGREGATION_CONSTRAINT −> { policy_body };
ALTER TABLE {table_name}
SET AGGREGATION POLICY { policy_name }
REFERENCES {entity_id_column_names} [, ...];
:::::::CODE::::::

According to the above example syntax, {entity_id_key_names} allows the user to specify a list of column names forming an entity key. These can be random identifiers which serve a role similar to function parameters: these names will be referenced by an entity definition defined in a policy body. In some examples, {entity_id_column_names} can specify the list of columns from the {table_name} table that should correspond to the list of entity id columns defined by {entity_id_key_names}. According to some examples, the REFERENCES keyword here is used to denote referenced columns, since this keyword in the syntax has the same meaning as the ANSI standard SQL REFERENCES keyword that is used with foreign keys. Moreover, foreign key trees conceptually describe logical (not just private) entities and, thus, can serve as entity definitions, which makes the keyword reuse here even more appealing. However, it will be understood that other keywords can be used according to example embodiments presented herein.

Such examples provide flexibility in configuring entity settings per particular execution context and are easy to integrate with separate entity schema objects. In some examples, a view can be used as an entity definition. Since entity is mostly a list of column definitions, it can be represented as a view that projects entity key columns from a table. In some examples, foreign keys can be used as an entity definition. Since the tree is made from foreign key traversal most of the time, it fully describes a logical entity, it can use foreign key trees as a private entity definition, enabling the reuse of an existing concept that many production ready schemas can already use to define logical entities. In some examples, function parameter syntax can be used to represent entity columns, where using a function parameter syntax instead of a separate keyword (e.g., REFERENCES or USING) to represent referenced entity columns. For example:

:::::::CODE::::::
CREATE AGGREGATION POLICY test_policy AS (user_id string,
household_id
string)
RETURNS AGGREGATION_CONSTRAINT −>
AGGREGATION_CONSTRAINT(
min_group_size=>2,
entity=>ARRAY_CONSTRUCT(user_id, household_id));
ALTER TABLE protected_table ADD AGGREGATION POLICY
test_policy ON
(user_id, h_id);
::::::CODE::::::

Additional example embodiments provide different forms of constraints to give providers more ways to protect their data. For example, providers can be enabled to limit the rate at which consumers can issue queries, the fraction of the dataset the consumer can access (e.g., before or after filters are applied), and/or the types of data that can be combined together in a single query. In additional example embodiments, differential privacy can be implemented by a DP-aggregation constraint. Further examples provide enhanced audit capabilities to allow providers to closely monitor how consumers are using provider data. For example, a provider can find out if a data consumer is crafting a sequence of abusive queries to attempt to expose PII about a specific individual. The cloud data platform 102 can support a variety of constraints and constraint types, including, for example, single-column constraints, multi-column constraints, inline constraints, out-of-line constraints, and many more.

In some examples, as DP supports several policies per table, the entity-level privacy system 260 can use a model where a single entity per policy is attached. To attach several entities to a table, a provider can just create several policies and attach them separately. The model allows a single policy to be attached to entity keys of different sizes (e.g., one table may store the key in a form of a single column called ‘phone_number’, while another table may store the same key as a combination of ‘country_code’ and ‘local_phone’). In some examples, the cloud data platform 102 enables a single policy to be attached to entity keys of different sizes (e.g., one table can store the key in a form of a single column called ‘phone_number’ while another table can store the same key as a combination of ‘country_code’ and ‘local_phone.’

In some examples, similarly to aggregation constraints, the cloud data platform 102 can include an entity key clause to add a privacy policy statement. The clause can include a potential list of default properties that include differential privacy. For example, as differential privacy (DP) supports several policies per table, the cloud data platform 102 can support a model that always has a single entity per policy. To attach several entities to a table, a provider can create several policies and attach them separately. In some examples, the provider can create several policies and attach them in a group.

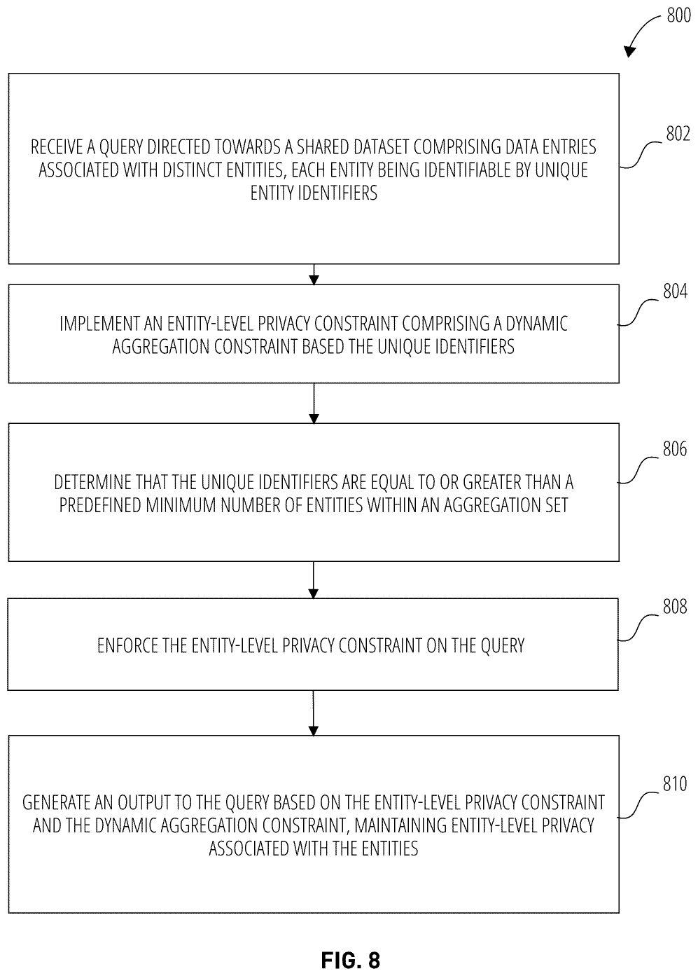

FIG. 8 illustrates a flow diagram of a method 800 for employing entity-level privacy policies with aggregation policies, in accordance with some example embodiments. The method 800 can be embodied in machine-readable instructions and/or machine-storage instructions for execution by one or more hardware components (e.g., one or more processors, one or more hardware processors, at least one hardware processor, etc.) such that the operations of the method 800 can be performed by components of the systems depicted in FIG. 1, FIG. 2, and/or FIG. 4, such as the compute service manager 108, the execution platform 110, the entity-level privacy system 260, or components thereof. Accordingly, the method 800 is described below, by way of example with reference to components of the entity-level privacy system 260. However, it shall be appreciated that method 800 can be deployed on various other hardware configurations and is not intended to be limited to deployment within the hardware of examples presented herein.

Depending on the example embodiment, an operation of the method 800 can be repeated in different ways or involve intervening operations not shown. Though the operations of the method 800 can be depicted and described in a certain order, the order in which the operations are performed may vary among embodiments, including performing certain operations in parallel or performing sets of operations in separate processes. While the various operations in this flowchart are presented and described sequentially, one of ordinary skill will appreciate that some or all of the operations may be executed in a different order, be combined, or omitted, or be executed in parallel.

In operation 802, the entity-level privacy system 260 receives a query directed towards a shared dataset, the shared dataset comprising one or more data entries associated with one or more distinct entities, each entity of the one or more distinct entities being identifiable by one or more unique entity identifiers. In operation 804, the entity-level privacy system 260 implements an entity-level privacy constraint, the entity-level privacy constraint comprising a dynamic aggregation constraint based on the one or more unique identifiers (e.g., one or more unique entity identifiers). In operation 806, the entity-level privacy system 260 determines that the one or more unique identifiers are equal to or greater than a predefined minimum number of entities. In operation 808, the entity-level privacy system 260 enforces the entity-level privacy constraint on the query. In operation 810, the entity-level privacy system 260 generates an output to the query based on the entity-level privacy constraint and the dynamic aggregation constraint while maintaining entity-level privacy associated with the one or more distinct entities.

According to further examples the method 800, example embodiments provide an entity-level privacy system designed to ensure entity-level privacy in the process of data aggregation. Each dataset is composed of data records (e.g., rows) connected to entities (e.g., columns), with each entity being represented by one or more unique keys, which allows for the organized storage and retrieval of entity-specific data. Where a privacy enhancement technology (PET) component applies specific aggregation constraints to the datasets. These constraints are based on predefined entity keys and are designed to ensure that each aggregation group includes a minimum number of unique entities, thus maintaining the privacy of individual data points within the aggregated information. The PET component can suppress an aggregation group from query results if it fails to meet the predetermined minimum number of unique entities, providing an additional layer of privacy.

In some examples, an entity key specification component provides users the ability to define attributes (e.g., via a user interface) that identify an entity within the datasets. This component supports the specification of both identifiers, quasi-identifiers, and/or attributes as entity keys, facilitating flexible and secure data handling.

In some examples, a query processing component adjusts query results in accordance with the aggregation constraints and the entity-level privacy constraints used in combination. This adjustment ensures entity-level privacy is maintained while still permitting the aggregated data of entities to be analyzed and utilized. The query processing component can apply differential privacy techniques to further protect privacy in the query results.

In some examples, a policy management component defines, manages, and directs privacy policies that safeguard entity-level privacy. It enables the specification of the minimum number of unique entities required for an aggregation group to be considered in query results, allowing for customized privacy thresholds across different datasets. In some examples, an encryption component enhances the privacy protection of entity identifiers by encrypting or hashing the entity keys. Advanced encryption standards are employed to secure these keys, further bolstering the system's defense against unauthorized access.

In some examples, the entity-level privacy system 260 incorporates several advanced features to enhance its functionality. For example, the entity-level privacy system's adaptability to various data storage formats and structures facilitates its seamless integration with existing databases and data management systems. According to some examples, a user interface component is included to offer users feedback on how their specified entity keys and aggregation constraints might influence query results. In some examples, the entity-level privacy system can be implemented within a data clean room technology framework, the system extends privacy protection to entities across multiple datasets, leveraging a combination of aggregation constraints and entity-level privacy constraints integration for enhanced privacy. This system represents a comprehensive solution for ensuring entity-level privacy in data aggregation, addressing both the technical and operational aspects necessary for safeguarding sensitive data.

Another general aspect is for a system that includes a memory comprising instructions and one or more computer processors or one or more hardware processors. The instructions, when executed by the one or more computer processors, cause the one or more computer processors to perform operations. In yet another general aspect, a tangible machine-readable storage medium (e.g., a non-transitory storage medium) includes instructions that, when executed by a machine, cause the machine to perform operations.

Described implementations of the subject matter can include one or more features, alone or in combination as illustrated below by way of example.

Example 1 is a method comprising: receiving a query directed towards a shared dataset, the shared dataset comprising one or more data entries associated with one or more distinct entities, each entity of the one or more distinct entities being identifiable by one or more unique entity identifiers; implementing, by at least one hardware processor, an entity-level privacy constraint, the entity-level privacy constraint comprising a dynamic aggregation constraint based on the one or more unique entity identifiers; determining that the one or more unique entity identifiers satisfy a threshold condition comprising a minimum number of entities; enforcing the entity-level privacy constraint on the query based on determining the one or more unique entity identifiers satisfy the threshold condition; and generating an output to the query based on the entity-level privacy constraint and the dynamic aggregation constraint while maintaining entity-level privacy associated with the one or more distinct entities.

In Example 2, the subject matter of Example 1 includes, determining the one or more unique entity identifiers fails to comply with the dynamic aggregation constraint; and in response to the determining, excluding the one or more unique entity identifiers from the output to the query.

In Example 3, the subject matter of Examples 1-2 includes, enforcing the dynamic aggregation constraint based on the one or more unique entity identifiers, wherein the one or more unique entity identifiers comprise an entity key; and receiving data defining the entity key identifies the one or more distinct entities attached to the first table.

In Example 4, the subject matter of Example 3 includes, wherein the entity key identifies the one or more distinct entities further comprises: identifying the one or more distinct entities based on the entity key, wherein the entity key comprises one or more columns within a database table; and enforcing a minimum entity count for the one or more unique entity identifiers, wherein the minimum entity count is based on a distinct combination of the one or more columns within a database table.

In Example 5, the subject matter of Example 4 includes, implementing an enhanced aggregation policy that incorporates the entity key, wherein the enhanced aggregation policy comprises: the minimum entity count specifies a threshold number of the one or more distinct entities that must be present within the one or more unique entity identifiers; and a minimum group size that specifies a threshold number of rows that must be present within the one or more unique entity identifiers.

In Example 6, the subject matter of Examples 1-5 includes, determining whether the query is a valid query based, at least in part, on the minimum number of the one or more unique entity identifiers; and rejecting the query based on determining that the query is invalid.

In Example 7, the subject matter of Examples 1-6 includes, wherein the dynamic aggregation constraint ensure that the one or more unique entity identifiers contains a predetermined minimum number of unique entities.

In Example 8, the subject matter of Examples 1-7 includes, providing an entity key user interface to enable a user to specify an attribute to identify the one or more distinct entities within the shared dataset, wherein the attribute is at least one of an identifier attribute or a quasi-identifier attribute.

In Example 9, the subject matter of Examples 1-8 includes, wherein determining that the one or more unique entity identifiers satisfy the threshold condition further comprises: determining that the one or more unique entity identifiers are equal to or greater than a predefined minimum number of entities in an aggregation group.

In Example 10, the subject matter of Examples 1-9 includes, generating a data clean room in a first account, the first account being associated with a provider database account; installing, in a second account, an application instance that implements the data clean room, the second account being associated with a consumer database account of a second entity; and sharing, by the provider database account, source provider data with the data clean room, the sharing making the source provider data accessible to the consumer database account via the application instance.

Example 11 is a system comprising: one or more hardware processors of a machine; and at least one memory storing instructions that, when executed by the one or more hardware processors, cause the system to perform operations comprising: receiving a query directed towards a shared dataset, the shared dataset comprising one or more data entries associated with one or more distinct entities, each entity of the one or more distinct entities being identifiable by one or more unique entity identifiers; implementing, by at least one hardware processor, an entity-level privacy constraint, the entity-level privacy constraint comprising a dynamic aggregation constraint based on the one or more unique entity identifiers; determining that the one or more unique entity identifiers satisfy a threshold condition comprising a minimum number of entities; enforcing the entity-level privacy constraint on the query based on determining the one or more unique entity identifiers satisfy the threshold condition; and generating an output to the query based on the entity-level privacy constraint and the dynamic aggregation constraint while maintaining entity-level privacy associated with the one or more distinct entities.

In Example 12, the subject matter of Example 11 includes, the operations further comprising: determining the one or more unique entity identifiers fails to comply with the dynamic aggregation constraint; and in response to the determining, excluding the one or more unique entity identifiers from the output to the query.

In Example 13, the subject matter of Examples 11-12 includes, the operations further comprising: enforcing the dynamic aggregation constraint based on the one or more unique entity identifiers, wherein the one or more unique entity identifiers comprise an entity key; and receiving data defining the entity key identifies the one or more distinct entities attached to the first table.

In Example 14, the subject matter of Example 13 includes, wherein the entity key identifies the one or more distinct entities further comprises: identifying the one or more distinct entities based on the entity key, wherein the entity key comprises one or more columns within a database table; and enforcing a minimum entity count for the one or more unique entity identifiers, wherein the minimum entity count is based on a distinct combination of the one or more columns within a database table.

In Example 15, the subject matter of Example 14 includes, the operations further comprising: implementing an enhanced aggregation policy that incorporates the entity key, wherein the enhanced aggregation policy comprises: the minimum entity count specifies a threshold number of the one or more distinct entities that must be present within the one or more unique entity identifiers; and a minimum group size that specifies a threshold number of rows that must be present within the one or more unique entity identifiers.

In Example 16, the subject matter of Examples 13-15 includes, the operations further comprising: determining whether the query is a valid query based, at least in part, on the minimum number of the one or more unique entity identifiers; and rejecting the query based on determining that the query is invalid.

In Example 17, the subject matter of Examples 13-16 includes, wherein the dynamic aggregation constraint ensure that the one or more unique entity identifiers contains a predetermined minimum number of unique entities.

In Example 18, the subject matter of Examples 13-17 includes, the operations further comprising: providing an entity key user interface to enable a user to specify an attribute to identify the one or more distinct entities within the shared dataset, wherein the attribute is at least one of an identifier attribute or a quasi-identifier attribute.

In Example 19, the subject matter of Examples 11-18 includes, the operations further comprising: generating a data clean room in a first account, the first account being associated with a provider database account; installing, in a second account, an application instance that implements the data clean room, the second account being associated with a consumer database account of a second entity; and sharing, by the provider database account, source provider data with the data clean room, the sharing making the source provider data accessible to the consumer database account via the application instance.

In Example 20, the subject matter of Examples 11-19 includes, wherein determining that the one or more unique entity identifiers satisfy the threshold condition further comprises: determining that the one or more unique entity identifiers are equal to or greater than a predefined minimum number of entities in an aggregation group.

Example 21 is a machine-storage medium embodying instructions that, when executed by a machine, cause the machine to perform operations comprising: receiving a query directed towards a shared dataset, the shared dataset comprising one or more data entries associated with one or more distinct entities, each entity of the one or more distinct entities being identifiable by one or more unique entity identifiers; implementing, by at least one hardware processor, an entity-level privacy constraint, the entity-level privacy constraint comprising a dynamic aggregation constraint based on the one or more unique entity identifiers; determining that the one or more unique entity identifiers satisfy a threshold condition comprising a minimum number of entities; enforcing the entity-level privacy constraint on the query based on determining the one or more unique entity identifiers satisfy the threshold condition; and generating an output to the query based on the entity-level privacy constraint and the dynamic aggregation constraint while maintaining entity-level privacy associated with the one or more distinct entities.

In Example 22, the subject matter of Examples 11-21 includes, the operations further comprising: determining the one or more unique entity identifiers fails to comply with the dynamic aggregation constraint; and in response to the determining, excluding the one or more unique entity identifiers from the output to the query.

In Example 23, the subject matter of Examples 21-22 includes, the operations further comprising: enforcing the dynamic aggregation constraint based on the one or more unique entity identifiers, wherein the one or more unique entity identifiers comprise an entity key; and receiving data defining the entity key identifies the one or more distinct entities attached to the first table.

In Example 24, the subject matter of Example 23 includes, wherein the entity key identifies the one or more distinct entities further comprises: identifying the one or more distinct entities based on the entity key, wherein the entity key comprises one or more columns within a database table; and enforcing a minimum entity count for the one or more unique entity identifiers, wherein the minimum entity count is based on a distinct combination of the one or more columns within a database table.

In Example 25, the subject matter of Example 24 includes, the operations further comprising: implementing an enhanced aggregation policy that incorporates the entity key, wherein the enhanced aggregation policy comprises: the minimum entity count specifies a threshold number of the one or more distinct entities that must be present within the one or more unique entity identifiers; and a minimum group size that specifies a threshold number of rows that must be present within the one or more unique entity identifiers.

In Example 26, the subject matter of Examples 21-25 includes, the operations further comprising: determining whether the query is a valid query based, at least in part, on the minimum number of the one or more unique entity identifiers; and rejecting the query based on determining that the query is invalid.

In Example 27, the subject matter of Examples 21-26 includes, wherein the dynamic aggregation constraint ensure that the one or more unique entity identifiers contains a predetermined minimum number of unique entities.

In Example 28, the subject matter of Examples 21-27 includes, the operations further comprising: providing an entity key user interface to enable a user to specify an attribute to identify the one or more distinct entities within the shared dataset, wherein the attribute is at least one of an identifier attribute or a quasi-identifier attribute.

In Example 29, the subject matter of Examples 21-28 includes, wherein determining that the one or more unique entity identifiers satisfy the threshold condition further comprises: determining that the one or more unique entity identifiers are equal to or greater than a predefined minimum number of entities in an aggregation group.

In Example 30, the subject matter of Examples 21-29 includes, the operations further comprising: generating a data clean room in a first account, the first account being associated with a provider database account; installing, in a second account, an application instance that implements the data clean room, the second account being associated with a consumer database account of a second entity; and sharing, by the provider database account, source provider data with the data clean room, the sharing making the source provider data accessible to the consumer database account via the application instance.

Example 31 is at least one machine-readable medium including instructions that, when executed by processing circuitry, cause the processing circuitry to perform operations to implement of any of Examples 1-30.

Example 32 is an apparatus comprising means to implement of any of Examples 1-30.

Example 33 is a system to implement of any of Examples 1-30.

Example 34 is a method to implement of any of Examples 1-30.

FIG. 9 is a block diagram 900 illustrating an example Entity Group Size 932 for aggregation constraint group size and/or entity-level privacy constraint count size, according to some example embodiments. The cloud data platform 102 can enforce individual privacy through aggregation constraint group size and/or entity-level privacy constraint count size by enabling providers to select larger minimum group sizes to provide better protection.

In some examples, every aggregation policy specifies a minimum group size. Before the introduction of entity-level privacy, the minimum group size defined the number of records that must be included in an aggregation group. The inclusion of entity-level privacy enables the minimum group sizes to define how many entities must be included in an aggregation group. Having a projection policy on an entity key column does not affect how the cloud data platform 102 calculates whether there are enough entities in an aggregation group. Having a masking policy on an entity key column does not affect how the cloud data platform 102 calculates whether there are enough entities in an aggregation group. When a masking policy is assigned to the GROUP BY column, the aggregation groups formed by the query are based on the values returned by the masking policy. Each of these groups must have enough entities. In some examples, in cases where name references are used several times (e.g., in JOIN or UNION operators), the cloud data platform 102 enforces the minimum group size for each name reference of each dataset separately. This applies even when the reference points to the same dataset several times.

Examples of aggregation constraint group size can include an additional signature to the AGGREGATION_CONSTRAINT( ) function, such as AGGREGATION_CONSTRAINT(min_row_count=>{number}, min_entity_count=>{number}). Where the min_entity_count parameter denotes the minimum number of entities that must be present in an aggregation group for this group to be returned to a user, while the min_row_count specifies a similar number of rows. In some examples, specify min_row_count only when it is larger (e.g., bigger) than min_entity_count, since the number of entities in the output will always be less than the number of rows. In some examples, for the existing AGGREGATION_CONSTRAINT(min_group_size) function, the entity-level privacy system 260 adjusts the meaning of the min_group_size parameters such that it will mean the minimum number of entities for tables/views that have entities attached and minimum number of rows, if entity key is not present in the attachment for this table. This will allow the system to use the same policies with tables requiring entity-level privacy and tables that do not need it. In some examples, the entity-level privacy system 260 can add an additional ENTITY KEY clause to the ‘ALTER TABLE/VIEW . . . SET AGGREGATION POLICY’ statement as follows:

::::::CODE::::::
ALTER (TABLE|VIEW) <table_name> SET AGGREGATION POLICY
<policy_name>
ENTITY KEY <entity_key_column> [, ... ]
[ [ WITH ] DEFAULT min_entity_count=>{number} ];
::::::CODE::::::

Here, entity_key_column is a list of columns forming an entity key. The min_entity_count is an optional parameter that sets a default value for an aggregation policy min_entity_count. Aggregation policy bodies can overwrite this parameter by using the min_entity_count argument.

To calculate the number of unique entity identifiers, the entity-level privacy system 260 or component thereof can use original values of entity key columns provided by protected views/tables and not computed values obtained due to external transformations, like masking policies. The AGGREGATION_CONSTRAINT( ) function allows to set both parameters min_row_count and min_entity_count at the same time. In some examples, both of these parameters can be enforced independently, that is: If the min_row_count parameter is set to positive value, the aggregation constraint makes sure that there are at least min_row_count rows from a protected table in an aggregation group and/or if the min_entity_count parameter is set to positive value or there is a default min_entity_count parameter set on a protected table, the aggregation constraint makes sure that there are at least min_entity_count distinct entity_key_column values in an aggregation group. In some examples, the min_entity_key parameter applied in a policy body always has a preference over the min_entity_key parameter applied on a table body. At the same time, the min_group_size parameter in the original signature will mean either number of entities or number of rows depending on whether an entity is specified for a table.

According to some examples, the entity-level privacy system 260 can maintain the same JOIN/UNION semantics as for the row-level privacy. For example, minimum group threshold will be enforced separately for each table/view reference participating in a join or union. In some examples, there is a separate group size threshold enforcement even for the case when customer references the same table/view from different branches of UNION ALL in order to prevent an attack when a user reveals an approximate entity value by having a union on values from two separate columns with different scale (e.g., age and salary). For example, consider the following query:

::::::CODE::::::
WITH cte AS (
SELECT age AS val FROM protected_table
UNION ALL
SELECT year_salary AS val FROM protected_table WHERE
user_id=123
)
SELECT SUM(val) FROM cte GROUP BY departement_id;
::::::CODE::::::

Based on the above query, since age and year_salary have a completely different scale (e.g., year_salary is significantly bigger than age), the year_salary would dominate the result of computation revealing an approximate salary.

According to some examples, the aggregation constraints including entity level privacy can include the cloud data platform 102 supporting several aggregation constraint entities per table. For example, multiple aggregation constraint entities can be implemented by adding a name to each entity and reference them by this name in a policy body. In some examples, multiple aggregation constraint entities can be implemented by the cloud data platform 102 supporting attaching several aggregation policies to a table.

Aggregation constraints can require the data objects (e.g., rows in the aggregation-constrained table) to be aggregated into groups of a specified minimum size, where each group must have certain properties. For example, each row from the aggregation-constrained table can be represented at most once in a given group. In additional examples, each group represents at least a minimum group size (e.g., minimum number) of rows from the aggregation-constrained table, where groups that do not meet the requirement are combined into a residual group at execution time, for example. In some example embodiments, for each aggregation constraint, the provider can specify a minimum group size (e.g., select a minimum group size 901 and/or a minimum entity count 902). For example, each aggregate group must include at least the minimum number of rows from the underlying table, where groups below the specified size are organized into a residual group (e.g., a remainder group, a group for others, crumbs, leftovers, etc.) including a NULL key. In some example embodiments, if the residual (e.g., crumbs) group is non-empty but below the threshold size, the values will also be NULL. In an example of multiple constrained input tables, the minimum group size rules can be applied independently for each input table.

In example embodiments of aggregation constraint group size, a provider is responsible for selecting or picking the group size based on the provider's privacy goals, data distribution, or the like. In additional example embodiments, providers can specify different group sizes (e.g., different minimums) depending on which columns in the table are queried. For example, a provider can select, via a user interface or programming interface, a minimum group size being one or more sizes displayed to the provider as large 910, medium 920, or small 930. Where large 910 includes a minimum group size of at least 1000 data objects (e.g., rows), medium 920 includes a minimum group size of at least 100 data objects, and small 930 includes a minimum group size of at least 10 data objects. Different providers can be shown varying group sizes of any number that is relevant to the provider based on the provider's needs or business purposes, and it should be understood that the numbers provided in FIG. 9 are for exemplary purposes.

The aggregation system 250 enforces aggregation constraints on data values stored in specified tables of a shared dataset when queries are received by the cloud data platform 102. An aggregation constraint identifies that the data in a table may be restricted from being aggregated (e.g., joined, presented, read, outputted) in an output to a received query, while allowing specified operations to be performed on the data and a corresponding output to be provided. For example, the aggregation constraint may indicate a context for a query that triggers the aggregation constraint, such as based on the user, role, accounts, shares associated with the query, or other triggers. The aggregation constraint can be a policy that is attached to one or more tables, where the policy can consider a context (e.g., current role, account, etc.). The policy result can indicate the minimum group size for aggregation or NULL (e.g., no restriction).

According to some example embodiments, the first time an aggregation-constrained table (or view) is aggregated can be called a constrained aggregation. In a constrained aggregation, all aggregate functions must be permitted aggregate functions. In some examples, the output from a constrained aggregation is not aggregation constrained. No restrictions are placed on what queries can do with the data after it has been safely aggregated. The cloud data platform 102 or a component thereof can enforce a minimum group size on each aggregate group of a constrained aggregation. This minimum group size is specified as part of the aggregation policy attached to the aggregation-constrained table. The cloud data platform 102 can enforce the minimum group size as follows: (1) Each group must have at least as many rows from the aggregation-constrained table as the minimum group size. (2) Rows belonging to groups that are too small are combined into a remainder group. All key attributes are NULL for the remainder group (while key attributes can be NULL for other reasons related to underlying row values or due to the use of Group-By sets). (3) If the remainder group itself is too small, the aggregate values for the remainder group are NULL as well. In some example embodiments, a Group-By (or an aggregate) is a query block that (1) has a group by key, or (2) has an aggregate function.

According to some examples, an aggregation constraint is maintained as a type of policy, such as an aggregation policy or aggregation constraint policy, which can be a schema-level object. The contents of the aggregation policy can be expressed as a Lambda expression to express functionality as first-class objects that can be passed as arguments to other functions or stored in variables. Below is one possible example of applicable code to illustrate a syntax of an expression:

```
::::::CODE::::::
  create or replace aggregation policy consumer_agg_100 as
  ( ) returns aggregation_config −>
  case
  when current_account( ) = ‘MY_ACCOUNT’ then
  aggregation_config( )
  else aggregation_config(100)
  end;
  alter table sales set aggregation policy consumer_agg_100;
::::::CODE::::::
```

The expression can return an appropriate minimum group size based on context, or the expression can return NULL if no aggregation constraint should be enforced in the specific example. The aggregation constraints can be enforced at different times when an aggregation policy function is executed; for example, the aggregation constraint(s) can be enforced at compile time, execution time, or the like.

FIG. 10 is a block diagram 1000 illustrating components of the aggregation system 250 as described and depicted in connection with FIG. 2, according to some example embodiments. As explained above, databases are used by various entities (e.g., businesses, people, organizations, etc.) to store data. For example, an entity using a database can include a retailer that may store data describing purchases (e.g., product, date, price, etc.) and the purchasers (e.g., name, address, email address, etc.). Similarly, an entity using a database can include an advertiser that may store data describing performance of their advertising campaigns, such as the advertisements served to users, date that advertisement was served, information about the user, (e.g., name, address, email address, etc.), and the like.

In some cases, entities may wish to share their data with each other. For example, the retailer and the advertiser may wish to share some or all of their respective data to determine the effectiveness of an advertisement campaign, such as by determining whether users that were served advertisements for a product ultimately purchased the product. In these types of situations, the entities may wish to maintain the confidentiality of some or all of the data they have collected and stored in their respective databases. For example, a retailer and/or advertiser may wish to maintain the confidentiality of personal identifying information (PII), such as usernames, addresses, email addresses, credit card numbers, and the like. As another example, entities sharing data may wish to maintain the confidentiality of individuals in their proprietary datasets.

The aggregation system 250 as depicted in the block diagram 1000 provides for components to enable entities to share data while maintaining confidentiality of private information. The aggregation system 250 can be implemented within the cloud data platform 102 when processing requests (e.g., queries) directed to shared datasets. For example, in some embodiments, the aggregation system 250 can be implemented within a clean room provided by the data clean room system 230 as described and depicted in connection with FIGS. 2 and 14A to 16, or combinations thereof.

As shown in FIG. 10, the aggregation system 250 includes an aggregation constraint generation component 1001, a query receiving component 1002, a data accessing component 1003, a table identification component 1004, an aggregation constraint determination component 1005, a query context determination component 1006, an enforcement determination component 1007, and an aggregation constraint enforcement component 1008. Although the example embodiment of the aggregation system 250 includes multiple components, a particular example of the aggregation system can include varying components in the same or different elements of the cloud data platform 102.

The aggregation constraint generation component 1001 enables entities to establish aggregation constraints (e.g., aggregation constraint policies) to shared datasets. For example, the aggregation constraint generation component 1001 can provide a user interface or other means of user communication that enables one or more entities to define aggregation constraints in relation to data associated with a provider or consumer, where the data is maintained and managed via the cloud data platform 102. The aggregation constraint generation component 1001 can allow a user of the cloud data platform 102 to define an aggregation constraint, such as an aggregation policy to provide a set of guidelines and rules that determine how data is collected, processed, managed, presented, shared, or a combination thereof for data analysis.

The aggregation constraint generation component 1001 enables users to provide data defining one or more shared datasets and tables to which the one or more aggregation constraints should be attached. Further, the aggregation constraint generation component 1001 enables users to define conditions for triggering the aggregation constraint, which can include defining the specific context(s) that triggers enforcement of (e.g., application of) the aggregation constraint. For example, the aggregation constraint generation component 1001 can enable users to define roles of users, accounts, shares, or a combination thereof, which would trigger the aggregation constraint and/or are enabled to aggregate the constrained table of data.

The query receiving component 1002 receives a query (e.g., request) directed to one or more shared datasets. The query can include information defining data to be accessed, shared, and one or more operations to perform on the data, such as any type of operation used in relation to data maintained and managed by the cloud data platform 102 (e.g., JOIN operation, READ operation, GROUP-BY operation, etc.). The query receiving component 1002 can provide the data associated with the query to other components of the aggregation system 250.

The data accessing component 1003 accesses (e.g., receives, retrieves, etc.) a set of data based on a query received by the query receiving component 1002 or other related component of the cloud data platform 102. For example, the data accessing component 1003 can access data from tables or other database schema of the shared dataset that are identified by the query or are needed to generate an output (e.g., shared dataset) based on the received query. The table identification component 1004 is configured to determine the table(s) associated with the data accessed by the data accessing component 1003 in response to a query. The table identification component 1004 can provide information (e.g., data, metadata, etc.) identifying the table(s) to other components of the cloud data platform 102 and/or to other components of the aggregation system 250, such as the aggregation constraint determination component 1005.

The aggregation constraint determination component 1005 is configured to determine whether an aggregation constraint (e.g., an aggregation constraint policy, aggregation policy, etc.) is attached to any of the tables identified by the table identification component 1004. For example, the aggregation constraint determination component 1005 determines or identifies whether a file defining an aggregation constraint is attached to or corresponds with any of the tables or other database schema identified by the table identification component 1004.

The query context determination component 1006 is configured to determine or identify a context associated with a received query. For example, the query context determination component 1006 can use data associated with a received query to determine the context, such as by determining a role of the user that submitted the query, an account of the cloud data platform 102 associated with the submitted query, a data share associated with the query, and the like. The query context determination component 1006 can provide data defining the determined context of the query to other components of the aggregation system 250, such as the enforcement determination component 1007. The enforcement determination component 1007 can be configured to determine whether an aggregation constraint should be enforced in relation to a received query.

If a query constraint is not attached to any of the tables, the aggregation constraint enforcement component 1008 determines that an aggregation constraint should not be enforced in relation to the specific query. However, if an aggregation constraint is attached to one of the tables, the aggregation constraint enforcement component 1008 uses the context of the query to determine whether the aggregation constraint should be enforced. For example, the aggregation constraint enforcement component 1008 can use the context of the query to determine whether conditions defined in a file attached to or associated with the table are satisfied in order to trigger the aggregation constraint. In some examples, the aggregation constraint enforcement component 1008 can use the context of the query as an input into a Boolean function defined by the aggregation constraint to determine whether the aggregation constraint is triggered and should be enforced or not enforced. According to some examples, the aggregation constraint enforcement component 1008 provides different return type options to an aggregation policy. For example, the return type can be a string where the aggregation policy returns a specific formatted string to specify the allowed actions that a compiler will understand as an aggregation configuration (e.g., min_group_size>10). In additional examples, the return type can be an object where the aggregation policy body uses the object construct to specify allowed actions as a key value pair (e.g., object_construct (‘min_group_size,’ 10). In additional examples, the return type can be an abstract data type (e.g., AGGREGATION_CONFIG).

The aggregation constraint enforcement component 1008 can prohibit an output to a query from including data values from any constrained tables of a shared dataset. For example, this can include denying a query altogether based on the operations included in the query (e.g., if the query requests to simply output the values of a constrained table). The aggregation constraint enforcement component 1008 can enable many other operations to be performed while maintaining the confidentiality (e.g., privacy) of data values in restricted tables or other database schema.

For example, an entity sharing data may define the aggregation constraints to be attached to various tables of a shared dataset. For example, the entity may define the table (e.g., tables, other schema level object(s), etc.) that the aggregation constraint should be attached to, as well as the conditions for triggering the aggregation constraint. When a query directed towards the shared dataset is received by the cloud data platform 102, the aggregation system 250 accesses the data needed to process the query from the shared database and determines whether an aggregation constraint is attached to any of the tables of the shared dataset from which the data was accessed. If an aggregation constraint is attached to one of the tables, the aggregation system 250 determines whether the aggregation constraint should be enforced based on the context of the query and generates an output accordingly. For example, if the aggregation constraint should be enforced, the aggregation system can generate, or cause to be generated, an output that does not include the data values stored in the tables but can provide an output determined based on the aggregation-constrained data.

For example, different combinations of aggregation constraint responses are considered, such as (a) rejecting the query (or request) if it queries individual rows rather than requesting one or more aggregate statistics across rows, (b) if the aggregate statistics for any given group of rows contains a sufficient number of rows (e.g., the “minimum group size”), the statistic for this group is included in the query result, (c) if the aggregate statistics for a given group does not meet the minimum group size threshold, these rows are combined into a remainder group, referred to herein as a residual group, that contains all rows for which the group size threshold was not met, and/or (d) an aggregate statistic is computed for the remainder group as well, and also included in the query result (when the remainder group itself meets the minimum group size threshold). Example embodiments can include some combinations or all combinations (e.g., parts (a) and (b) only, parts (a)/(b)/(c), or additional aggregation constraint responses may be added as described below in connection with FIG. 10).

An entity sharing data may define the aggregation constraints to be attached to various tables of a shared dataset. For example, the entity may define the table or tables (or other schema) that the aggregation constraint should be attached to, as well as the conditions for triggering the constraint. When a query directed towards the shared dataset is received by the cloud data platform 102, the aggregation system 250 accesses the data needed to process the query from the shared database and determines whether an aggregation constraint is attached to any of the tables of the shared dataset from which the data was accessed. If an aggregation constraint is attached to one of the tables, the aggregation system 250 determines whether the aggregation constraint should be enforced based on the context of the query and generates an output accordingly. For example, if the aggregation constraint should be enforced, the aggregation system 250 may generate an output that does not include the data values stored in the tables, or one or more columns of the tables, but may provide an output determined based on the constrained data, such as a number of matches, number of fuzzy matches, number of matches including a specified string, unconstrained data associated with the constrained data, and the like.

In some example embodiments, different users can specify different components of an aggregation constraint. For example, users can select one or more of the data to be protected by the constraint, the conditions under which the constraint is enforced (e.g., my account can query the raw data, but my data sharing partner's account can only query it in aggregated form), a minimum group size that queries must adhere to (e.g., each group must contain at least this many rows from the source table), and/or the class of aggregate functions that can be used for each attribute.

In some example embodiments, the aggregation constraint system includes receiving a constraint to a database table from the data steward (e.g., provider). The constraint specifies which principals (e.g., consumers, analysts, roles, etc.) are subject to the constraint, where a principal refers to an entity or user that can be granted permissions or access rights to system resources. For example, a principal can represent a user, group of users, application, or the like relating to a security framework with a central role in authorization, authentication, accountability processes, and the like (e.g., group principal, service principal, user principal, etc.). The constraint also specifies, for each principal who is subject to the constraint, the minimum number of rows that must be aggregated in any valid query. If a query does not meet this minimum, data is suppressed or the query is rejected, indicating an invalid query. Aggregation constraints work with data sharing and collaboration, provided that the sharing occurs on a common, trusted platform. In some example embodiments, the constraint is enforced by a common trusted data platform, (e.g., the cloud data platform). In additional example embodiments, the constraint could be enforced without the need to trust a common platform by using either (a) homomorphic encryption or (b) confidential computing.

In some example embodiments, the aggregation system 250 allows multiple sensitive datasets, potentially owned by different stakeholders, to be combined (e.g., joined or deduplicated using identifying attributes such as email address or social security number). The system enables analysts, consumers, and the like to formulate their own queries against these datasets, without coordinating or obtaining permission from the data owner (e.g., steward, provider, etc.). The system can provide a degree of privacy protection, since analysts are restricted to query only aggregate results, not individual rows in the dataset. The data steward/owner/provider can specify that certain roles or consumers have unrestricted access to the data, while other roles/consumers can only run aggregate queries. Furthermore, the provider can specify that for roles/consumers in the latter category, different consumers may be required to aggregate to a different minimum group size. For example, a highly trusted consumer may be seeing only aggregate groups of 50+ rows. A less trusted consumer may be required to aggregate to 500+ rows. Such example embodiments can express aggregation constraints as a policy, which can be a Structured Query Language (SQL) expression that is evaluated in the context of a particular query and returns a specification for the aggregation constraint applicable to that query.

In some example embodiments, the aggregation system 250 performs operations on the underlying table within the database built into the cloud data platform. The cloud data platform, or a trusted database processing system, can perform the aggregation policies according to different example embodiments as described throughout.

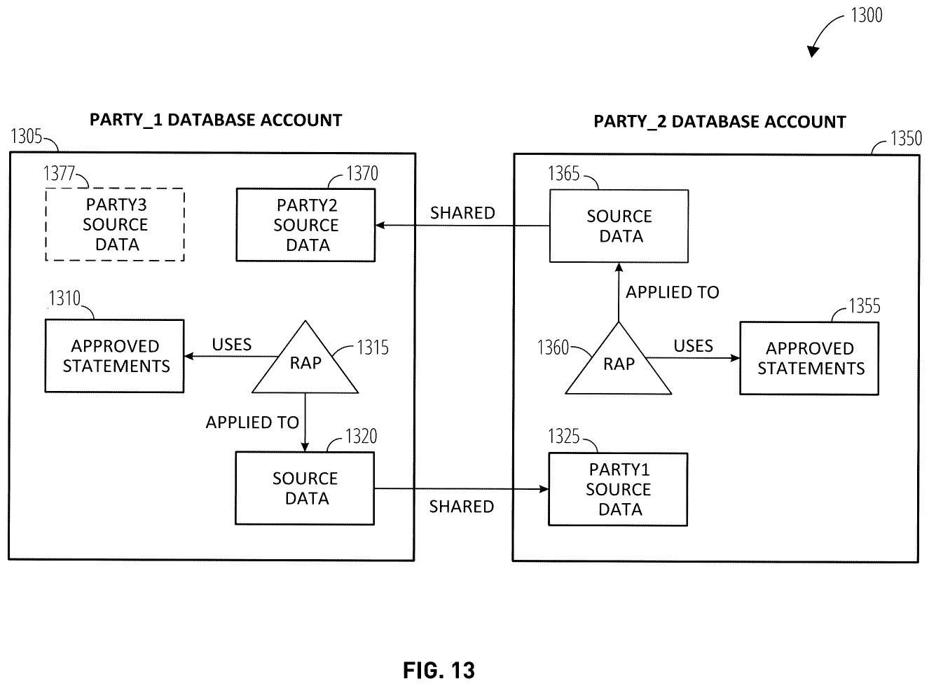

Enforcing aggregation constraints on queries received at the cloud data platform 102 allows for data to be shared and used by entities to perform various operations without the need to anonymize the data. As explained throughout, in some example embodiments, the aggregation system 250 can be integrated into a database clean room, as depicted, and described above with reference to FIG. 13 to FIG. 16 and/or used in conjunction with, parallel to, or in combination with the constraint system 240 as depicted and described above with reference to FIG. 2. The database clean room enables two or more end-users of the cloud data platform 102 to share and collaborate on their sensitive data, without directly revealing that data to other participants.

As an example, and in accordance with some example embodiments, the aggregation system 250 can implement aggregation constraints in a clean room to perform database end-user intersection operations (e.g., companies A and Z would like to know which database end-users they have in common, without disclosing PII of the user's customers). For instance, a company can implement the aggregation system 250 to provide enrichment analytics. In additional example embodiments, the aggregation system 250 can be implemented in a clean room to perform enrichment operations.

In some example embodiments, aggregation constraints can be enforced by aggregation system 250 when a query is submitted by a user and compiled. An SQL compiler of the aggregation system 250 analyzes each individual table accessed based on the query to determine the lineage of that table (e.g., where the data came from). In some example embodiments, the constraint-based approach of aggregation system 250 is integrated in an SQL-based system as discussed, here, however it is appreciated that the constraint-based approaches of the aggregation system 250 can be integrated with any different query language or query system, other than SQL, in a similar manner. In this way, a user submits a query, and the aggregation system 250 determines the meaning of the query, considers any applicable aggregation constraints, and ensures that the query complies with applicable constraints.

In some example embodiments, if the data is from an aggregation-constrained table(s), then the aggregation system 250 checks whether the aggregation constraint should be enforced based on context, such as the role of the user performing the query. If the aggregation constraint is intended to be enforced, then the aggregation system 250 prevents the column, or any values derived directly from that column, from being included in the query output. In some example embodiments, the aggregation system 250 implements constraints using a native policy framework of the cloud data platform 102 (e.g., dynamic data masking (column masking) and Row Access Policies). In some example embodiments, similar to a masking policy of the cloud data platform 102, the aggregation system 250, via the data provider, attaches a given aggregation constraint policy to one or more specific tables. In these example embodiments, the aggregation constraint policy body is evaluated to determine whether and how to limit access to that table when a given query is received from a consumer end-user.

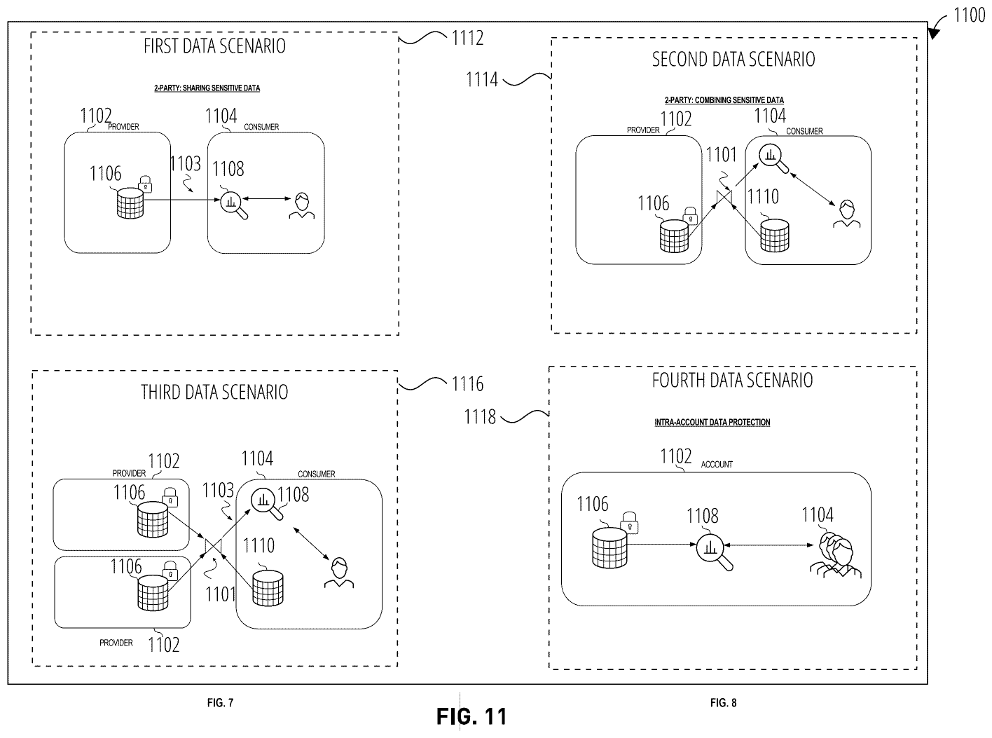

FIG. 11 illustrates a block diagram 1100 of four data sharing scenarios 1112/1114/1116/1118 including various data sharing scenarios in which aggregation constraints can be implemented with entity-level privacy, in accordance with some example embodiments. Specifically, the block diagram 1100 includes a first data scenario 1112 of two parties sharing sensitive data, a second data scenario 1114 of two parties combining sensitive data, a third data scenario 1116 including multiple data providers, and a fourth data scenario 1118 showing intra-account data protection.

The example in the first data scenario 1112 provides a simple data sharing scenario including a provider sharing data with one or more consumers, whether the consumer's queries must satisfy the aggregation constraints of the provider. In this type of scenario, the consumer 1104 (e.g., shared dataset) is associated with and managed by a single entity (e.g., combine 1101) and share 1103 with one or more other entities (e.g., provider 1102), according to some example embodiments. The consumer 1104 is therefore not a combination of data provided by multiple entities. In this type of scenario, the aggregation system 250 can be implemented to enforce aggregation constraints on data 1106 submitted by the provider 1102. The combine 1101 can implement aggregation constraints to protect any sensitive data (e.g., PII) by dictating which tables of data cannot be aggregated by the provider 1102. For example, the combine 1101 may establish an aggregation constraint to prohibit each of the provider 1102 from aggregating data in a protected table or set an aggregation constraint to vary whether the data can be aggregated based on the context of the query, such as which provider 1102 submitted a query. According to the example embodiment of FIG. 11, a provider user shares data with one or more consumer users, where the consumer queries must satisfy the provider's query constraint (e.g., aggregation constraint). In the two-party sharing of sensitive data, information flow is unidirectional.

The example in the second data scenario 1114 in which a provider 1102 shares data with the consumer 1104, which is combined 1101 with the consumer's data 1110, according to some example embodiments. In this type of scenario including the combination of sensitive data, the consumer 1104 is associated with and managed by a single entity (e.g., consumer 1104) and shared with one or more other entities (e.g., provider 1102), which combine the provider data 1106 with the consumer's own data 1110.

For example, combining data from two parties can include a provider sharing data in a database table that is protected by one or more aggregation constraints with a consumer. The consumer queries the database table, where the queries combine provider data and consumer data. The cloud data platform 102 enforces the provider's constraints on the consumer's queries. In this type of scenario, the aggregation system 250 can be implemented to enforce aggregation constraints on queries submitted by one or more consumers, such as provider 1102. The provider 1102 can implement aggregation constraints to protect any sensitive data by dictating which tables of data cannot be used by the provider 1102 via queries, while allowing the provider 1102 to perform operations on the consumer 1104 based on the consumer's data 1110. For example, the provider 1102 can perform operations to determine and/or output a number of matches between the consumer's data 1110 and data in the constrained tables of the consumer 1104 but may be prohibited from aggregating the data values of the constrained tables.

The example in the third data scenario 1116, the provider 1102 can establish an aggregation constraint to prohibit each of the providers 1102 from aggregating data in a protected table or set an aggregation constraint to vary whether the data can be aggregated based on the context of a query, such as which provider 1102 submitted a query. According to the example embodiment of the third data scenario 1116, a provider user shares data protected by one or more aggregation constraints with one or more consumer users, such as provider 1102. The consumer user's queries 1108 are combined with provider data and consumer data, where the cloud data platform or component thereof (or trusted database processing system) enforces the provider user's aggregation constraints. In the two-party combining of sensitive data, information flow can be unidirectional or bidirectional.

The example in the third data scenario 1116 in which data shared by multiple provider accounts, such as a provider 1102 first database account, is combined via a share and shared with multiple consumers 1104, according to some example embodiments. In an example combining data from N parties, N−1 providers share data with a consumer and the consumer's queries must satisfy all N providers' constraints. In this type of scenario, the consumer 1104 and providers 1102 combine 1101 data associated with and managed by multiple entities (e.g., providers 1102 and consumer 1104) and the consumer 1104 and provider 1102 data is shared 1103 with one or more other entities (e.g., consumer 1104). In this type of scenario, the aggregation system 250 can be implemented to enforce aggregation constraints on queries submitted by the one or more consumers, such as consumer 1104. Each of the providers 1102 and the consumer 1104 can implement aggregation constraints to protect any sensitive data shared by the respective provider by dictating which tables of the data cannot be aggregated by the provider 1102. In this type of example, a query 1108 submitted by a provider 1102 can be evaluated based on the aggregation constraints provided by each of the providers 1102 and the consumer 1104.

The data 1106 and data 1110 can be accessed by the provider 1102 without being combined with the consumer's data 1106, as shown in the second data scenario 1114, or the provider 1102 can combine the provider 1102 data 1106 with the consumer's own data 1110, as shown in the third data scenario 1116. Each provider 1102 and consumer 1104 can establish aggregation constraints to prohibit each of the consumers, such as the consumer 1104, from aggregating data in a protected table or set an aggregation constraint to vary whether the data can be aggregated based on the context of a query, such as where the consumer 1104 submitted a query 1108. According to the example embodiment of the third data scenario 1116, data is combined from N number of parties, where N−1 providers share data with one or more consumers, and all consumer queries must satisfy all providers' aggregation constraints. In the N-parties combining sensitive data, information flow can be unidirectional, bidirectional, and/or multidirectional.

The example in the fourth data scenario 1118 in which a provider 1102 of an account shares data with consumer(s) 1104 (e.g., internal users), according to some example embodiments.

In this type of scenario, the data 1106 is data associated with and managed by a single entity (e.g., provider 1102 or other account) and the data 1106 is shared with one or more other users associated with the entity (e.g., consumer 1104). In this type of scenario, the aggregation system 250 can be implemented to enforce aggregation constraints on queries submitted by the one or more internal users. The provider 1102 account can implement aggregation constraints to protect any sensitive data shared by the provider 1102 account by dictating which tables of the data cannot be aggregated by the consumers 1104 (e.g., internal users). For example, the provider 1102 account can establish aggregation constraints to prohibit each of the consumers 1104 from aggregating data in a protected table or set an aggregation constraint to vary whether the data can be aggregated based on the context of a query, such as the role of the consumers 1104 that submitted a query 1108.

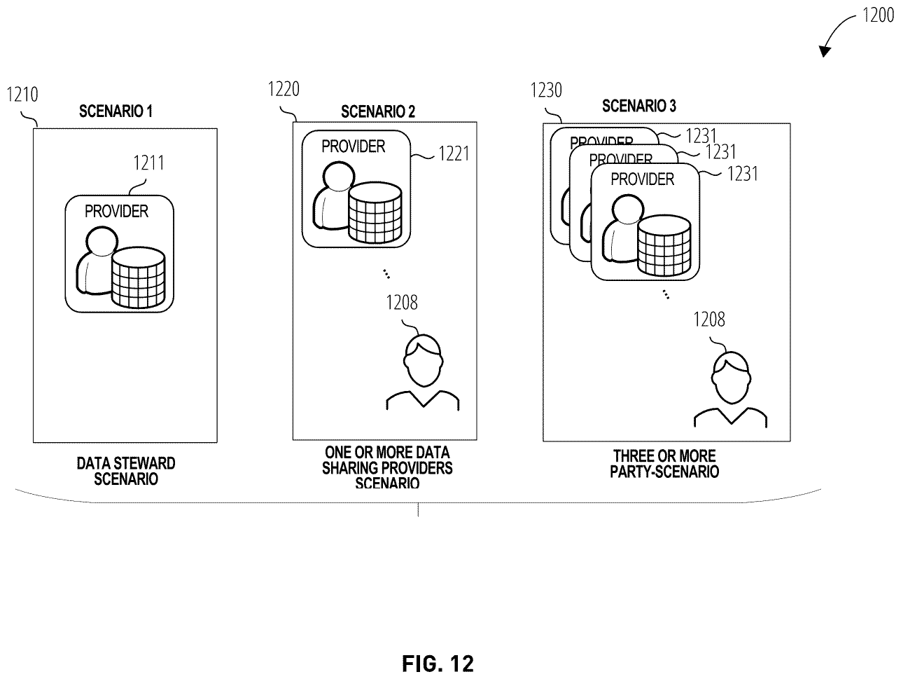

FIG. 12 illustrates a block diagram 1200 in which varying example embodiments of an aggregation constraint system can be implemented, in accordance with some example embodiments. Example embodiments of FIG. 12 provide additional examples to FIG. 11.

Aggregation constraints include a specific type of query constraint that enable data analysts to analyze a set of data and enable cloud data platform users to share data with data analysts, while ensuring that the data-sharing entity (e.g., user publishing data) can maintain a level of control over how the data can be queried (e.g., how the data can be used). While a projection constraint is useful for maintaining confidentiality and/or anonymity of proprietary datasets, the projection constraints fail to protect individual privacy (e.g., the privacy of each customer or each user).

The aggregation constraint system provides cloud data platform users with aggregation constraints to maintain individual customer privacy of each customer of a user (e.g., provider, consumer, combination). A provider or data steward can share a secure view of a dataset including customer PII and include an aggregation constraint to the secure view. A consumer can JOIN the provider's secure view against the consumer's customer list, but the consumer is restricted or prohibited from including the provider's customer list in the query output based on the provider's aggregation constraints.

In a first scenario 1210, such as data steward scenario, a single organization illustrates a provider 1211 (e.g., data steward) that makes aggregation-constrained data available to data consumers (e.g., data analysts). For example, a data steward applies an aggregation constraint to a table in which each row contains sensitive information about individuals (e.g., name, address, gender, age, income, occupation, etc.). The data steward can be a data owner or data provider, such as provider 1211, that ensures the quality, security, compliance, and the like of data processed and stored in the cloud data platform. In the first scenario 1210, an analyst can run aggregate queries against a table (e.g., average income grouped by occupation) but cannot run queries that target specific individuals. In additional example embodiments, a data steward specifies a minimum group size of 25 rows, and it is understood that each group will represent an aggregation of at least 25 individuals, i.e., each row corresponds to a unique individual. However, in other example embodiments, this assumption is not true of some tables, particularly for transactional data. For example, if an advertisement platform has recorded multiple advertisement impressions for a single user, that user might have multiple records in an ad_impressions table. Additional example embodiments allow the data steward to designate a relation (e.g., table, column, view, etc.) that identifies the user. A minimum group size could be enforced in terms of unique users instead of rows, and some join restrictions can be relaxed (e.g., entity-level privacy).

In a second scenario 1220, one provider 1221 and consumer 1208 (e.g., different organizations that collaborate in a data clean room using aggregation constraints to protect their data) is illustrated. For example, in such a scenario where one or more data providers are sharing data, the data-sharing second scenario 1220 can make or implement one or more aggregation-constrained tables available to a data sharing consumer 1208. Data sharing consumers can query these aggregation-constrained tables, join these tables with data from other providers, and join these tables with the consumers' own data. These JOIN operations can use identifying and/or quasi-identifying attributes of individuals (e.g., email addresses), or the operations can use non-identifying data or abstractions. The aggregation constraint system can ensure that consumers' queries abide by all relevant aggregation constraints, such that the results will be appropriately aggregated.

For example, according to the second scenario 1220, including one data-sharing provider, an advertising platform and an advertiser can share data that includes PII. The advertising platform (e.g., the provider) may share an aggregation-constrained table of customers who saw an advertisement. The advertiser (e.g., the consumer) can use an identifying attribute, such as an email address or phone number, to join this table against a second table owned by the advertiser (e.g., the consumer), which contains the customers who purchased the advertiser's product. The aggregation constraint permits the advertiser (e.g., the consumer) to execute a query that performs this JOIN operation, and then aggregates to compute the total number of customers who saw the advertisement and also purchased the product. The aggregation constraint system can enable the constraint to ensure that the advertiser cannot run unaggregated queries against the specific rows (e.g., customers) in the provider's table.

In a third scenario 1230, multiple data providers and a single consumer are shown. For example, in a multiple-party scenario, aggregation constraints can be used in example embodiments with three or more providers, such as providers 1231. For example, the advertiser and advertising platform in the previous example enlist the help of an identity resolution provider. The advertising platform maintains a table of advertisement impressions. According to the third scenario, the fields that identify a given consumer can be similar or different between two companies (e.g., consumer always provides the same email to all companies or sometimes the consumer provides their phone number, other times their email, still other times their address and email, etc.). Enabling two or more companies to match identities across their different customer lists requires an identity provider (e.g., a third party) to provide the bridge to actually match the customers based on their different identifying or quasi-identifying attributes.

For example, in the advertisement technology space, there can be standalone companies (e.g., Company B) whose main role is to match identities across companies. The standalone company provides an identifier (e.g., unique identifier (UID)) for each customer that is unique per company the customer contracts with. For example, customer, User A, has a first unique identifier from the advertising platform and a second unique identifier from the advertiser, but the standalone company generates a wholly unique customer identifier that matches both company-specific identifier values (e.g., a bridging UID matching both the advertising platform UID and the advertiser UID for customer User A).

In additional example embodiments, the third scenario of identity resolution aggregation constraints can be implemented in a data clean room, enabling data-sharing companies to match customer records and then perform additional operations (e.g., augmentation/enrichment, audience creation, reach, frequency, measurement, etc.). These data-sharing providers are foundational to much of the cross-company clean room collaboration that can be performed in the advertising technology space.

Additional example embodiments of an aggregation constraint system or aggregation system can be implemented to join and aggregate audience overlaps with segment creation operations. For example, when advertisers (e.g., shoe companies, exercise equipment companies, etc.) want to run advertisements on an advertisement platform (e.g., video sharing platforms, television platforms, etc.), they want to perform two actions before targeting consumers. First, advertisers want to understand what percentage and total number of their customer base are using the service. Second, advertisers want to understand how different customer segments are using the specific advertisement platform. For example, an exercise equipment company wants to know the total number of their customers watching different television programs from a specific television platform. They can then use this to run advertisements on the programs that have the highest viewership of their customers with the desire to target non-customers and drive purchasing a bike or treadmill.

Additional example embodiments of an aggregation constraint system can be implemented to join and aggregate to provide each operation. For example, when advertisers are choosing the advertisement platform that they want to run their advertisements on, the platform will commit to the total size of the audience that they will serve the advertisement X number of times. Advertisers commit to this metric, and they evaluate this metric, along with frequency, during the measurement phase. The queries that advertisers will run are joins across the advertiser's audience and segments and the population of customers that were served the advertisements on the advertisement platforms service. They will then count the total number of consumers that match and were served this advertisement.

Additional example embodiments of an aggregation constraint system can be implemented to join and aggregate to provide frequency operations. For example, advertisers want to know that the advertisement was not shown 10 million times to 1000 customers, they commit to and report on the distribution of the number of customers and times that have seen the specific advertisement campaign. The queries that advertisers will run are joins across the advertiser's audience and segments and number of customers that saw the advertisement campaign N times (resulting in the distribution).

Additional example embodiments of an aggregation constraint system can be implemented to join and aggregate to provide measurement operations. For example, when an advertisement has been run on a platform the advertisement platform will provide the advertiser with a measurement of the audience reach for a given advertisement campaign across all channels that an advertisement platform offers. Today this requires an advertisement platform to provide reporting on viewership and advertisement campaign performance across their streaming channels (e.g., web, mobile, television, etc.). Another, longer term measure, is being able to connect the customers that were served an advertisement on an advertisement platform and purchased a product in the advertiser's store. This can involve combining the advertisement platforms advertisement serving data with the advertisers' customer records and purchase history.

Additional example embodiments of an aggregation constraint system can be implemented in various other use cases.

For example, the aggregation constraint system can be used for customer intersection. In such an example, two companies are considering a partnership, and wish to aggregate statistics, such as quantifying the number of joint customers that are of high strategic value, without being able to query the status of a specific company. However, they do not want to share their respective customer lists with each other. The matching process will typically use identifying attributes, such as company name, website Uniform Resource Locator (URL), or a Content Index Key (CIK) (a unique identifier assigned by the SEC). The companies may also want to exchange additional attributes about their customers. For example, they may wish to indicate which customers are of high strategic value.

For example, the aggregation constraint system can be used for fraud detection. In such an example, financial institutions share information with each other to detect fraud and other financial crimes, while simultaneously protecting customer data. For example, the aggregation constraint system can be used for aggregate queries on de-identified data. In such an example, de-identified data is often shared for purposes such as medical research and collaborative machine learning. The intended use cases for this data typically look at records in aggregate. Unfortunately, so-called de-identified records can often still be traced back to individuals. The risk of re-identification can be greatly reduced by only permitting aggregate queries on the data. The aggregation constraint system enables de-identified data sets to be shared, without allowing consumers to inspect individual records. The cloud data platform's k-anonymization component can address similar requirements, where aggregation constraints can be used instead of, or in addition to, k-anonymity.

FIG. 13 shows an example block diagram 1300 of a dynamically restricted data clean room system 230, according to some example embodiments. In FIG. 13, a first database account 1305 and a second database account 1350 share data in a data clean room system 230 against which queries can be issued by either account. In the following example, the first database account 1305 provides data to the second database account 1350 (e.g., using approved statements table 1310, row access policy engine (RAP) 1315, source data 1320, and shared source data 1325), and it is appreciated that the second database account 1350 can similarly share data with the first database account 1305 (e.g., using approved statements table 1355, row access policy engine (RAP) 1360, source data 1365, and shared source data 1370).

In the example of FIG. 13, the data clean room system 230 implements a row access policy scheme (e.g., row access policy engine 1315, row access policy engine 1360) on the shared datasets of the first and second database accounts (e.g., source data 1320, source data 1365). In some example embodiments, the row access policy engine 1360 is implemented as a database object of the cloud data platform 102 that restricts source data of a database account for use and/or sharing in the clean room. In some example embodiments, a database object in the cloud data platform 102 is a data structure used to store and/or reference data. In some example embodiments, the cloud data platform 102 implements one or more of the following objects: a database table, a view, an index, a stored procedure of the cloud data platform, a user-defined function of the cloud data platform, or a sequence. In some example embodiments, when the cloud data platform 102 creates a database object type, the object is locked, and a new object type cannot be created due to the cloud data platform 102 restricting the object types using the source code of the cloud data platform. In some example embodiments, when objects are created, a database object instance is what is created by the cloud data platform 102 as an instance of a database object type (e.g., such as a new table, an index on that table, a view on the same table, application instance, or a new stored procedure object). The row access policy engine 1360 provides row-level security to data of the cloud data platform 102 through the use of row access policies to determine which rows to return in the query result. Examples of a row access policy include allowing one particular role to view rows of a table (e.g., user role of an end-user issuing the query), or including a mapping table in the policy definition to determine access to rows in a given query result. In some example embodiments, a row access policy is a schema-level object of the cloud data platform 102 that determines whether a given row in a table or view can be viewed from different types of database statements including SELECT statements or rows selected by UPDATE, DELETE, and MERGE statements.

In some example embodiments, the row access policies include conditions and functions to transform data at query runtime when those conditions are met. The policy data is implemented to limit sensitive data exposure. The policy data can further limit an object's owner (e.g., the role with the OWNERSHIP privilege on the object, such as a table or view) who normally has full access to the underlying data. In some example embodiments, a single row access policy engine is set on different tables and views to be implemented at the same time. In some example embodiments, a row access policy can be added to a table or view either when the object is created or after the object is created.

In some example embodiments, a row access policy comprises an expression that can specify database objects (e.g., table or view) and use conditional expression functions and context functions to determine which rows should be visible in a given context. The following is an example of a row access policy being implemented at query runtime: (A) for data specified in a query, the cloud data platform 102 determines whether a row access policy is set on a database object. If a policy is added to the database object, all rows are protected by the policy. (B) The distributed database system then creates a dynamic secure view (e.g., a secure database view) of the database object. (C) The policy expression is evaluated. For example, the policy expression can specify a “current statement” expression that only proceeds if the “current statement” is in the approved statements table or if the current role of the user that issued the query is a previously specified and allowed role. (D) Based on the evaluation of the policy, the restriction engine generates the query output, such as source data (e.g., provider source data) to be shared from a first database account to a second database account, where the query output only contains rows based on the policy definition evaluating to TRUE.

Continuing with reference to FIG. 13, the contents of the approved statements table is agreed upon or otherwise generated by the first database account and second database account. For example, the users managing the first database account 1305 and second database account 1350 agree upon query language that is acceptable to both and include the query language in the approved statements table, and the agreed upon language is stored in the approved statements table 1310 on the first database account 1305 and also stored in the approved statements table 1355 in the second database account 1350. As an illustrative example, the source data 1320 of the first database account 1305 can include a first email dataset of the first database account's users, and the source data 1365 of the second database account 1350 can include a second email dataset of the second database accounts users (not shown). The two database accounts may seek to determine how many of their user email addresses in their respective datasets match, where the returned result is a number (e.g., each has end users and the two database accounts are interested in how many users they share, but do not want to share the actual users' data). To this end, the two database accounts store “SELECT COUNT” in the approved query requests table. In this way, a counting query that selects and joins the source data can proceed, but a “SELECT *” query that requests and potentially returns all user data cannot proceed because it is not in the approved statements tables of the respective dataset accounts (e.g., the approved statements table 1310 and the approved statements table 1355).

Further, although only two database accounts are illustrated in FIG. 13, the data clean room system 230 enables two or more database accounts to share data through the clean room architecture. In past approaches, data clean room data is obfuscated (e.g., tokenized) and then shared in a data clean room, and the complexity of matching obfuscated data can result in limiting the data clean room data to only two parties at a time. In contrast, in the approach of FIG. 13, a third database account (not illustrated in FIG. 13) can provide a third-party shared dataset 1377 using the data clean room system 230 in the compute service manager 108, and database statements can be issued that join data from the three datasets, such as a SELECT COUNT on a joined data from the source data 1320, the shared source data 1370 from the second database account 1350, and the third-party shared dataset 1377 from the third database account (e.g., as opposed to a requester database account sharing data with a first provider database account, and the requester database account further correlating the data with another second provider database account using sequences of encrypted functions provided by the first and second provider accounts), in accordance with some example embodiments.

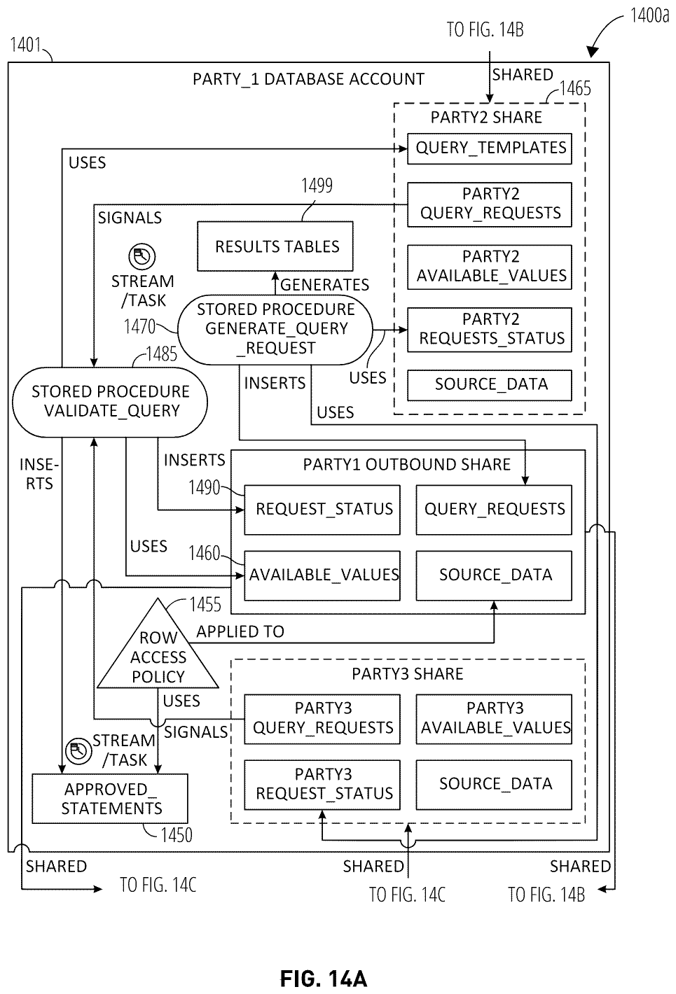

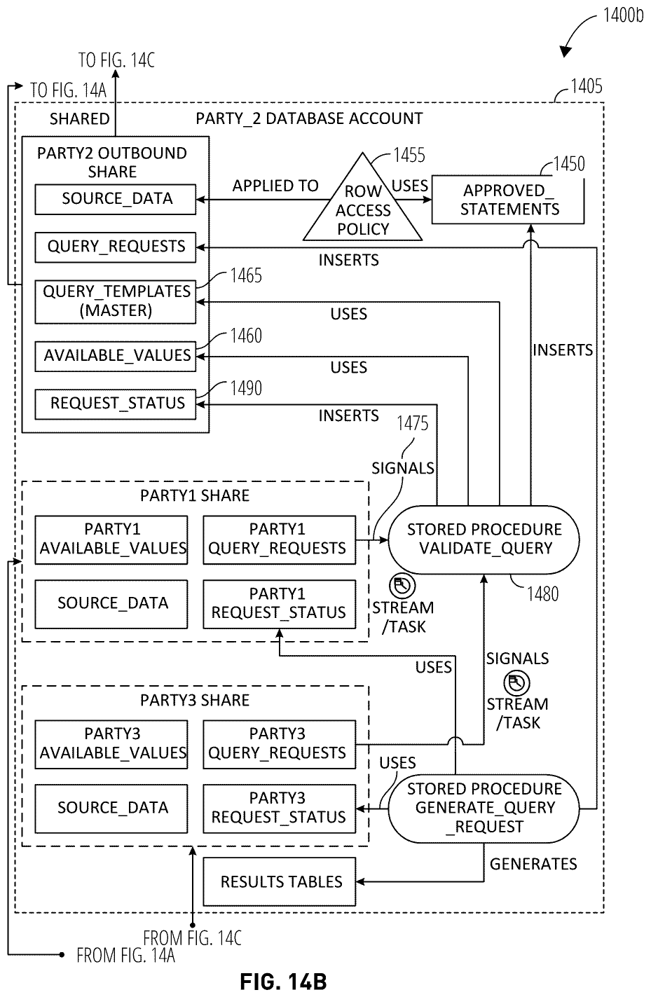

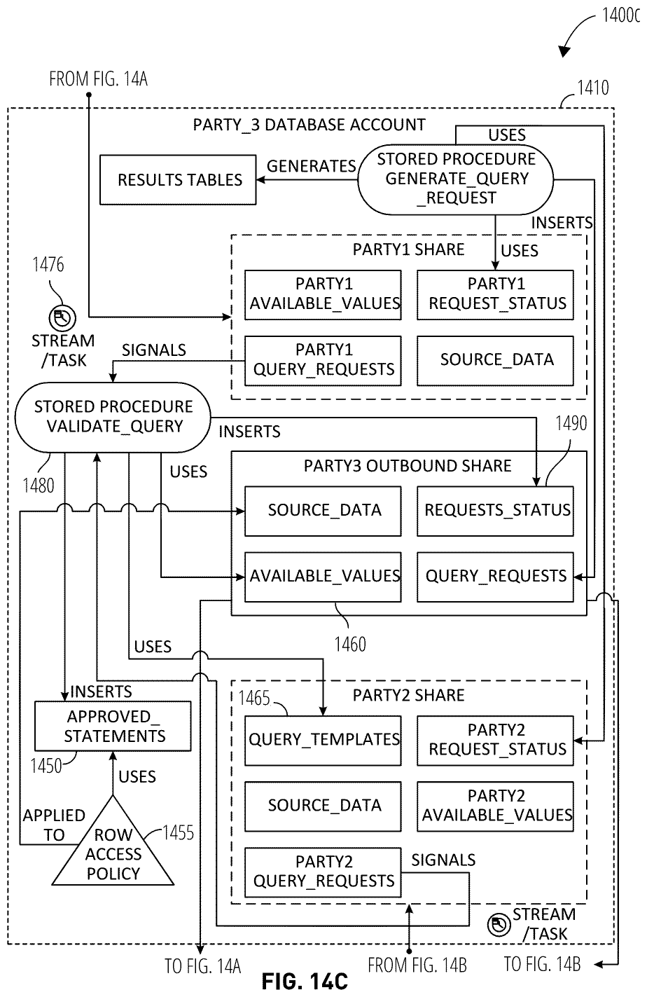

FIGS. 14A-14C show examples of data clean room architecture for sharing data between multiple parties, according to some example embodiments. In the illustrated examples, party_1 database account 1401 is in FIG. 14A, party_2 database account 1405 is in FIG. 14B, and party_3 database account 1410 is in FIG. 14C, where data is transferred (e.g., replicated, shared) between the different accounts, as indicated by the broken labeled arrows that refer to other figures. For example, in FIG. 14C, a “Party2 Outbound Share” is shared from the party_2 database account 1405 to the party_1 database account 1401 in which the share is labeled as “Party2 Share” and connected by a broken arrow between FIG. 14A and FIG. 14B. The below data flows refer to operations that each party performs to share data with the other parties of FIGS. 14A-14C. For example, at operation 1450, the party_1 database account 1401 creates its APPROVED_STATEMENTS in its own database instance (e.g., illustrated in FIG. 14A); likewise at operation 1450, party_2 database account 1405 creates its APPROVED_STATEMENTS in its own database instance (e.g., illustrated in FIG. 14B), and further, party_3 database account 1410 creates its APPROVED_STATEMENTS in its own database instance (e.g., illustrated in FIG. 14C).

FIG. 14A shows an example of data clean room architecture 1400a for sharing data between multiple parties including party_1 database account 1401, according to some embodiments.

At operation 1450, each party creates an APPROVED_STATEMENTS table that will store the query request Structured Query Language (SQL) statements that have been validated and approved. In some example embodiments, one of the parties creates the approved statements table, which is then stored by the other parties. In some example embodiments, each of the parties creates their own approved statements table, and a given query on the shared data must satisfy each of the approved statements table or otherwise the query cannot proceed (e.g., “SELECT *” must be in each respective party's approved statements table in order for a query that contains “SELECT *” to operate on data shared between the parties of the cleanroom).

At operation 1455, each party creates a row access policy that will be applied to the source table(s) shared to each other party for clean room request processing. The row access policy will check the current_statement( ) function against values stored in the APPROVED_STATEMENTS table.

At operation 1460, each party will generate their AVAILABLE_VALUES table, which acts as a data dictionary for other parties to understand which tables, columns, and/or values they can use in query requests. In some example embodiments, the available values comprise schema, allowed columns, and metadata specifying prohibited rows or cell values. In some example embodiments, the available values data is not the actual data itself (e.g., source data) but rather specifies what data can be accessed (e.g., which columns of the source data) by the other parties (e.g., consumer accounts) for use in their respective shared data jobs (e.g., overlap analysis).

Continuing, at operation 1470 (FIG. 14A), one of the parties (e.g., party_1 database account 1401, in this example) will generate a clean room query request by calling the GENERATE_QUERY_REQUEST stored procedure. This procedure will insert the new request into the QUERY_REQUESTS table. This table is shared to each other party, along with the source data table(s) that have the row access policy enabled, the party's AVAILABLE_VALUES table, and the REQUEST_STATUS table.

At operation 1485, the GENERATE_QUERY_REQUEST procedure will also call the VALIDATE_QUERY procedure on the requesting party's account. This is to ensure the query generated by each additional party and the requesting party matches, as an extra layer of validation.

At operation 1490, the REQUEST_STATUS table, which is shared by each party, is updated with the status from the VALIDATE_QUERY procedure. The GENERATE_QUERY_REQUEST procedure will wait and poll each REQUEST_STATUS table until a status is returned. At operation 1499, once each party has returned a status, the GENERATE_QUERY_REQUEST procedure will compare all of the CTAS statements (e.g., Create Table As Select operation in SQL) to ensure they match (if status is approved). If they all match, the procedure will execute the statement and generate the results table.

FIG. 14B shows an example of data clean room architecture 1400b for sharing data between multiple parties, including party_2 database account 1405, according to some example embodiments.

At operation 1475, each party has a stream 1476 object created against the other party's QUERY_REQUESTS table, capturing any inserts to that table. A task object will run on a set schedule and execute the VALIDATE_QUERY stored procedure if the stream object has data. At operation 1480, the VALIDATE_QUERY procedure is configured to: (1) Ensure the query request select and filter columns are valid attributes by comparing against the AVAILABLE_VALUES table. (2) Ensure the query template accepts the variables submitted. (3) Ensure the threshold or other query restrictions are applied. (4) Generate a create table as select (CTAS) statement and store it in the APPROVED_STATEMENTS table if validation succeeds. (5) Update the REQUEST_STATUS table with success or failure. If successful, the create table as select (CTAS) statement is also added to the record.

FIG. 14C shows an example of data clean room architecture 1400c for sharing data between multiple parties, including party_3 database account 1410 where data is transferred (e.g., replicated, shared, etc.) between the different accounts, as indicated by the broken labeled arrows that refer to other figures, according to some example embodiments.

With reference to FIG. 14C, at operation 1465, each party agrees on one or more query templates that can be used for query requests. For example, if a media publisher and advertiser are working together in a clean room, they may approve an “audience overlap” query template. The query template would store join information and other static logic, while using placeholders for the variables (select fields, filters, etc.). As an additional example, one of the parties is a provider account that specifies which statements are stored in the available statements table (e.g., thereby dictating how the provider's data will be accessed by any consumer account wanting to access the provider data). Further, in some example embodiments, the provider account further provides one or more query templates for use by any of the parties (e.g., consumer accounts) seeking to access the provider's data according to the query template. For example, a query template can comprise blanks or placeholders “{{______}}” that can be replaced by specific fields via the consumer request (e.g., the specific fields can be columns from the consumer data or columns from the provider data). Any change to the query template (e.g., adding an asterisk “*” to select all records) will be rejected by the data restrictions on the provider's data (e.g., the Row Access Policies (RAP) functions as a firewall for the provider's data).

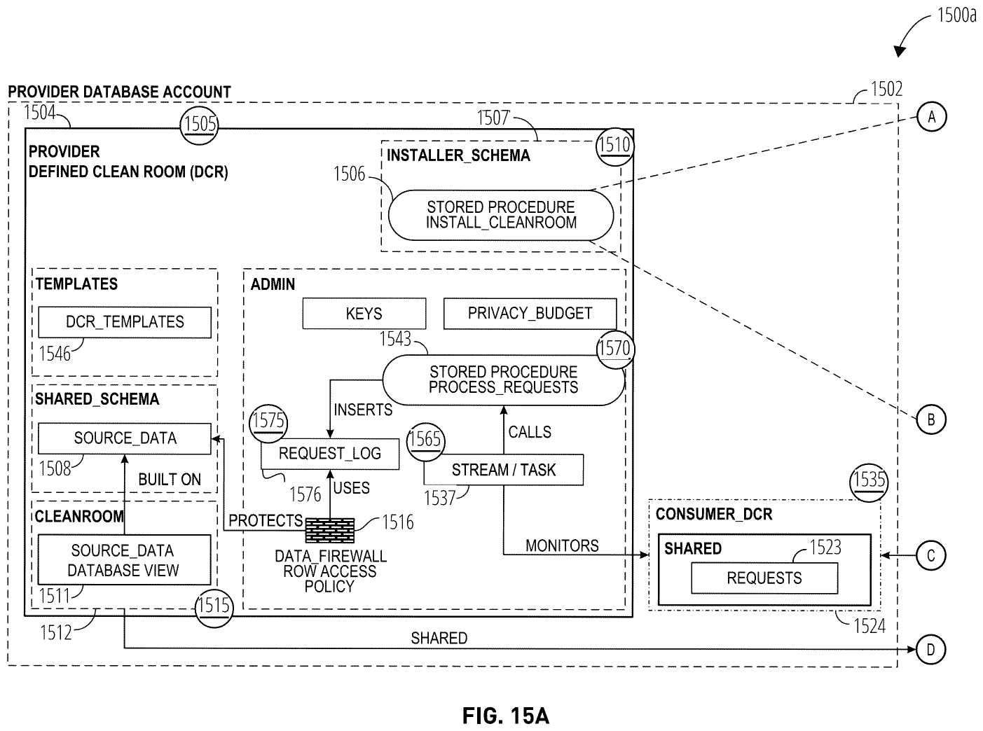

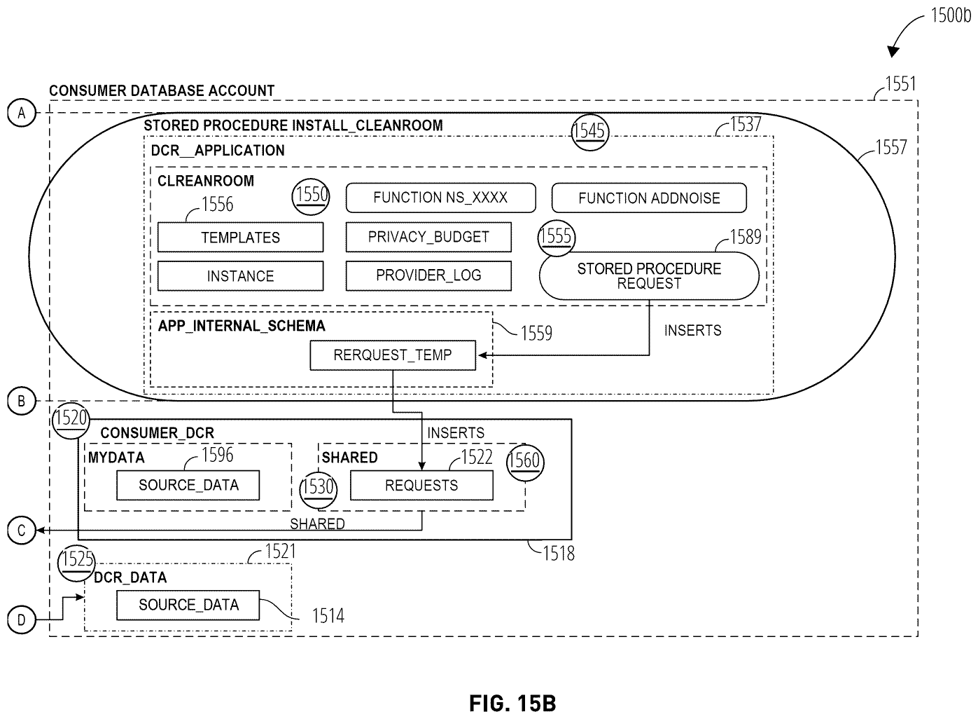

FIG. 15A shows an example data architecture 1500a for implementing defined access clean rooms using native applications, in accordance with some example embodiments.

In some example embodiments, a native application is configured so that a provider can create local state objects (e.g., tables, views, schema, etc.) and local compute objects (e.g., stored procedures, external functions, tasks, etc.) and also share objects representing the application logic in the consumer account. In some example embodiments, a native application is installed in the consumer accounts as a database instance that is shareable. For example, a provider can generate a native application that includes stored procedures and external functions that analyze and enrich data in a given consumer account. A consumer can install the provider's native application in the consumer's account as a database and call stored procedures in the installed native application that provide the application functionality. In some example embodiments, the native application is configured to write only to a database in the consumer account. Further, in some example embodiments, a native application of a provider can be packaged with one or more other objects such as tables, views, and stored procedures of the provider account, which are then generated in the consumer account upon installation via an installer script. In some example embodiments, the native application installer script is configured to: (1) create local objects in the consumer account, and (2) control the visibility of objects in native applications with the different consumer accounts that may install the provider's native application.

FIG. 15A shows a provider database account 1502 and FIG. 15B shows a consumer database account 1551 where connections between FIGS. 15A and 15B are shown using capital letters with circles (e.g., A, B, C, and D). With reference to FIG. 15A, at operation 1505, the provider database account 1502 generates a defined access clean room 1504 (DCR). At operation 1510, the provider database account 1502 shares an installer 1507 clean room stored procedure 1506 as a native database application with the consumer database account 1551. At operation 1515 in FIG. 15A, the provider database account 1502 shares source data 1508 as a source data database view 1511 in a clean room 1512, which is then accessible by the consumer database account 1551 as source data 1514 (in FIG. 15B). While the source data 1514 is accessible as a share by the consumer database account 1551, the source data 1514 may be empty (e.g., not yet populated) and is controlled by a data firewall 1516, such as a row access policy of the provider database account 1502, as discussed above. In FIG. 15B, at operation 1520, the consumer database account 1551 creates a clean room consumer database 1518 to store source data 1596.

At operation 1525, the consumer database account 1551 creates the database store 1521 to store the source data 1514 shared from the provider database account 1502. At operation 1530, the consumer database account 1551 shares a requests table 1522 with the provider database account 1502 as consumer-defined clean room shared requests table 1523 (in FIG. 15A). At operation 1535, the provider database account 1502 creates a consumer store database 1524 to store a requests table 1523 received as a consumer share from the consumer database account 1551. Further, the provider database account 1502 creates a management object 1537 comprising a stream object to track changes on the requests table 1523, and a task object in the management object 1537 to execute the process requests stored procedure 1543 when a new request is input into the requests table 1523 (e.g., a request from the consumer and user that is input into the requests table 1522 and that is automatically shared as an entry in requests table 1523).

At operation 1560, consumer database account 1551 implements the request stored procedure 1589, which is configured to (1) generate a query based on the query template and the parameters passed in, (2) signed the query request using an encryption key created by the data clean room native application 1557 to authenticate to the provider database account 1502 that the data clean room native application 1557 issued the request, (3) apply differential privacy noise parameter to the query results based on an epsilon value (e.g., privacy budget) passed in with the query, and (4) when the query is input into the requests table 1522 the query is automatically shared with the provider as an entry in the requests table 1523.

At operation 1565 in FIG. 15A, the provider database account 1502 implemented a stream to capture the insert entry into the requests table 1523 subsequently triggers the task of the management object 1537 to execute the process requests stored procedure 1543. At operation 1570, the process requests stored procedure 1543 executes the query that validates the requests. In some example embodiments, the validation that is performed by the process requests stored procedure 1543 comprises (1) determining that the encrypted request key matches the provider key, (2) confirming that the request originated from a corresponding preauthorized consumer account (e.g., consumer database account 1551), (3) confirming that the query uses a valid template from the templates 1546 (e.g., from a plurality of valid and preconfigured templates authorized by the provider), (4) confirming that the instant ID of data clean room native application 1557 matches the expected instance ID, and (5) confirming that the provider database account 1502 is the expected or preconfigured account. At operation 1575, if the request is valid, the provider database account 1502 updates the status as “approved” in a request log 1576, which configures the data firewall 1516 (e.g., row access policy) to provide access to one or more rows from the source data 1508; where the RAP provided rows are then shared to the consumer database account 1551 as source data 1514.

FIG. 15B shows an example data architecture 1500b for implementing defined access clean rooms using native applications, in accordance with some example embodiments.

At operation 1545, the consumer database account 1551 creates a database store 1521 to store the provider's shared source data 1514 (in FIG. 15B), which initiates a stored procedure installer script that generates a runtime instance of a native application 1557. In FIG. 15B, at operation 1550, the execution and creation of the data clean room native application 1557 using the native application installer procedure 1506 creates a clean room schema, and all of the objects within the clean room as specified in the native application installer procedure 1506, in accordance with some example embodiments. Further, the native application installer procedure 1506 grants privileges on the tables and the request data stored procedure. Further, the native application installer procedure 1506 creates application internal schema 1559 for use in request processing.

At operation 1555, the consumer database account 1551 generates a clean room request by calling the request stored procedure 1589 and passes in a query template name (e.g., of a template from query templates 1556, a template repository), selects groups by columns, filters, a privacy budget to implement, and any other parameters that are required for the query template chosen or otherwise passed in.

In FIG. 15B, once the data is shared into the source data 1514, the consumer database account 1551 can execute the query within the data clean room native application 1557 on the consumer database account 1551 (e.g., by execution nodes of the consumer database account 1551).

Another general aspect is for a system that includes a memory comprising instructions and one or more computer processors or one or more hardware processors. The instructions, when executed by the one or more computer processors, cause the one or more computer processors to perform operations. In yet another general aspect, a tangible machine-readable storage medium (e.g., a non-transitory storage medium) includes instructions that, when executed by a machine, cause the machine to perform operations.

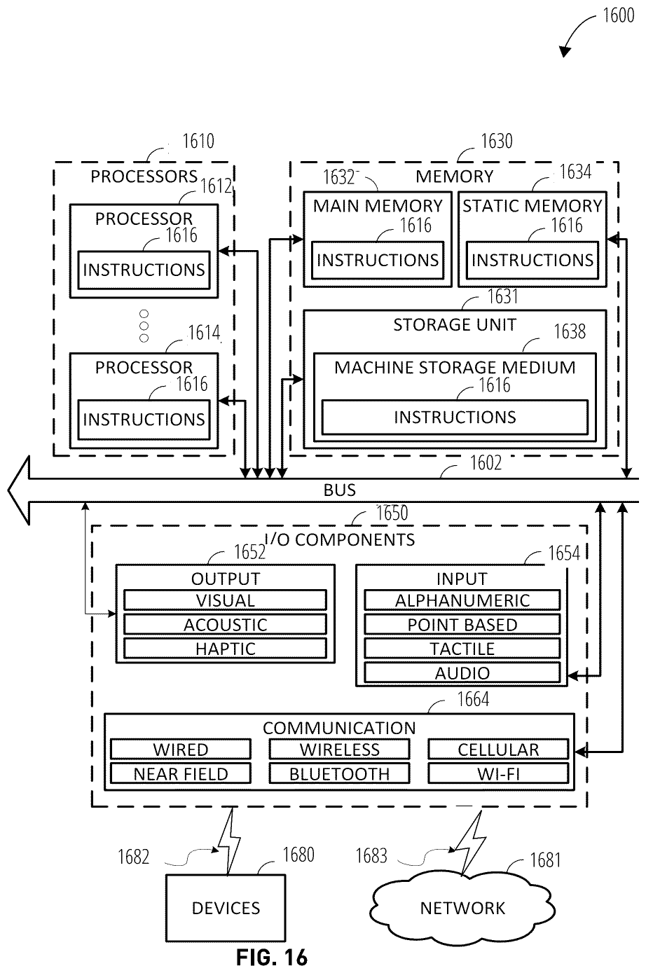

FIG. 16 illustrates a diagrammatic representation of a machine 1600 in the form of a computer system within which a set of instructions may be executed for causing the machine 1600 to perform any one or more of the methodologies discussed herein, according to an example embodiment. Specifically, FIG. 16 shows a diagrammatic representation of the machine 1600 in the example form of a computer system, within which instructions 1616 (e.g., software, a program, an application, an applet, an app, or other executable code), for causing the machine 1600 to perform any one or more of the methodologies discussed herein, may be executed. For example, the instructions 1616 may cause the machine 1600 to implement portions of the data flows described herein (e.g., data flows described and depicted in FIG. 8). In this way, the instructions 1616 transform a general, non-programmed machine into a particular machine 1600 (e.g., the client device 114 of FIG. 1, the compute service manager 108 of FIG. 1, the execution platform 110 of FIG. 1) that is specially configured to carry out any one of the described and illustrated functions in the manner described herein.

In alternative embodiments, the machine 1600 operates as a standalone device or may be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 1616, sequentially or otherwise, that specify actions to be taken by the machine 1600. Further, while only a single machine 1600 is illustrated, the term “machine” shall also be taken to include a collection of machines 1600 that individually or jointly execute the instructions 1616 to perform any one or more of the methodologies discussed herein.

The machine 1600 includes processors 1610, memory 1630, and input/output (I/O) components 1650 configured to communicate with each other such as via a bus 1602. In an example embodiment, the processors 1610 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1612 and a processor 1614 that may execute the instructions 1616. The term “processor” is intended to include multi-core processors 1610 that may comprise two or more independent processors (sometimes referred to as “cores”) that may execute instructions 1616 contemporaneously. Although FIG. 16 shows multiple processors 1610, the machine 1600 may include a single processor with a single core, a single processor with multiple cores (e.g., a multi-core processor), multiple processors with a single core, multiple processors with multiple cores, or any combination thereof.

The memory 1630 may include a main memory 1632, a static memory 1634, and a storage unit 1631, all accessible to the processors 1610 such as via the bus 1602. The main memory 1632, the static memory 1634, and the storage unit 1631 comprise a machine storage medium 1638 that may store the instructions 1616 embodying any one or more of the methodologies or functions described herein. The instructions 1616 may also reside, completely or partially, within the main memory 1632, within the static memory 1634, within the storage unit 1631, within at least one of the processors 1610 (e.g., within the processor's cache memory), or any suitable combination thereof, during execution thereof by the machine 1600.

The I/O components 1650 include components to receive input, provide output, produce output, transmit information, exchange information, capture measurements, and so on. The specific I/O components 1650 that are included in a particular machine 1600 will depend on the type of machine. For example, portable machines, such as mobile phones, will likely include a touch input device or other such input mechanisms, while a headless server machine will likely not include such a touch input device. It will be appreciated that the I/O components 1650 may include many other components that are not shown in FIG. 16. The I/O components 1650 are grouped according to functionality merely for simplifying the following discussion and the grouping is in no way limiting. In various example embodiments, the I/O components 1650 may include output components 1652 and input components 1654. The output components 1652 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1654 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 1650 may include communication components 1664 operable to couple the machine 1600 to a network 1681 via a coupler 1683 or to devices 1680 via a coupling 1682. For example, the communication components 1664 may include a network interface component or another suitable device to interface with the network 1681. In further examples, the communication components 1664 may include wired communication components, wireless communication components, cellular communication components, and other communication components to provide communication via other modalities. The devices 1680 may be another machine or any of a wide variety of peripheral devices (e.g., a peripheral device coupled via a universal serial bus (USB)). For example, as noted above, the machine 1600 may correspond to any one of the client device 114, the compute service manager 108, and the execution platform 110, and may include any other of these systems and devices.

The various memories (e.g., 1630, 1632, 1634, and/or memory of the processor(s) 1610 and/or the storage unit 1631) may store one or more sets of instructions 1616 and data structures (e.g., software), embodying or utilized by any one or more of the methodologies or functions described herein. These instructions 1616, when executed by the processor(s) 1610, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, (e.g., erasable programmable read-only memory (EPROM), electrically erasable programmable read-only memory (EEPROM), field-programmable gate arrays (FPGAs), and flash memory devices); magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1681 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1681 or a portion of the network 1681 may include a wireless or cellular network, and the coupling 1682 may be a Code Division Multiple Access (CDMA) connection, a Global System for Mobile communications (GSM) connection, or another type of cellular or wireless coupling. In this example, the coupling 1682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1616 may be transmitted or received over the network 1681 using a transmission medium via a network interface device (e.g., a network interface component included in the communication components 1664) and utilizing any one of a number of well-known transfer protocols (e.g., hypertext transfer protocol (HTTP)). Similarly, the instructions 1616 may be transmitted or received using a transmission medium via the coupling 1682 (e.g., a peer-to-peer coupling) to the devices 1680. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1616 for execution by the machine 1600, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

What is claimed is:

1. A method comprising:
receiving a query directed towards a shared dataset, the shared dataset comprising one or more data entries associated with one or more distinct entities, each entity of the one or more distinct entities being identifiable by one or more unique entity identifiers;
implementing, by at least one hardware processor, an entity-level privacy constraint, the entity-level privacy constraint comprising a dynamic aggregation constraint based on the one or more unique entity identifiers;
determining that the one or more unique entity identifiers satisfy a threshold condition comprising a minimum number of entities;
enforcing the entity-level privacy constraint on the query based on determining the one or more unique entity identifiers satisfy the threshold condition; and
generating an output to the query based on the entity-level privacy constraint and the dynamic aggregation constraint while maintaining entity-level privacy associated with the one or more distinct entities.

2. The method of claim 1, further comprising:
determining the one or more unique entity identifiers fails to comply with the dynamic aggregation constraint; and
in response to the determining, excluding the one or more unique entity identifiers from the output to the query.

3. The method of claim 1, further comprising:
enforcing the dynamic aggregation constraint based on the one or more unique entity identifiers, wherein the one or more unique entity identifiers comprise an entity key; and
receiving data defining the entity key identifies the one or more distinct entities attached to a first table.

4. The method of claim 3, wherein the entity key identifies the one or more distinct entities further comprises:
identifying the one or more distinct entities based on the entity key, wherein the entity key comprises one or more columns within a database table; and
enforcing a minimum entity count for the one or more unique entity identifiers, wherein the minimum entity count is based on a distinct combination of the one or more columns within the database table.

5. The method of claim 4, further comprising:
implementing an enhanced aggregation policy that incorporates the entity key, wherein the enhanced aggregation policy comprises:
the minimum entity count specifies a threshold number of the one or more distinct entities that must be present within the one or more unique entity identifiers; and
a minimum group size that specifies a threshold number of rows that must be present within the one or more unique entity identifiers.

6. The method of claim 1, further comprising:
determining whether the query is a valid query based, at least in part, on a minimum number of the one or more unique entity identifiers; and
rejecting the query based on determining that the query is invalid.

7. The method of claim 1, wherein the dynamic aggregation constraint ensure that the one or more unique entity identifiers contains a predetermined minimum number of unique entities.

8. The method of claim 1, further comprising:
providing an entity key user interface to enable a user to specify an attribute to identify the one or more distinct entities within the shared dataset, wherein the attribute is at least one of an identifier attribute or a quasi-identifier attribute.

9. The method of claim 1, wherein determining that the one or more unique entity identifiers satisfy the threshold condition further comprises:
determining that the one or more unique entity identifiers are equal to or greater than a predefined minimum number of entities in an aggregation group.

10. The method of claim 1, further comprising:
generating a data clean room in a first account, the first account being associated with a provider database account;
installing, in a second account, an application instance that implements the data clean room, the second account being associated with a consumer database account of a second entity; and
sharing, by the provider database account, source provider data with the data clean room, the sharing making the source provider data accessible to the consumer database account via the application instance.

11. A system comprising:
one or more hardware processors of a machine; and
at least one memory storing instructions that, when executed by the one or more hardware processors, cause the system to perform operations comprising:
receiving a query directed towards a shared dataset, the shared dataset comprising one or more data entries associated with one or more distinct entities, each entity of the one or more distinct entities being identifiable by one or more unique entity identifiers;
implementing, by at least one hardware processor, an entity-level privacy constraint, the entity-level privacy constraint comprising a dynamic aggregation constraint based on the one or more unique entity identifiers;
determining that the one or more unique entity identifiers satisfy a threshold condition comprising a minimum number of entities;
enforcing the entity-level privacy constraint on the query based on determining the one or more unique entity identifiers satisfy the threshold condition; and
generating an output to the query based on the entity-level privacy constraint and the dynamic aggregation constraint while maintaining entity-level privacy associated with the one or more distinct entities.

12. The system of claim 11, the operations further comprising:
determining the one or more unique entity identifiers fails to comply with the dynamic aggregation constraint; and
in response to the determining, excluding the one or more unique entity identifiers from the output to the query.

13. The system of claim 11, the operations further comprising:
enforcing the dynamic aggregation constraint based on the one or more unique entity identifiers, wherein the one or more unique entity identifiers comprise an entity key; and
receiving data defining the entity key identifies the one or more distinct entities attached to a first table.

14. The system of claim 13, wherein the entity key identifies the one or more distinct entities further comprises:
identifying the one or more distinct entities based on the entity key, wherein the entity key comprises one or more columns within a database table; and
enforcing a minimum entity count for the one or more unique entity identifiers, wherein the minimum entity count is based on a distinct combination of the one or more columns within the database table.

15. The system of claim 14, the operations further comprising:
implementing an enhanced aggregation policy that incorporates the entity key, wherein the enhanced aggregation policy comprises:
the minimum entity count specifies a threshold number of the one or more distinct entities that must be present within the one or more unique entity identifiers; and
a minimum group size that specifies a threshold number of rows that must be present within the one or more unique entity identifiers.

16. The system of claim 13, the operations further comprising:
determining whether the query is a valid query based, at least in part, on a minimum number of the one or more unique entity identifiers; and
rejecting the query based on determining that the query is invalid.

17. The system of claim 13, wherein the dynamic aggregation constraint ensure that the one or more unique entity identifiers contains a predetermined minimum number of unique entities.

18. The system of claim 13, the operations further comprising:
providing an entity key user interface to enable a user to specify an attribute to identify the one or more distinct entities within the shared dataset, wherein the attribute is at least one of an identifier attribute or a quasi-identifier attribute.

19. The system of claim 11, the operations further comprising:
generating a data clean room in a first account, the first account being associated with a provider database account;
installing, in a second account, an application instance that implements the data clean room, the second account being associated with a consumer database account of a second entity; and
sharing, by the provider database account, source provider data with the data clean room, the sharing making the source provider data accessible to the consumer database account via the application instance.

20. The system of claim 11, wherein determining that the one or more unique entity identifiers satisfy the threshold condition further comprises:
determining that the one or more unique entity identifiers are equal to or greater than a predefined minimum number of entities in an aggregation group.

21. A machine-storage medium embodying instructions that, when executed by a machine, cause the machine to perform operations comprising:
receiving a query directed towards a shared dataset, the shared dataset comprising one or more data entries associated with one or more distinct entities, each entity of the one or more distinct entities being identifiable by one or more unique entity identifiers;
implementing, by at least one hardware processor, an entity-level privacy constraint, the entity-level privacy constraint comprising a dynamic aggregation constraint based on the one or more unique entity identifiers;
determining that the one or more unique entity identifiers satisfy a threshold condition comprising a minimum number of entities;
enforcing the entity-level privacy constraint on the query based on determining the one or more unique entity identifiers satisfy the threshold condition; and
generating an output to the query based on the entity-level privacy constraint and the dynamic aggregation constraint while maintaining entity-level privacy associated with the one or more distinct entities.

22. The machine-storage medium of claim 21, the operations further comprising:
determining the one or more unique entity identifiers fails to comply with the dynamic aggregation constraint; and
in response to the determining, excluding the one or more unique entity identifiers from the output to the query.

23. The machine-storage medium of claim 21, the operations further comprising:
enforcing the dynamic aggregation constraint based on the one or more unique entity identifiers, wherein the one or more unique entity identifiers comprise an entity key; and
receiving data defining the entity key identifies the one or more distinct entities attached to a first table.

24. The machine-storage medium of claim 23, wherein the entity key identifies the one or more distinct entities further comprises:
identifying the one or more distinct entities based on the entity key, wherein the entity key comprises one or more columns within a database table; and
enforcing a minimum entity count for the one or more unique entity identifiers, wherein the minimum entity count is based on a distinct combination of the one or more columns within the database table.

25. The machine-storage medium of claim 24, the operations further comprising:
implementing an enhanced aggregation policy that incorporates the entity key, wherein the enhanced aggregation policy comprises:
the minimum entity count specifies a threshold number of the one or more distinct entities that must be present within the one or more unique entity identifiers; and
a minimum group size that specifies a threshold number of rows that must be present within the one or more unique entity identifiers.

26. The machine-storage medium of claim 21, the operations further comprising:
determining whether the query is a valid query based, at least in part, on a minimum number of the one or more unique entity identifiers; and
rejecting the query based on determining that the query is invalid.

27. The machine-storage medium of claim 21, wherein the dynamic aggregation constraint ensure that the one or more unique entity identifiers contains a predetermined minimum number of unique entities.

28. The machine-storage medium of claim 21, the operations further comprising:
providing an entity key user interface to enable a user to specify an attribute to identify the one or more distinct entities within the shared dataset, wherein the attribute is at least one of an identifier attribute or a quasi-identifier attribute.

29. The machine-storage medium of claim 21, wherein determining that the one or more unique entity identifiers satisfy the threshold condition further comprises:
determining that the one or more unique entity identifiers are equal to or greater than a predefined minimum number of entities in an aggregation group.

30. The machine-storage medium of claim 21, the operations further comprising:
generating a data clean room in a first account, the first account being associated with a provider database account;
installing, in a second account, an application instance that implements the data clean room, the second account being associated with a consumer database account of a second entity; and
sharing, by the provider database account, source provider data with the data clean room, the sharing making the source provider data accessible to the consumer database account via the application instance.
